(19) United States
(12) Patent Application Publication
(10) Pub. No.: US 2017/0097963 A1
(43) Pub. Date: Apr. 6, 2017

(54) Data Analysis

(71) Applicant: Centrifuge Pty Ltd, Forster (AU)

(72) Inventors: John Julian Galloway, Mudgree (AU); Adam Broadway, Burlingame, CA (US); Nicholas Davie, Centennial Park (AU); Douglas John Atkinson, Tuncurry (AU)

(21) Appl. No.: 15/333,783

(22) Filed: Oct. 25, 2016

Related U.S. Application Data
(63) Continuation of application No. 13/939,704, filed on Jul. 11, 2013.
Application No. 13/939,704 is a continuation-in-part of application No. PCT/AU2012/000484, filed on May 4, 2012.
(60) Provisional application No. 61/670,669, filed on Jul. 12, 2012.
(60) Provisional application No. 61/482,686, filed on May 5, 2011.

(51) Int. Cl. G06F 17/30; G06F 21/62

(52) U.S. Cl. CPC G06F 17/30551; G06F 17/30554; G06F 17/30598; G06F 17/30241; G06F 17/30572; G06F 21/6218

(57) ABSTRACT

A method for use in analysing time sense data, the method including determining a relationship coefficient between each pair of a plurality of data sets, each data set being indicative of variable values of a corresponding variable over time, and the relationship coefficient being indicative of a degree of relatedness between the pair of data sets, displaying a first representation including first nodes indicative of first data sets, the first data sets being selected ones of the data sets, determining selection of at least two second data sets from the first data sets and displaying a second representation, the second representation including an animation over time of a second node, the second node being animated based on the variable values for the second data sets.

This application is a continuation of U.S. patent application Ser. No. 13/939,704, filed Jul. 11, 2013, which is a continuation-in-part of International Patent Application No. PCT/AU2012/000484, filed on May 4, 2012, which claims the benefit of Provisional U.S. Patent Application Ser. No. 61/482,686, filed on May 5, 2011. U.S. patent application Ser. No. 13/939704 also claims the benefit of Provisional U.S. Patent Application Ser. No. 61/670,669, filed on Jul. 12, 2012. Each of the above-referenced applications is incorporated by reference herein in its entirety.

### BACKGROUND OF THE INVENTION

The present invention relates to a method and apparatus for use in analysing data and in particular time series data, as well as to a method and apparatus for use in performing a search, and in one example to performing a search to identify variables related to a selected variable.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Organizations have long collected held time series records which have multiple data points at different time intervals, e.g. weekly, monthly, yearly. The proliferation of data in general however and time series data in particular, means ready and easy-to-understand methods of discovering potentially important patterns in such data are required.

In particular, how the different variables may or may not be statistically related to each other and move in similar or dissimilar ways over time is of much concern to many executives but is not currently easy to comprehend. For example, discovering that visits to a website trend in a synchronous manner with coffee sales or part time employment rates, or temperature or rainfall statistics, may provide critical and previously unknown information helpful to the enterprise.

Coupled with a focus found in many enterprises on the current quarter or the current month, exacerbates the need to easily understand longer periods of time series movements and potentially synchronous patterns with other time series that may or may not be seemingly related. The drivers for success and overcoming complexity require that these potential relationships over time be understood, and by a method that is visual and easy to drive and understand.

However, current and traditional methods of visualizing time series are those of line charts, which only allow small numbers of time series variables to be examined comparatively over time without representations of the data become visually confusing, making analysis difficult. Given a trend across many organizations of more data being collected on a regular basis and from more different sources, a tool is required to allow the over-time movements of many variables in relation to each other to be readily understood.

Searching based on semantics is well known, for example from search engines, such as Google™. Such searches identify search results based on an input, such as a text string, which is then compared to a range of content, to identify content of interest based on the text string. This can include, for example, identifying content containing the text string, or content containing information equating to a meaning of the text string.

However, such searches are limited, and in particular, only identify content based on the semantics of the input. This fails to take into account relationships between data, such as cause and effect relationships, which are often of more interest.

### SUMMARY OF THE PRESENT INVENTION

In a first broad form the present invention seeks to provide a method for use in analysing time series data, the method including, in an electronic processing device:
a) determining a relationship coefficient between each pair of a plurality of data sets, each data set being indicative of variable values of a corresponding variable over time, and the relationship coefficient being indicative of a degree of relatedness between the pair of data sets;
b) displaying a first representation including at least one of:
   i. first nodes indicative of first data sets, the first data sets being selected ones of the data sets;
   ii. node connections indicative of the relationship coefficients between at least some of the selected first data sets;
c) determining selection of at least two second data sets from the first data sets; and,
d) displaying a second representation, the second representation including an animation over time of a second node, the second node being animated based on the variable values for the second data sets.

Typically the first representation includes nodes spatial distributed relative to one another based on their relationship coefficients.

Typically the method includes manipulating the first representation in accordance with input commands of a user, by altering at least one of:
a) first data sets selected;
b) a number of connections;
c) data set indicators;
d) zoom levels; and,
e) a viewpoint.

Typically the method includes:
a) determining a selected first data set; and,
b) moving a viewpoint so that the node of the selected first data set is displayed centrally in the representation.

Typically the method includes:
a) determining a coefficient threshold; and,
b) displaying node connections having a relationship coefficient that exceed the coefficient threshold, in the first representation.

Typically the method includes:
a) determining a node size for each node at least in part using variable values for the corresponding first data set; and,
b) displaying the nodes in accordance with the node size.

Typically the method includes displaying the nodes as at least one of circles spheres, and bubbles.

Typically the method includes displaying the nodes together indicators indicative of an identity of the corresponding data set.

Typically the method includes determining selection of at least one of the first and second data sets in accordance with user input commands received via an input device.

Typically the method includes:
a) displaying a list of data sets via a user interface; and,
b) determining selection of data sets from the list.

Typically the method includes determining selection of the second data sets in accordance with user selection of nodes in the first representation.

Typically the method includes:
a) determining at least one group of associated second data sets;
b) displaying a respective second node for each group of associated data sets.

Typically the method includes displaying the second nodes in accordance with appearance parameters, the appearance parameters being indicative of the appearance of the second node depending on variable values for the second data sets.

Typically appearance parameters includes X-Y axes, the animation of the second node being a change in a position of the second node over time relative to the X-Y axes based on the variable values for two of the second data sets.

Typically the appearance parameters include a second node size, the animation of the second node being a change in the second node size over time based on the variable values for one of the second data sets.

Typically the appearance parameters include a second node colour, the animation of the second node being a change in the second node colour over time based on the variable values for one of the second data sets.

Typically the appearance parameters include a second node opacity, the animation of the second node being a change in the second node opacity over time based on the variable values for one of the second data sets.

Typically the method includes scaling variable values for the second data sets of different groups to show the data sets on the same second representation.

Typically the appearance parameters includes X-Y axes, and wherein the method includes scaling the variable values for the second data sets provided on the X-Y axes across groups.

Typically the method includes:
a) obtaining a data set;
b) determining a time interval associated with the data set, the time interval being indicative of the time between successive variable values;
c) comparing the time interval to a preset time interval; and,
d) if required, interpolating variable values in the data set to determine new variable values having a time interval equal to the preset time interval.

Typically the method includes, determining the relationship coefficient using at least one of:
a) a regression analysis; and,
b) a correlation analysis.

Typically the method includes:
a) time shifting variable values in a data set in accordance with a time offset to form at least one time shifted data set;
b) displaying the second representation using at least one time shifted data set.

Typically the method includes:
a) determining user permissions associated with a user;
b) determining access permissions associated with a data set; and,
c) confirming whether a data set can be used as a first or second data set using the user permissions and data access permissions.

Typically the method includes generating time series data using a survey.

Typically the method repeating the survey a number of times to generate the time series data.

Typically the survey relates to activities of an individual.

In a second broad form the present invention seeks to provide apparatus for use in analysing time series data, the apparatus including, an electronic processing device that:
a) determines a relationship coefficient between each pair of a plurality of data sets, each data set being indicative of variable values of a corresponding variable over time, and the relationship coefficient being indicative of a degree of relatedness between the pair of data sets;
b) displays a first representation including at least one of:
   i. first nodes indicative of first data sets, the first data sets being selected ones of the data sets;
   ii. node connections indicative of the relationship coefficients between at least some of the selected first data sets;
c) determines selection of at least two second data sets from the first data sets; and,
d) displays a second representation, the second representation including an animation over time of a second node, the second node being animated based on the variable values for the second data sets.

In a third broad form the present invention seeks to provide a method for use in analysing time series data, the method including:
a) determining a relationship coefficient between each pair of a plurality of data sets, each data set being indicative of variable values of a corresponding variable over time, and the relationship coefficient being indicative of a degree of relatedness between the pair of data sets;
b) displaying a first representation including:
   i. first nodes indicative of first data sets, the first data sets being selected ones of the data sets;
   ii. node connections indicative of the relationship coefficients between at least some of the selected first data sets; and,
c) animating the first representation based on changes in relationship coefficients over time.

In a fourth broad form the present invention seeks to provide apparatus for use in analysing time series data, the apparatus including an electronic processing device that:
a) determines a relationship coefficient between each pair of a plurality of data sets, each data set being indicative of variable values of a corresponding variable over time, and the relationship coefficient being indicative of a degree of relatedness between the pair of data sets;
b) displays a first representation including at least one of:
   i. first nodes indicative of first data sets, the first data sets being selected ones of the data sets;
   ii. node connections indicative of the relationship coefficients between at least some of the selected first data sets; and,
c) animates the first representation based on changes in relationship coefficients over time.

In a fifth broad form the present invention seeks to provide a method of collecting data for use in time series data analysis, the method including:
a) providing a survey to a number of individuals, the survey requesting information relating to activities performed by the individual, and including an indication of when the activity is performed; and,
b) using survey results in a time series data analysis.

Typically the method includes periodically repeating the survey, and using the repeat results to establish time series data.

Typically the survey includes questions relating to at least one:
a) media consumption;
b) travel;
c) eating and drinking;
d) shopping;
e) entertainment;
f) product preferences; and,
g) demographics of the individual.

In a sixth broad form the present invention seeks to provide a method for performing a search to identify variables having a relationship to a selected variable, the method including, in an electronic processing device:
a) in accordance with input commands, determining a number of selected data sets of a plurality of data sets, each data set being indicative of at least one variable value of a corresponding variable
b) in accordance with input commands, determining a selected variable of at least one of the number of selected data sets;
c) determining a relationship coefficient between the selected variable each other variable of the selected data sets; and,
d) displaying a representation indicative of the relationship coefficients.

Typically the relationship coefficient between two variables is at least partially indicative of at least one of:
a) a cause and effect relationship between the respective variables; and,
b) an impact between the respective variables.

Typically the relationship coefficient is determined using at least one of:
a) a regression analysis; and,
b) correlation analysis.

Typically each data set is indicative time series data including variable values of the corresponding variable over time.

Typically the representation includes:
a) a central node indicative of the selected variable;
b) a number of nodes indicative of other variables of the selected data sets; and,
c) an indication of the relationship coefficients.

Typically the method includes, determining relationship coefficients between the variables of each of the selected data sets.

Typically the representation includes nodes spatial distributed relative to one another based on their relationship coefficients.

Typically a separation of the nodes is at least partially indicative of the relationship coefficients.

Typically the representation includes a indication of a directionality of a relationship between variables.

Typically the representation includes arrows indicative of the directionality of the relationship.

Typically the representation includes an indication of whether a relationship is positive or negative.

Typically the method includes manipulating the representation in accordance with input commands of a user, by altering at least one of:
a) selected data sets;
b) a number of connections;
c) data set indicators;
d) zoom levels; and,
e) a viewpoint.

Typically the method includes:
a) determining a coefficient threshold; and,
b) displaying node connections having a relationship coefficient that exceed the coefficient threshold, in the representation.

Typically the method includes:
a) determining a node size for each node at least in part using variable values for the corresponding selected data set; and,
b) displaying the nodes in accordance with the node size.

Typically the method includes displaying the nodes as at least one of circles spheres, and bubbles.

Typically the method includes displaying the nodes together indicators indicative of an identity of the corresponding data set.

Typically the input commands are received via an input device.

Typically the method includes:
a) displaying a list of data sets via a user interface; and,
b) determining selection of data sets from the list.

Typically the list is displayed as a tree structure.

Typically the method includes:
a) obtaining a data set;
b) determining a time interval associated with the data set, the time interval being indicative of the time between successive variable values;
c) comparing the time interval to a preset time interval; and,
d) if required, interpolating variable values in the data set to determine new variable values having a time interval equal to the preset time interval.

In a seventh broad form the present invention seeks to provide apparatus for performing a search to identify variables having a relationship to a selected variable, the apparatus including an electronic processing device that:
a) in accordance with input commands, determines a number of selected data sets of a plurality of data sets, each data set being indicative of at least one variable value of a corresponding variable
b) in accordance with input commands, determines a selected variable of at least one of the number of selected data sets;
c) determines a relationship coefficient between the selected variable each other variable of the selected data sets; and,
d) displays a representation indicative of the relationship coefficients.

In an eighth broad form the present invention seeks to provide a method for providing access to a data set, the method including, in an electronic processing device:
a) displaying an indication of a plurality of data sets, each data set being indicative of at least one variable value of a corresponding variable;
b) in accordance with input commands, determining a selected data set from the plurality of data sets;
c) determining if the user has permission to access the data set; and,
d) making the data set available for use in response to a positive determination.

Typically the method includes, in the electronic processing device displaying information regarding the selected data set.

Typically the information includes at least one of:
a) a precis of data set content;
b) an indication of a source of the data;
c) a cost of using the data set;
d) selected portions of the data set; and,
e) a modified version of the data set.

Typically the method includes, in the electronic processing device:
a) accessing user permissions associated with an identity of the user; and,
b) determining if the user has permission to access the data set using the user permissions.

Typically the method includes, in the electronic processing device, contacting a submitter to determine if the user can access the data set.

In a ninth broad form the present invention seeks to provide apparatus for providing access to a data set, the apparatus including an electronic processing device that:
a) displays an indication of a plurality of data sets, each data set being indicative of at least one variable value of a corresponding variable;
b) in accordance with input commands, determines a selected data set from the plurality of data sets;
c) determines if the user has permission to access the data set; and,
d) makes the data set available for use in response to a positive determination.

### BRIEF DESCRIPTION OF THE DRAWINGS

An example of the present invention will now be described with reference to the accompanying drawings, in which:

FIG. 1A is a flow chart of an example of a process for use in analysing time series data;

FIG. 1B is a schematic diagram of an example of a first representation for use in analysing time series data;

FIG. 1C is a schematic diagram of an example of a second representation for use in analysing time series data;

FIG. 1D is a schematic diagram of the second representation of FIG. 1C following partial animation;

FIG. 1E is a flow chart of an example of a process for use in performing a search to identify variables having a cause and effect relationship to a selected variable;

FIG. 2 is a schematic diagram of an example of a distributed computer architecture;

FIG. 3 is a schematic diagram of an example of a processing system;

FIG. 4 is a schematic diagram of an example of an end station;

FIG. 5 is a flow chart of an example process for configuring data for use in analysing time series data;

FIGS. 6A to 6C are a flow chart of a second example of a process for use in analysing time series data;

FIG. 7 is a flowchart of an example of the process for generating the first representation;

FIGS. 8A to 8J are schematic diagrams of a user interface displaying the first and second representations;

FIG. 9 is a flowchart of an example of the steps performed to implement a preferred analysis method;

FIG. 10 is a schematic diagram of the logic blocks of the general method of processing and analyzing time series data; and,

FIGS. 11A to 11F are schematic diagrams of example user interfaces displaying different representations;

FIGS. 12A and 12B are a flow chart of a second example of a process for use in analysing time series data;

FIGS. 13A to 13F are schematic diagrams of a user interface displaying example representations;

FIG. 14 is a flowchart of an example of the process for generating the representation; and,

FIG. 15 is a flowchart of an example of a process for accessing data sets stored in a library.

### DETAILED DESCRIPTION

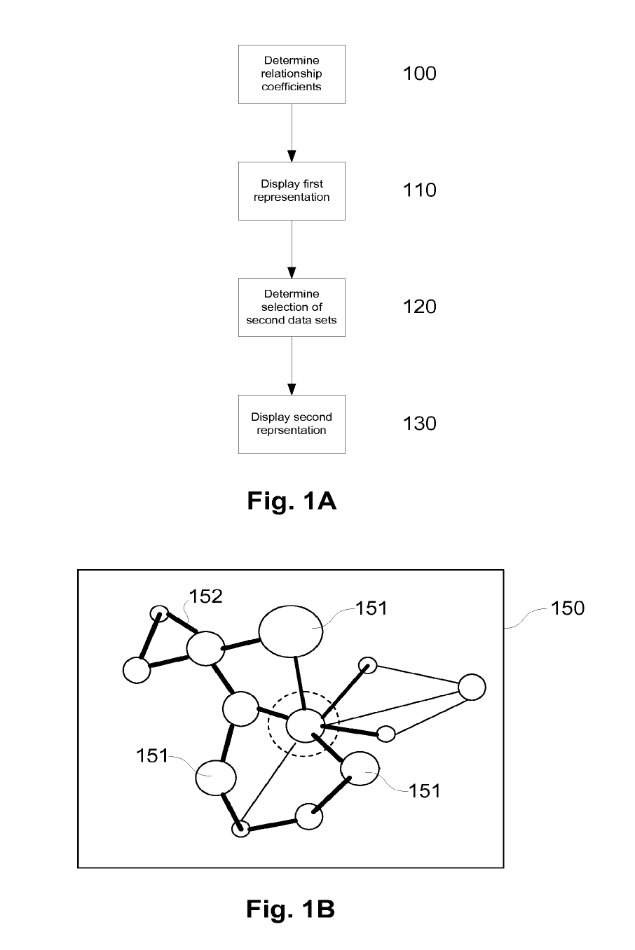

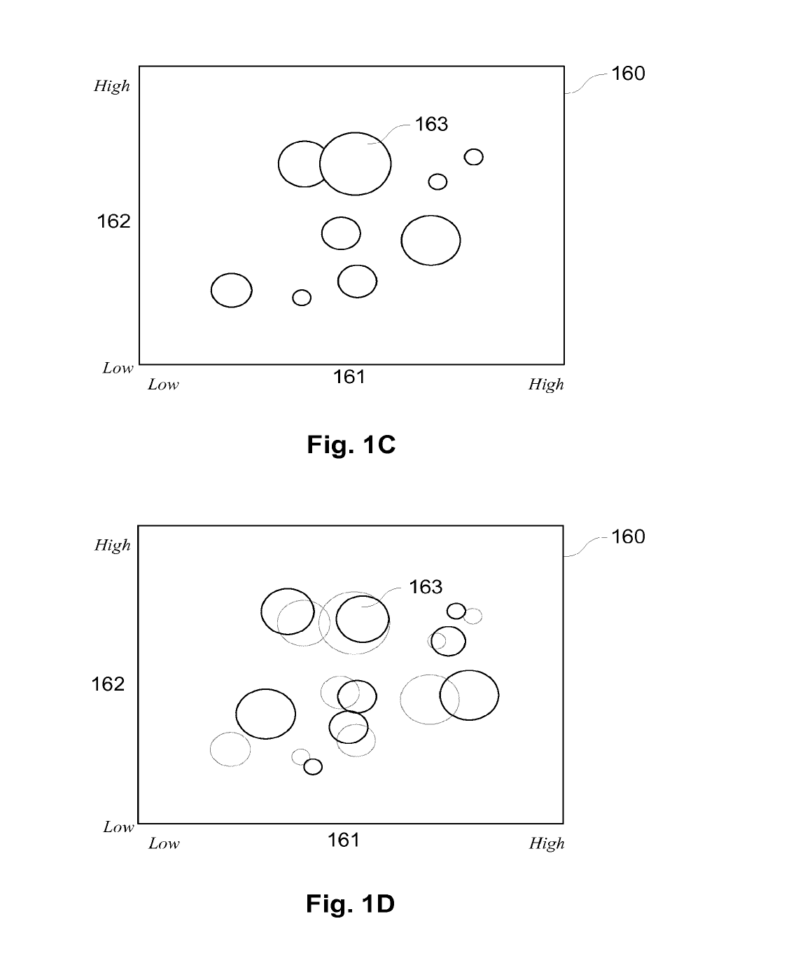

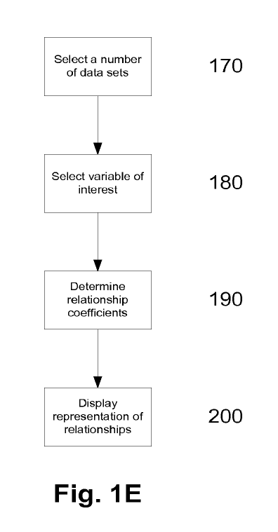

An example of a process for use in analysing time series data will now be described with reference to FIGS. 1A to 1D.

For the purpose of this example, it is assumed that the process is performed at least in part utilising an electronic processing device, and in particular a processing system, such as a suitably programmed computer system, that is capable of analysing data to determine variables having an impact on each other, such as a cause and effect relationship.

In this example, at step 100 relationship coefficients are determined between pairs of a plurality of data sets of time series data.

Each data set is indicative of at least one variable value of a corresponding variable, and in one example, is time series data relating to one or more variables and may include a number of variable values representing changes in the one or more variables over time. Such time series data can be of any appropriate form and can relate to any type of data for which variable values at a given time can be determined. This can include, for example, market research data, sales data, demographic information, climate data, sporting information or the like, as will be described in more detail below. However, the techniques can also apply to other data that is not time series data, as will be described in more detail below.

The relationship coefficient is indicative of a degree of relatedness between a pair of data sets and may be determined in any suitable manner, such as by performing a regression or correlation analysis of the data sets. Whilst this can be performed manually, typically the number of data sets involved would make this prohibitively time consuming and accordingly the process is usually implemented at least in part utilising an electronic processing device, and in particular a processing system, such as a suitably programmed computer system.

In general, relationship coefficients will be determined between each possible pairing of data sets. However, this is not essential and coefficients may only be determined on an “as need” basis.

At step 110 a first representation is generated using the relationship coefficients. The first representation includes a number of first nodes indicative of selected first data sets and node connections indicative of the relationship coefficients between at least some of the first data sets. Whilst this may be performed for all data sets, more typically this is performed for selected first data sets which represent a subset of all available data sets.

The representation may be provided in any one of a number of ways, but typically this process involves having the processing system determine relative spatial positions for the first nodes based on the relationship coefficients. The first nodes can then be displayed in a virtual space or “universe”, so that more closely related data sets are displayed in close proximity to each other. The first nodes may be represented by any form of visual indicator and in one example this can include a sphere, circle or the like. Node connections can then be provided between some, or all of the first nodes, with the node connections being indicative of relationship coefficient, for example by having a line weight based on the relationship coefficient value.

An example of such a first representation is shown in FIG. 1B. In this example, the first representation 150 includes a number of first nodes 151, each representing a selected first data set and node connections 152, which are indicative of the relationship coefficient between the first data sets represented by the connected first nodes.

The first representation is typically generated and displayed by the processing system, thereby allowing the user to optionally manipulate the first representation, for example to view different first nodes within the first representation. In particular, the first representation can include a large number of first nodes, such as several hundred, with these being presented in the three-dimensional “universe”, with the spacing between the first nodes being based on their respective relationship coefficients. The user can navigate throughout the “universe”, for example by viewing the first representation from different viewing angles, at different zoom levels or the like, allowing the user to explore relationships between the different first nodes. This allows users to easily visually identify the degree of relatedness between the first data sets, based on the spatial proximity of the first nodes and/or the strength of the node connections, thereby allowing the user to identify clusters of highly related data sets.

At step 120 at least two second data sets are selected. The second data sets are typically a subset of the first data sets shown in the first representation and may be selected in any appropriate manner. Thus, for example, this can be performed by selecting a predetermined number of first data sets having the highest relationship coefficients, which can be performed automatically by the processing system. More typically however this is performed manually by a user, for example by having the user interact with the first representation and select first nodes provided thereon. This therefore allows the user to select highly related data sets for further analysis.

Having selected at least two second data sets, a second representation is presented to the user at step 130. The second representation includes an animation over time of at least one second node, which is animated based on the variable values for at least some of the second data sets.

In one particular example, a second node is generated for a group of associated second data sets, with the animation of the second node being used to change the appearance of the second node, so that the changes in appearance represent how the variable values for the associated second data sets vary over time.

The nature of the animation, and hence the change in visual appearance can vary depending on the preferred implementation. In one example, the variable values of each data set are mapped to respective appearance parameters of the second node, so that changes in the variable values are represented by a corresponding change in the appearance of the node. The appearance parameters can relate to any aspect of the visual appearance of the second node, and will depend on the nature of the second representation.

In one example, the second representation includes an X-Y plot, in which case a position of the second node relative to X and Y axes can be used to represent changes in the variable values for two of the second data sets. Additionally and/or alternatively, other parameters relating to the visual appearance of the second nodes can be altered, such as a size, colour, opacity or shape of the second nodes, thereby allowing the variable values associated with up to four other second data sets to be shown. Thus, it will be appreciated that a single second node can be used to display up to six variable values that change over time.

An example of a second representation will now be described with reference to FIGS. 1C and 1D. In this example, the second representation 160 includes first and second axes 161, 162, and a number of second nodes 163. Each second node 163 is positioned relative to the first and second axes 161, 162 based on the variable values for a current time, for two of the second data sets. In addition to this the size and colour (not shown) of the second nodes can also be adjusted based on variable values for other associated second data sets. During the animation process, changes in the variable values over time are determined and used to update the second representation, as shown for example in FIG. 1D.

The second representation therefore allows a user to visualise how variable values are changing over time, and in particular how multiple associated variable values within a group are changing, thereby allowing the user to discern whether there are relationships of interest. In particular, this process can be used to determine whether there is any degree of synchronicity between changes in different second data sets, thereby allowing the user to assess whether the relationship can be used in a meaningful manner.

However, this is not essential and alternatively the second representation could be based in an animated version of the first representation, with the animation showing changes in the relationship coefficients over time. In this example, the relationship coefficients could be calculated for multiple time periods over the entire times series data, with this being used to animate the representation, so that changes in node position indicates changes in the relationship coefficients. Thus, for example, if time series data is available for variable values separated by weekly intervals, relationship coefficients can be determined quarterly, with animation of the first representation being used to visualise how the coefficients vary.

Accordingly, the above described process allows a first representation to view the degree of relatedness between large numbers of data sets from a range of sources. In particular, this can be used to allow a user to visually inspect the representation and thereby identify data sets that are highly interrelated. Such highly related data sets can then be selected for use as second data sets, either by visual inspection of the first representation, or by using other techniques, such as comparing the relationship coefficient to a threshold, or combination thereof. Once selected, the second data sets can be displayed on a second representation which shows an animation of how variable values change over time, allowing the user to more easily identify useful relationships.

This provides a useful mechanism for allowing users to compare multiple sets of time series data in a meaningful manner, thereby allowing the user to discover useful relationships that can be exploited in some manner.

For example, the process can be used to compare data sets from a wide range of disparate sources, including demographic information, such as employment rates, climate information, sales information for multiple products, marketing information, or the like. In this example, the first representation can be used to determine where data sets might be related. This could be used, for example, to identify that sales of a particular product, such as ice cream, are highly related to a climate variable such as temperature, as well as to other variables, such as employment rates and marketing spend.

By allowing the user to select groups of variables that appear to be related, and then display these groups on the second representation, a user can easily identify not only that the data sets are related, but also the nature of the relationship. Thus, whilst ice cream sales may correlate positively with temperature, there may be a negative correlation with unemployment, so that as unemployment levels increase, sales decrease. Similarly, it might be discovered that sales tend to increase after an increase in marketing spend. Having discovered these relationships, the user can then time their next marketing campaign to maximise the return on dollar spend.

Thus, the first representation allows a large number of different data sets to be easily considered, to determine if these are related, before the nature of the relationships for selected second data sets is explored in greater detail using the second representation. This allows users to visually identify relationships that would not otherwise be possible using traditional techniques, such as line charts.

In this regard, whilst traditional techniques, such as standard line charts, allow management of an enterprise to see that sales of products X trended in a synchronous way with advertising expenditure. Line charts are only able to show over-time trending for more than a small number of variables at once (in the order of 5-6), they may not be able to discover more than a small number of other synchronous patterns. In contrast, by allowing a number of data sets to be viewed as part of a single group, and by displaying an animation of second nodes representing multiple groups, this allows a far greater number of data sets to be considered than can be achieved using traditional techniques.

Whilst the time series data can be obtained from any suitable source, in one example, the data includes a mixture of public data, such as statistical demographic information, or the like, together with private company information. Thus, the data sets can be based on any time series data sets, which can be found for example in numerous industries and most notably in the operation of many business and government enterprises where regular measurements and statistics are collected to enable, among others, management and marketing executives to obtain oversight on the enterprise's operations and progress.

It will be appreciated that by performing the above described process using a suitably programmed computer system, this allows a very large number of different and disparate data sets to be analysed, which in turn is useful in identifying previously undiscovered relationships, particularly between data sets which have previously been assumed to be unrelated.

For example, using the above described technique, users may be able to discover that sales of product X also trend synchronously with the changes in tourist numbers to the area, competitor pricing, and the cost of living. This additional and previously unknown information can be used in marketing of the product to refine the company's definition of target markets.

In addition, the system can allow companies to share information allowing previously undiscovered correlations between different products to be identified. Thus for example, research might show that sales of a particular car correlate highly with sales of a particular brand of coffee, allowing the companies to run joint promotions thereby further maximizing return on marketing spend.

Accordingly, the above described process provides a new method and apparatus for use in analysing time series data, and in particular provides a tool allowing users to easily visualise relationships between disparate time series data sets. More particularly, the process allows for the creation and visualization of a network of inter-relationships of a large number of time series variables and analysis of the trend synchronicity of the time series variables that enables insights to be drawn about the degree and timing of synchronicity between large numbers, hitherto difficult or impossible to detect.

This can be used, for example, to allow business managers and those in other domains to visually and quickly comprehend patterns of trend synchronicity in their accumulating data stores, and therefore glean insights to guide improvements in their endeavours.

An example of a process for performing a search to identify variables having an impact on each other, and in one example to identify variables having a cause and effect relationship on each other will now be described with reference to FIG. 1B and FIG. 1E.

For the purpose of this example, it is assumed that the process is performed at least in part utilising an electronic processing device, and in particular a processing system, such as a suitably programmed computer system, that is capable of analysing data to determine variables having an impact on each other, such as a cause and effect relationship.

In this example, at step 170 the electronic processing device determines a number of selected data sets selected from a plurality of data sets, typically in accordance with input commands provided by a user.

Each data set is indicative of at least one variable value of a corresponding variable, and in one example, is time series data relating to one or more variables and may include a number of variable values representing changes in the one or more variables over time. Such time series data can be of any appropriate form and can relate to any type of data for which variable values at a given time can be determined. This can include, for example, market research data, sales data, demographic information, climate data, sporting information or the like, as will be described in more detail below. However, the techniques can also apply to other data that is not time series data, as will be described in more detail below.

The data sets are typically selected by a user based on a number of available data sets, which are displayed to the user by the electronic processing device, for example in the form of a list or data set tree.

At step 180, the electronic processing device determines a selected variable of interest, typically selected in accordance with input commands provided by a user. The selected variable represents a search term, and corresponds to a variable for which the user is interested in understanding relationships with other variables in the selected data sets.

At step 190, the electronic processing device determines relationship coefficients between the selected variable and each other variable of the selected data sets. The relationship coefficients are indicative of a degree of relatedness between variables and may be determined in any suitable manner, such as by performing a regression or correlation analysis of the data sets.

Relationship coefficients may be calculated on an as need basis, once the selected variable and data sets have been determined. Alternatively, relationship coefficients can be determined between each possible pairing of variables within all the data sets, with this being done when data is first imported into the system. In this example, the relationship coefficients can be stored in a store, such as a database, or the like, and retrieved as required.

At step 200 a representation is generated which is at least partially indicative of the relationship coefficients. The nature of the representation can be of any suitable form. In one example, the representation can be a simple list of coefficients for each of the variables. Alternatively however, a graphical network representation can be used in which nodes are displayed corresponding to each of the variables “\\rithin the selected data sets, and with relative spatial positions for the nodes being based on the relationship coefficients. The nodes may be represented by any form of visual indicator and in one example this can include a sphere, circle or the like. Node connections can then be provided between some, or all of the nodes, with the node connections being indicative of relationship coefficient, for example by having a line weight based on the relationship coefficient value. In one example, a selected node, corresponding to the selected variable, can be positioned at a centre of the representation, with nodes for the other variables being spatially distributed based on the relationship coefficients.

An example of such a representation is shown in FIG. 1B. In this example, the representation 150 includes a number of nodes 151, each representing a selected data set and node connections 152, which are indicative of the relationship coefficient between the selected data sets represented by the connected nodes.

The representation is generated and displayed by the electronic processing device allowing the user to optionally manipulate the representation, for example to view different nodes or relationships in more detail. This allows users to easily visually identify the degree of relatedness between variables selected data sets, based on the spatial proximity of the nodes and/or the strength of the node connections, thereby allowing the user to identify highly related variables.

Accordingly, the above described arrangement allows a user to identify relationships between variables, and in one particular example, to identify when variables have an impact on other variables, such as through cause and effect relationships. This allows users to answers questions of the type: ‘what causes what’, and ‘what is related to what’.

To generate the relationship coefficients, in one example the electronic processing device determines from the selected data, whether the data is suited to regression and other associated methods that enable inferences to be made of contributory causality (‘what causes what’), or whether the data and the variables within it are suited only for display of correlational relationships (‘what is related to what’).

For example, time series data over a sufficient number of time periods is amenable to forms of cause and effect multiple regression analysis thereby enabling inferences to be drawn as to which variables have served as contributory causes to affect certain other variables. However, if the time series data contains insufficient time periods, then multiple regression procedures are not suited and the means by which inferences can be drawn about the nature of a relationship between any two variables must rely upon correlational analysis.

Thus, the electronic process device can examine the data and if the data is suited creates relationships between variable that give priority to answering questions of the type ‘what causes what’.

Accordingly, the above described process allows the process to be used to answer questions about relationships between variables in sets of data. Instead of being a semantic search for the occurrence of search term words, as is the more traditional class of search (e.g. Google, Bing or Yahoo), the units of analysis of the above method are data variables. This allows a degree of relatedness between variables to be determined, which can prove to be more informative.

Thus, for example, the marketing director of a company might be interested in knowing where the company's marketing spend is most effective. Methodologically this means the system determines relationships between variables representing marketing expenditure (e.g. expenditure on television advertising, on radio, or newspapers, or social media) and sales of a product being advertised. The executive wants to know in an even more granular way, which of many variables had the most impact on sales: was it a particular television show or series, or a newspaper campaign in a certain paper and locality, or a particular series of radio advertisements? Furthermore, the executive who may not know or be interested in the underlying statistics, wants to have the system indicate to him or her which variables caused in a contributory sense the most variation in sales over a selected period and relative to all other variable in the system at the time.

Accordingly, the user selects the variable of interest that is to act as the search term, e.g. sales of a product in dollars or volume, and then typically selects data sets of variables that might be related to that particular variable. If the selected variables of the selected data sets are found in data suited to the system identifying causal relationships in relation to the selected variable and others, then the electronic processing device will attempt to find the relatively strongest contributory causes affecting the selected variable. Otherwise, only correlational relationships are determined.

In either case, the results can be provided in the form of a table or list. For example, for a given data set (or mix of data sets) and all the variables contained therein, the effects on variable Y (e.g. Sales) were most strongly caused by (in contributory causal terms, or else most strongly related to in correlational terms), variables X103, X422, X008 and X222 in that order. The list or tabular forms may also report one or more coefficients or other value indicative of the strength of relationship between the variables. For example: X103 (0.82), X422 (0.64), X008 (0.28) and X222 (0.19).

However, whilst such representations are satisfactory for small numbers of variables, much larger numbers, such as hundreds and thousands of variables, require a simple and preferably visual form of reporting. Furthermore, this is preferably interactive from the user's point of view so they can immediately see and understand which of many possible variables have the greatest impact (causal or correlational) on the selected variable. Also, the user can rapidly change the search context, e.g. by introducing one or more additional data sets and therefore other variables that may be more informative as to what causal or correlational effects there are on the selected variable. The search process is under the user's control.

Accordingly, the above described process allows a representation to be used to display to view the degree of relatedness between large numbers of data sets from a range of sources. This can be used to allow a user to visually inspect the representation and thereby identify data sets that are highly interrelated. This provides a useful mechanism for allowing users to perform searches to identify relationships between data set variables, thereby allowing the user to discover useful relationships that can be exploited in some manner.

For example, the process can be used to compare data sets from a wide range of disparate sources, including demographic information, such as employment rates, climate information, sales information for multiple products, marketing information, or the like. In this example, the representation can be used to determine which data sets might be related. This could be used, for example, to identify that sales of a particular product, such as ice cream, are highly related to a climate variable such as temperature, as well as to other variables, such as employment rates and marketing spend.

Whilst the data can be obtained from any suitable source, in one example, the data includes a mixture of public data, such as statistical demographic information, or the like, together with private company information. Thus, the data sets can be based on any time series data sets, which can be found for example in numerous industries and most notably in the operation of many business and government enterprises where regular measurements and statistics are collected to enable, among others, management and marketing executives to obtain oversight on the enterprise's operations and progress.

It will be appreciated that by performing the above described process using a suitably programmed computer system, this allows a very large number of different and disparate data sets to be analysed, which in turn is useful in identifying previously undiscovered relationships, particularly between data sets which have previously been assumed to be unrelated.

For example, using the above described technique, users may be able to discover that sales of product X also trend synchronously with the changes in tourist numbers to the area, competitor pricing, and the cost of living. This additional and previously unknown information can be used in marketing of the product to refine the company's definition of target markets.

In addition, the system can allow companies to share information allowing previously undiscovered correlations between different products to be identified. Thus for example, research might show that sales of a particular car correlate highly with sales of a particular brand of coffee, allowing the companies to run joint promotions thereby further maximizing return on marketing spend.

Accordingly, the above described process provides a new method and apparatus for use in performing searches to identify relationships between disparate data sets. More particularly, the process allows for the creation and visualization of a network of interrelationships of a large number of variables, allowing users to search for cause and effects between different data sets.

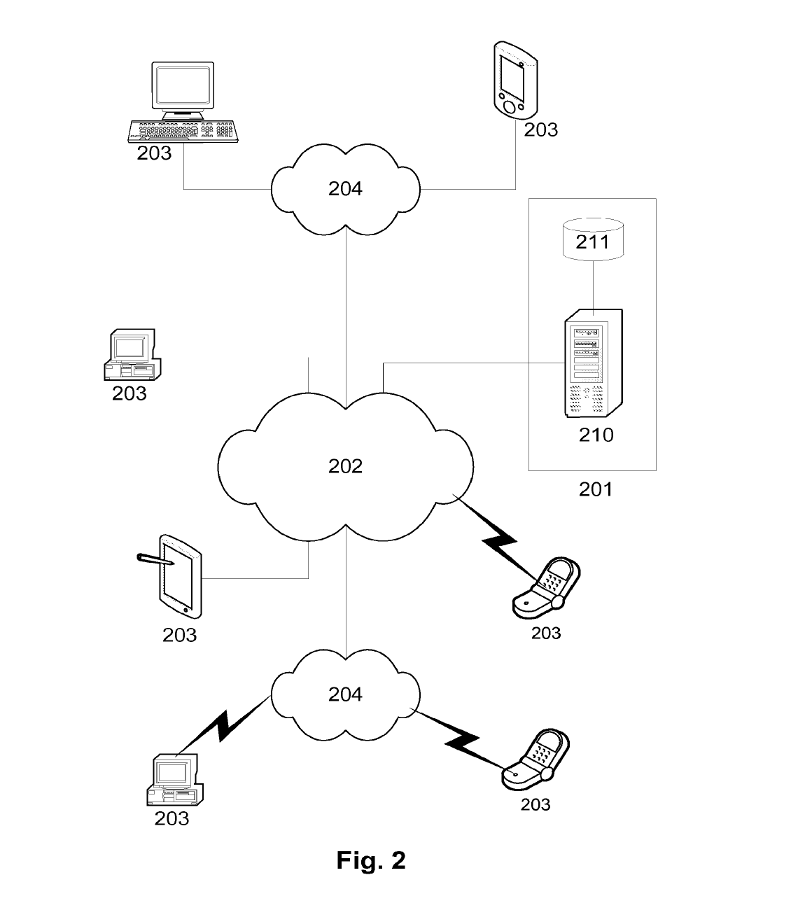

As mentioned above, the process is performed at least in part using a processing system. In one example, the process can be performed using a stand alone computer system. However, in another example, the process can be implemented at least in part using a distributed architecture, an example of which will now be described with reference to FIG. 2.

In this example, a base station 201 is coupled via a communications network, such as the Internet 202, and/or a number of local area networks (LANs) 204, to a number of end stations 203, which will be described in more detail below.

In use, the base station 201 includes one or more processing systems 210 that can be used in analysing time series data, allowing data sets to be searched based on a selected variable, and/or providing access to time series data, stored in a store such as a database 211, for analysis. Whilst the base station 201 is a shown as a single entity, it will be appreciated that the base station 201 can be distributed over a number of geographically separate locations, for example by using processing systems 210 and/or databases 211 that are provided as part of a cloud based environment.

The end stations 203 are typically used by users during the analysis process, either to perform the analysis or search, or to allow users to control the analysis or search and view results generated by the base station 201. In either case, this is typically achieved by having the end stations 203 communicate with the base station 201.

In one example, the analysis process is implemented at least in part using suitable analysis applications software hosted by one or more processing systems 210, with the end stations 203 being used to allow user interaction with the analysis applications software, via the communications networks 202, 204. In one example, the applications software operates as a search engine, with the end stations 203 being used to allow user interaction with the search engine, via the communications networks 202, 204. Each end station 203 therefore typically executes applications software allowing communication with the analysis software, as well as to allow viewing of content, such as a browser application, or the like. However, this is not essential and any suitable arrangement, such as having the analysis applications software executed by the end stations 203 may be used.

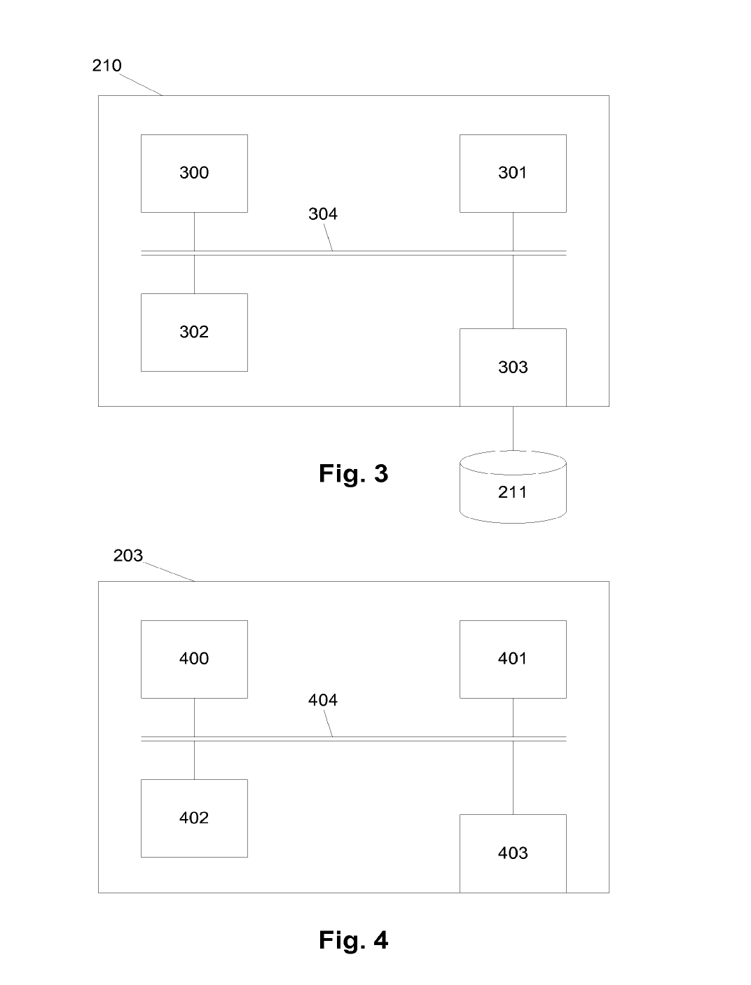

An example of a suitable processing system 210 is shown in FIG. 3. In this example, the processing system 210 includes at least one electronic processing device, such as a microprocessor 300, a memory 301, an input/output device 302, such as a keyboard and/or display, and an external interface 303, interconnected via a bus 304 as shown. In this example the external interface 303 can be utilised for connecting the processing system 210 to peripheral devices, such as the communications networks 202, 204, the databases 211, other storage devices, or the like. Although a single external interface 303 is shown, this is for the purpose of example only, and in practice, multiple interfaces using various methods (e.g. Ethernet, serial, USB, wireless, 3G or the like) may be provided.

In use, the processor 300 executes instructions in the form of applications software stored in the memory 301 to allow the analysis process to be performed, or to allow interaction with time series data stored at the base station 201. Accordingly, it will be appreciated that the processing system 300 may be formed from any suitable processing system, such as a suitably programmed computer system, PC, web server, network server, or the like. In one particular example, the base station 201 is implemented as part of a cloud architecture, and it will be appreciated from this that the processing system 210 can be a single processing system or multiple processing systems 210 interconnected by a computer network.

As shown in FIG. 4, in one example, the end station 203 includes at least one electronic processing device, such as a processor 400, a memory 401, an input/output device 402, such as a keyboard and/or display, and an external interface 403, interconnected via a bus 404 as shown. In this example the external interface 403 can be utilised for connecting the end station 203 to peripheral devices, such as the communications networks 202, 204, storage devices, or the like. Although a single external interface 403 is shown, this is for the purpose of example only, and in practice multiple interfaces using various methods (e.g. Ethernet, serial, USB, wireless, 3G or the like) may be provided. It will also be appreciated that additional hardware components, may be incorporated into the end stations 203, depending on the particular implementation.

In use, the processor 400 executes instructions in the form of applications software stored in the memory 401 to allow communication with the base station 201 and/or to perform the analysis process. For example, this can be used to allow an operator to interact with content analysis or search engine applications software hosted by the base station 201 and/or to access data sets or time series data stored in the database 211, as will be described in more detail below. Accordingly, it will be appreciated that the end stations 203 may be formed from any suitably programmed processing system, such as a suitably programmed PC, Internet terminal, lap-top, hand-held PC, tablet PC, slate PC, ipad™ mobile phone, smart phone, PDA (Personal Data Assistant), or other communications device.

In the following specific example processes, it will be assumed that actions performed by the end station 203 are performed by the processor 400 in accordance with instructions stored as applications software in the memory 401 and/or input commands received from a user via the I/O device 402. The base station 201 is a server which communicates with the end stations 203 via the communications networks 202, 204 via wired or wireless connections, depending on the particular network infrastructure available. Actions performed by the processing system 210 are performed by the processor 300 in accordance with instructions stored as applications software in the memory 301 and/or input commands received from a user via the I/O device 302, or commands received from the end stations 203.

In the following examples, it is assumed that the processing system 210 of the base station 201 hosts an analysis application or search engine that performs a majority of the processing tasks, and which generates a user interface that is displayed using a browser applications, or similar, hosted by the end stations 203, to allow interaction with the analysis application or search engine. However, it will be appreciated that the above described configuration assumed for the purpose of the following examples is not essential, and numerous other configurations may be used.

It will also be appreciated that the process could be performed on a standalone processing system, and in particular could be performed using any electronic processing system including an electronic processing device, such as a microprocessor, microchip processor, logic gate configuration, firmware optionally associated with implementing logic such as an FPGA (Field Programmable Gate Array), or any other electronic device, system or arrangement capable of analysing network data.

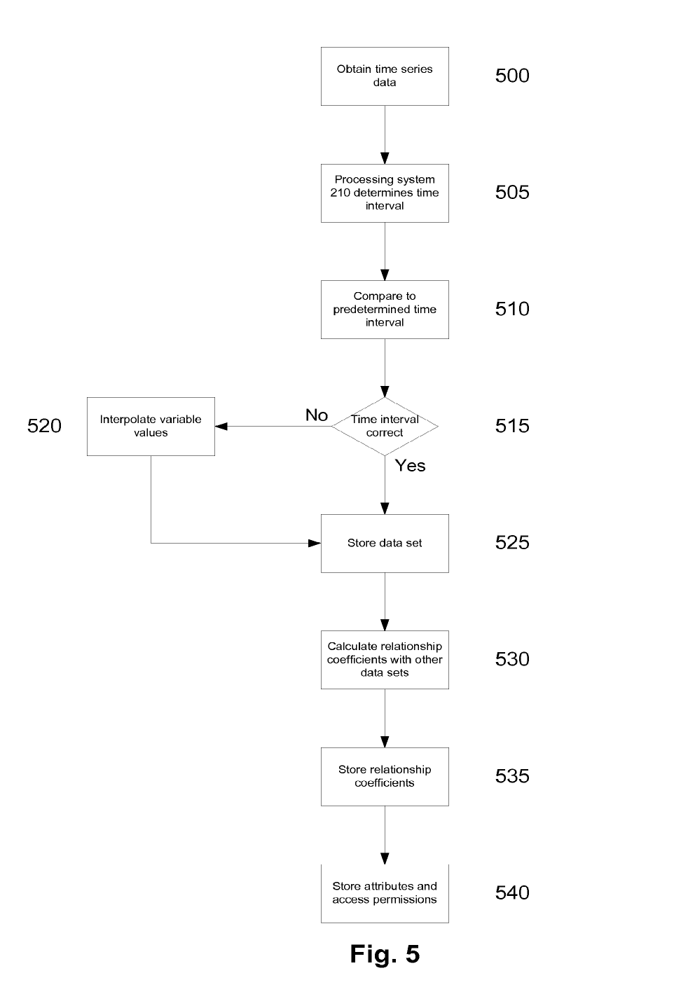

An example process for preparing data sets, such as time series data, for analysis will now be described with reference to FIG. 5.

In this example, at step 500, a data set of time series data is obtained. The data set may be obtained in any one of a number of manners. Thus, for example, a company may provide access to data stored in data repositories, in which case the data may need to be retrieved, translated into an appropriate format and then transferred to the processing system 210. Alternatively, time series data can be collected by automated processes, such as having an automated software application retrieve time series data from publicly available sources, via a communications network, such as the Internet.

It will also be appreciated that data can be collected via a range of different processes.

For example, as a further alternative, surveys can be used to collect time series data to relate to an individual's patterns of behaviour. This can include having the users provide an indication of activities that they perform at particular times of the day allowing additional time series data to be collected, which would not otherwise be generally publicly available, as will be described in more detail below.

As described above, the data set is typically time series data that includes a number of variable values corresponding to the value of a particular variable at a number of different points in time. However, this is not essential and the data sets may correspond to discrete one-off data, as will be appreciated by persons skilled in the art. At step 505, the processing system 210 examines the data set and determines a time interval between successive variable values. The time interval is then compared to a predetermined time interval at step 510, to determine if the time interval requires modification at step 515.

In this regard, in order to allow data sets to be correlated, and in particular to allow the use of regression analysis where possible, it is preferable for all of the data sets to have a common predetermined time interval. The particular value of this interval may vary depending on factors, such as the nature of the data, the preferred implementation or the like. By way of example, the predetermined time interval can corresponding to a weekly, monthly, quarterly or annual interval, although this is not essential and any appropriate time interval can be used.

In any event, if it is determined that the time interval of the data set does not correspond to the predetermined timing interval then variable values for the data set are interpolated at step 520, so that a data set having variable values with the predetermined time interval can be generated and stored in a store, such as the database 211, at step 525.

At this stage, additional processing may be performed, such as data cleansing, interpolation of series, checks on stationary and seasonality, and autocorrelation checks. Other functions include structural equation modelling, baysian modelling, the generation of structural vector autoregressive models, and model evaluation including misspecification tests. Candidate variables and models are progressively narrowed to ‘terminal’ models to enable testing for approximation of fit to the data. A thorough testing and calibration of the model ensures that visualizations by the user across different datasets are meaningful and appropriate.

At step 530 relationship coefficients are then determined with other data sets stored in the database 211. In one example, this process can be performed when data is initially imported into the system. Thus, each time a data set is imported, a relationship coefficient can be determined with each other data set already imported, allowing the relationship coefficients to be stored together with, or as part of the data set.

However, this is not essential and alternatively relationship coefficients can be generated as required. Thus, for example, the first time a data set is used in an analysis or search process, a relationship coefficient can be determined by comparing the data set to each other data set being used in the analysis or search. This means that relationship coefficients are only calculated as required, but once calculated can be stored to allow subsequent retrieval, and to avoid the need to recalculate the relationship coefficient each time the system is used.

The relationship coefficient can be determined in any appropriate manner. Typically this is achieved by performing a regression or correlation analysis as known in the art. During this process, variables can become associated with other variables, with the association being indicative of both a directionally and strength, by means of correlation or, more commonly, time sense regression methods using both proprietary and package algorithms particularly suited to the determination of cause and effect relationships. However, any technique for determining a coefficient that is indicative of the degree of relatedness between the data sets, and preferably a degree of impact between variables of different data sets, can be used. This may include, for example, the use of neural networks or fuzzy logic, artificial intelligence, cognitive modelling, predictive analysis, cross correlation analysis, or the like.

At step 540, additional information to be associated with the data set can be determined and stored. The additional information can include any information relevant to the data set, and can include for example, attributes of the data set, access permissions, details of the source of the data set, or the like.

The attributes can include any additional information associated with the data set, which may be useful in understanding the meaning of the data set. This can include, for example, a name and description of the variable, details of any locations to which the data relates, or the like.

Access permissions may be provided to allow access to the time series data to be restricted. For example, the access permissions can be indicative of individual users or groups of users that can have access to the data. The access permissions may be determined in any suitable manner but, in one example, are specified by a supplier of the data set, thereby allowing the supplier of the data to control dissemination of the data. Thus, for example, if a company were to supply their own data relating to aspects of their business, they may only want this available to company employees, or employees of selected other companies. In this instance the user can provide details of other users that can have permission to access the data which are then stored as the access permissions.

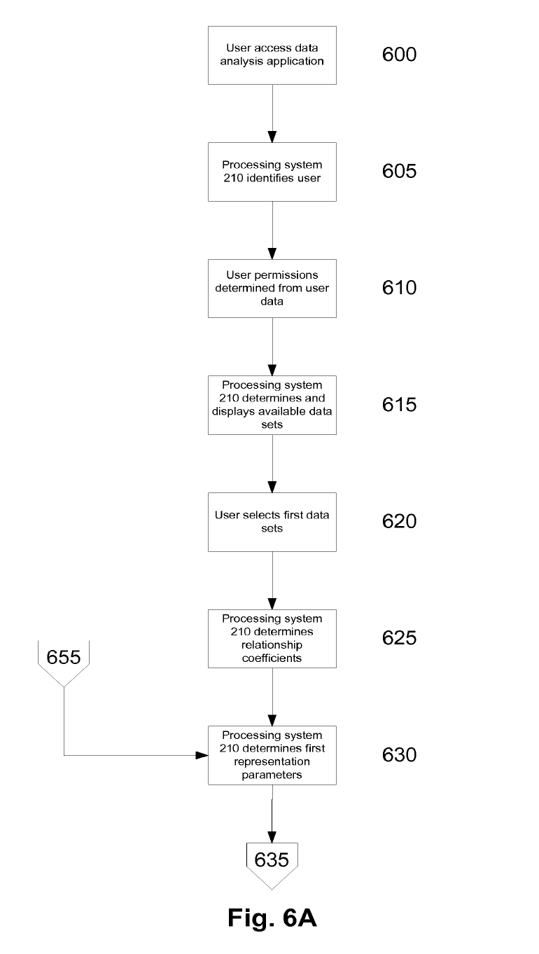

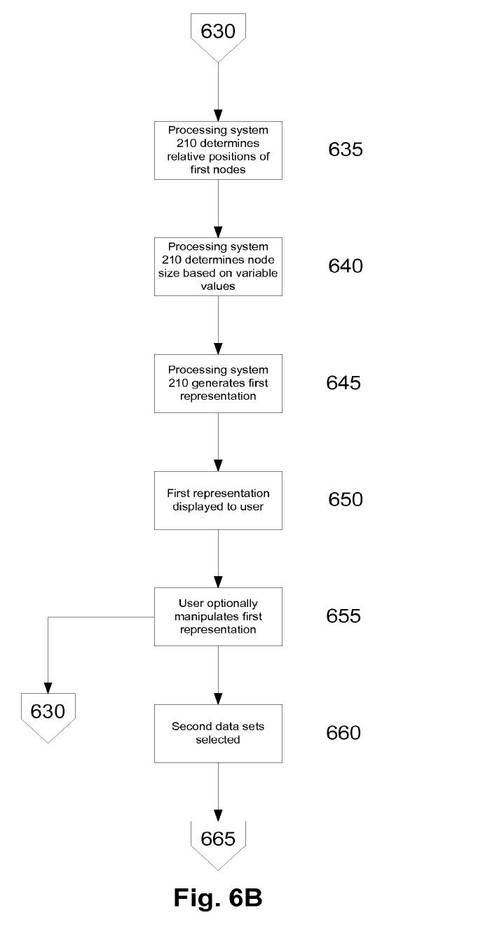

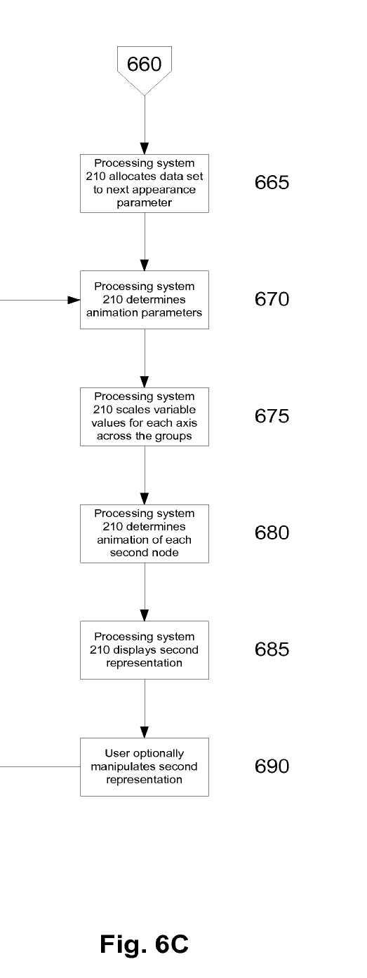

An example process for use in analysing time series data will now be described with reference to FIGS. 6A-6C.

In this example, at step 600, a user accesses a data analysis application implemented by the processing system 210, with the processing system 210 identifying the user at step 605. The identification process is typically used to ensure that a user has permission to access the data sets stored in the database 211, and may be performed in any appropriate manner. In one particular example, this is achieved by having the user provide authentication information, such as a username and password, or the like, which the processing system 210 compares to previously determined authentication information, which is typically created during a registration process. Such processes are known in the art and will not therefore be described in any further detail.

At step 610 the processing system 210 accesses user permissions associated with the user, typically based on the identity of the user. The user permissions may be stored as part of user data associated with the user, and typically specify any relevant permissions associated with the user. Thus, for example, the permissions may indicate that the user is able to access only limited data provided by their employer, depending for example on their position within the organisation.

At step 615, the processing system 210 determines and displays details of available data sets, thereby allowing the user to select a plurality of data sets for use as first data sets, at step 620. These first data sets are used as a basis for creating the first representation, as will be apparent from the following description. The first data sets can include all available data sets, but more typically are a subset of all available data sets, which the user believes may be of interest.

It will be appreciated by a person skilled in the art that the data sets can be displayed in any appropriate way and this can include, for example, providing a list of available data sets via a user interface. Additionally, and/or alternatively, data sets can be provided in different categories allowing users to search via a combination of category and/or keyword searching to allow particular data sets of interest to be selected. The data sets will also typically be filtered based on the user permissions associated with the user and based on the access permissions of the data set. Accordingly, in one example, the user is only presented with details of the data sets they are able to use in the analysis process.

In any event, the data sets are typically selected in accordance with user input commands received via an input device, although other suitable techniques can be used.

Once the first data sets have been selected, the processing system 210 determines the relationship coefficients for each pair of first data sets. It will be appreciated that this may be achieved by retrieving the previously stored relationship coefficient, or by calculating new relationship coefficients as required.

At step 630, the processing system 210 determines any representation parameters. The representation parameters are typically used to control how the first representation is displayed, and can include for example, options regarding filtering of the number of connections or nodes which are shown, an opacity of nodes, a first representation viewpoint or zoom levels, whether other information, such as node identifiers, are to be displayed, or the like. The representation parameters are typically controlled by the user, allowing the user to manipulate the representation, as will be described in more detail below, but typically include initial default values which are used when the first representation is initially displayed.

At step 635 the processing system 210 determines relative spatial positions of the first nodes based on the determined relationship coefficients, so that more highly related nodes are positioned closer to each other. The relative spatial positions can be determined using any suitable graph mapping technique that is capable of determining a relative spatial position, and this will not therefore be described in further detail.

At step 640 the processing system 210 determines a node size for each data set, based on the variable values. In this regard, each first data set is represented by a respective first node in the first representation, with the size optionally being based on the variable values in some manner. For example, the node size can be used to represent absolute variable values, such as an average variable value for the total time series data or over a predetermined time interval, or alternatively can represent changes in variable values, for example the degree to which the variable value has increased or decreased over the most recent time interval. However, this is not essential, and alternatively, the nodes may be displayed with a common size, or alternatively the node size can represent other information associated with the data set.

At step 645 the processing system 210 generates the first representation. In generating the first representation, the processing system 210 will take into account the representation parameters, such as the currently selected viewpoint, zoom level, or the like, and then use this, together with the relative spatial positions of the first nodes, to determine the appearance of the first representation.

Thus, for example, the representation parameters will typically include a coefficient threshold, which is used to filter the number of node connections that are shown in the first representation. Accordingly, the processing system 210 will compare the relationship coefficient for each pair of nodes to the coefficient threshold and then only display node connections between first nodes when the corresponding relationship coefficient exceeds the coefficient threshold.

At step 650, the first representation is displayed to the user. Thus, it will be appreciated that if the user is using an end station 203, the representation may be generated by the processing system 210 and then transferred to the end station 203, as required.

At step 655 the user optionally manipulates the first representation. The nature of the manipulation will depend on the preferred implementation, but typically this can include altering representation parameters, such as a viewpoint, the presence or absence of indicators, zoom levels, or the like. Thus, for example, the user can select a first data set, with the processing system 210 determining selection of the first data set, and then moving a viewpoint so that the node of the selected first data set is displayed centrally in the representation.

If the user manipulates the first representation, the process typically returns to step 630 allowing the representation to be updated as required.

Manipulation of the first representation is important to allow user visualisation of the degree of relatedness between the first data sets. In this regard, the first nodes are typically spatially distributed in a three dimensional “universe”, which is then represented on a display device in two dimensions, although it will be appreciated that this is not essential, and with the advent of 3D display technology, the first representation could alternatively be presented in 3D. Accordingly, allowing the user to alter the viewpoint and adjust zoom levels allows the user to navigate through the “universe” and explore the relative degree of relatedness between the different first data sets. This in turn allows users to identify clusters of data sets that are highly related and may therefore be of further interest.

Once the user has had sufficient opportunity to view the first representation, the process moves on to step 660 allowing second data sets to be selected. This selection process can be achieved using any appropriate manual and/or automated processes. For example, the user may user the representation parameters associated with the first representation to exclude first data sets for which all relationship coefficients fall below a predetermined threshold, with the user then selecting first data sets that are to become the second data sets by highlighting these in the first representation. Alternatively, the user can be presented with a list of first data sets, allowing the user to select these from the list.

Again, it will be appreciated that the second data sets could be all of the first data sets, but more typically the second data sets are a subset of the first data sets. Thus, the user is able to use the first representation to narrow the number of data sets that are to be used in generating the second representation.

In any event, during this selection process, at step 655, the processing system 210 allocates the second data sets to an appearance parameter for the second representation. The appearance parameter is used to control the appearance of the second node in accordance with the variable values of the second data sets, and can include any appropriate parameter, such as the position of the second node relative to axes, a colour, opacity, size, shape or the like.

The second data sets can be assigned to respective appearance parameters in any appropriate manner, so for example, the second data sets could be assigned based on their order of selection. Alternatively, however, the user can select to assign different data sets to different appearance parameters by selecting from a dropdown list, dragging or dropping first nodes from the first representation into an appropriate field or the like.

During this process the second data sets are grouped associated into groups, with each group of associated second data sets corresponding to a respective second node. The number of data sets in a group will depend on the number of appearance parameters, but in one particular example includes four second data sets, which are mapped to X and Y axes, as well as to a second node size and colour.

At step 670, the processing system determines any animation parameters that are used to control the presentation of the animation. This may include parameters such as an animation speed, the time period to be covered by the animation, or the like. This may also include a time offset associated with any data set, as will be described in more detail below.

At step 675, the processing system 210 scales variable values for each appearance parameter across the different groups. In particular, this generally involves examining the range of variable values within a given data set, over a time period of interest, and then scaling these variable values between pre-selected low and high values. Thus, for example, the variable values can be scaled to fit between ‘0’ and ‘1’, with ‘0’ corresponding to the lowest variable value and ‘1’ the highest variable value, in the data set. It will be appreciated that this is used to allow different data sets to be displayed in a consistent manner for a given visual appearance. So, for example, this allows variable values having different ranges to be displayed relative to common X and Y axes.

In the case of a second node size, it will be appreciated that the value ‘0’ can correspond to the smallest size and the value ‘1’ to the largest size, whilst for a colour appearance parameter the ‘0’ to ‘1’ range can represent a hue, saturation or contrast depending on the preferred implementation.

Thus, it will be appreciated that the second representation can be used to show data sets relating to completely different types of data. So for example, an X axis may need to display population information and product sales, which could typically not be easily shown on the same axis. However, by scaling the variable values based on the maximum and minimum variable values in the data set, this allows each data set to be displayed relative to the same axis.

At step 680, the processing system 210 determines the animation of each second node, based on the animation parameters and the scaled variable values. Accordingly, the processing system 210 will generate a representation including a second node corresponding to each group of data sets, together with information regarding how the second nodes should be animated based on progression of variable values over time. At step 685, the first representation is then displayed to the user. Thus, for example, it will be appreciated that if the user is using an end station 203, the representation may be generated by the processing system 210 and then transferred to the end station 203, as required.

During display, the second nodes are animated in accordance with the variable values and the appearance parameters to which they have been assigned. Thus, for second data sets assigned to X and Y axes, the position of the second node in the second representation represents the variable values in each data set.

Accordingly, the second representation allows the use to explore the manner in which data sets are related. For example, the user can view movements, and other changes in visual appearance, to understand the nature of the dependency between the data sets. It will be appreciated that the second representation allows a number of different second nodes to be displayed simultaneously. Thus, as each second node can represent five or six data sets (depending on the number of appearance parameters used), and multiple second nodes can be displayed, it will be appreciated that the second representation allows a significant number of data sets to be examined, unlike traditional line charts, which are limited to a restricted number of data sets.

At step 690 the user optionally manipulates the second representation, for example by changing animation parameters, stopping and starting animations or the like. By suitably adjusting the manner in which the second representation is displayed, this can help users understand the relationships between different data sets.

Thus, for example, one data set may depend highly on another data set, but with a time offset. In this case, if the second nodes moves relative to the X axis and then subsequently in a similar manner relative to the Y axis, this indicates that the second data set on the Y axis is correlated with, but lags behind the second data set on the X axis.

In this instance, the user can select to introduce a time offset into the time series data, allowing users to more easily visualise situations in which there is a lag between cause and effect. For example, in marketing a product, it is typical to have a marketing campaign but this marketing campaign may not immediately result in an increase in sales, which may only occur after the campaign has had time to take effect. In this instance, a user can select to introduce a time offset in the form of a lag in the marketing spend data. In this instance, the processing system 210 effectively shifts the variable values by one or more time intervals, allowing the second representation to be replayed with the introduced offset. This makes it easier for the user to discern that there is an offset between cause and effect and hence more easily visualize how the second data sets are related.

It will be appreciated that once the second representation has been viewed, the user may then choose to return to the first representation and adjust the data sets and hence displayed thereon. The user can then continue investigations by repeating the above described process, this time using different first data sets, thereby allowing further relationships to be considered. The above described process can therefore be performed iteratively, with the user using the first representation to discover relationships between data sets and then use the second representation to understand the nature of the relationship. Following this, further relationships can be investigated, depending for example on the outcome of the previous analysis.

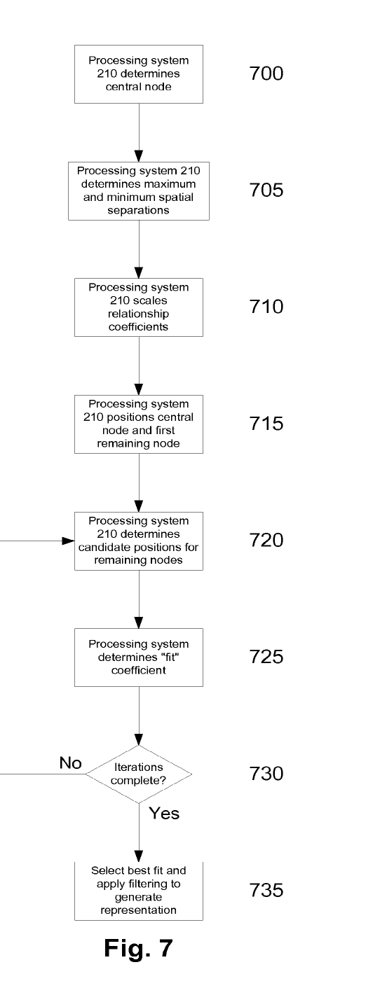

An example process for generating the first representation will now be described in more detail with reference to FIG. 7.

In this regard, it will be appreciated that the processing system 210 has to perform analysis of the first data sets, and in particular the relationship coefficients between the first data sets, in order to generate the first representation. To achieve this, at step 700 the processing system 210 determines a central node, which is a first node to be displayed at a centre of the first representation. The manner in which this is performed will depend on the circumstances and accordingly, this may be performed in accordance with input commands received from a user, for example by having the user select a first data set of interest, allowing this to be used as the central node. Alternatively, if no central node has been selected, the processing system 210 will typically just select a first data set to represent the central node.

The first nodes corresponding to other first data sets will be arranged in the space around the central node and will have a distance from the central node dependant of their relationship coefficients with the first data set represented by the central node. This distance is between a minimum and a maximum value so that all data will display with a consistent spread and the central node will be uncluttered.

Accordingly, at step 705, the processing system 210 determines maximum and minimum spatial separations relative to the central node. The maximum and minimum spatial separations correspond to the maximum and minimum distance from the central node at which other nodes can be provided and this may therefore be determined arbitrarily, or in accordance with input commands supplied by the user.

At step 710 the processing system 210 scales the relationship coefficients based on the maximum and minimum spatial separations. Accordingly, for nodes that are highly related to the central node, these will be provided at the minimum spatial separation whereas nodes that are not related to the central node will have a maximum spatial separation. This effectively defines a series of concentric spheres upon which nodes may be positioned relative to the central node. It will be appreciated that nodes having an intervening degree of relatedness will be positioned between the maximum and minimum spatial separations. This could be performed on a linear scale, logarithmic scale, or the like, depending on the preferred implementation.

Thus, the distance between the central node and any other first node is dictated by the respective relationship coefficient value of the these nodes. A correlation value of zero will cause the distance to be maximised, whilst a correlation value of +/−1.0 will cause the distance to be minimised. Correlation values between these two extremes are mapped linearly to a value between these two extremes, so that each node is provided on a sphere or circle centered at the origin and whose radius varies linearly between the minimum and the maximum radii. This distance is fixed and cannot change so that all first nodes other than the central node move on their own concentric sphere or circle.

At step 715, the processing system positions a central node and a first remaining node. The first remaining node is provided at the scaled spatial separation determined at step 710 above and may be arbitrarily positioned relative to the central node. Typically, however, the first remaining node is positioned directly below the central node.

At step 720 the processing system 210 determines candidate positions for the remaining nodes. The candidate positions are based on the degree of relatedness to the central node, as defined by the scaled spatial separation relative to the central node, and the relationship coefficient \\rith other first nodes in the first representation. Thus, for example, if a next node being considered is highly related to the first remaining node, it will be positioned close by whereas if it is unrelated to the first remaining node, it will be positioned further away. The position is provided on the concentric sphere based on the scaled separation mentioned above.

It will be appreciated from this that the distance between two non-central first nodes is not on the same scale as the distances to the central node because their separations may be greater. For example, suppose the minimum radius is 10 and the maximum is 30: Nodes may be between 10 and 30 distant from the central node (i.e. have loci with radii between 10 and 30). However, two non-central nodes may be separated by 60 (opposite sides of the Great Circle). In this case a separation of 60 represents zero correlation. When two nodes are perfectly correlated (correlation of 1.0) they will be separated by a nominal distance designed to stop nodes clustering too tightly. Correlations between the two extremes have corresponding linearly-varying separations.

However, the only distances that are fixed are those between the central node and other nodes. The calculation of the separation between other nodes is performed using a simplified iterative least squares method. So in practice, if a large number of first data sets are selected, the absolute separations of nodes can be subject to quite a lot of variation.

The initial positions are calculated by applying the cosine rule to the triangle formed by the central node, the first remaining node and the next first node to be placed. Where no solution exists (i.e. the length of one edge of the triangle is greater than the sum of the lengths of its other two edges), the node will be positioned with an alpha value of 1r. This corresponds to a position vertically above the central node.

Having determined candidate positions at all remaining nodes, at step 725, the processing system 210 determines a fit coefficient typically using a regression technique, such as a method of least squares, or the like. The fit coefficient represents the accuracy with which the nodes have been positioned.

The processing system 210 then determines if all iterations are complete at step 730. In this regard, the processing system 210 will typically perform a number of iterations corresponding to different node layouts and determine which of these most accurately represents the degree of relatedness between the nodes. If it is determined that the iterations are not complete, at step 730 the process returns to step 720, otherwise the process moves on to step 735 with the candidate positions that provide the best fit being used to generate the representation. At this point the processing system 210 may also apply filtering to generate the representation, as will be described in more detail below.

In one example, the algorithm performs up to 500 iterations, seeking a ‘best fit’ of all nodes considered together in each iteration. A form of damping can be built-in to the algorithm by virtue of the limiting of the maximum angular change of position of any node in a single iteration to a value which decreases with iteration. Currently this angular delta starts off at ⅔ n and decreases by around 10% on each iteration.

Once a representation has been generated, this can be manipulated in a number of ways. Selecting a node, for example by double clicking on the node, will move the selected node to the centre of the first representation. In one example, all other nodes will move to the right of the central node, before the user further manipulates view points or the like to display the first representation as desired. Two circles indicating the maximum and minimum separation may also be displayed.

Another manipulation that can be performed is the selection of an input to iterate through the algorithm once. Since the algorithm currently exist only when alpha is less than some small value (currently 1 degree), the number of iterations is completely deterministic. For example, an arbitrary number of iterations can be performed. As such, the algorithm seems particularly efficient for a solution in n-1 dimensions.

The above described algorithm is based on a method of least-squares approach for laying out the nodes and therefore has an execution time related approximately to the square of the number of nodes. It also performs analysis on all nodes selected for the first representation regardless of how many nodes are actually displayed, and accordingly the user may elect to select a particular number of iterations based on the number of nodes being considered, thereby controlling the time required to generate and/or manipulate the representation.

As previously mentioned, filtering can be performed to limit the number of nodes and connections displayed on the first representation. In general two different types of filters can be implemented.

A general cut-off filter is used to filter out connections having relationship coefficients below a threshold, based on the original unweighted data sets. In this example, the filter is applied to all data sets, including the central node, if it falls in the lower range of the cut off.

In addition to this, a direct relative cut-off can be used. In this example, a reweighted filter provides a view where the coefficients are reweighted to the selected central node and the filter reapplied. To achieve the reweighting of cross coefficients, all indirect cross node coefficients are multiplied by the highest direct coefficient of the selected central connection. Therefore all coefficients in the database will be less than the strongest direct connection. When the filter is fully applied the last remaining visible connections and nodes are directly related to the central connection or of the same coefficient. The display is then repositioned using the reweighted coefficients. The option of direct cut-off must be selected.

A further type of filtering that can be applied is referred to as a disk cut off filter. In this regard, each node in the first representation is connected to every other node. When displaying connections, there tends to be dense noise from cross connections. These connections clutter up the screen blocking out the direct connections of interest. Accordingly, a multi plane model can be constructed where direct connections (eg: connections between the central node and another node) travel across an upper plane and the cross connections (eg: connections between nodes other than the central node), travel across a lower plane. A disk is inserted in between these planes which when applied reduces or blocks out the cross connections from view actively decluttering the screen from the cross connections. This disc is resizable in real time allowing for cross connections to still be viewed outside the cut off disk. Included is an opacity control to control the distraction of cross connections under the disc so it is possible to identify the cross connections with reduced opacity.

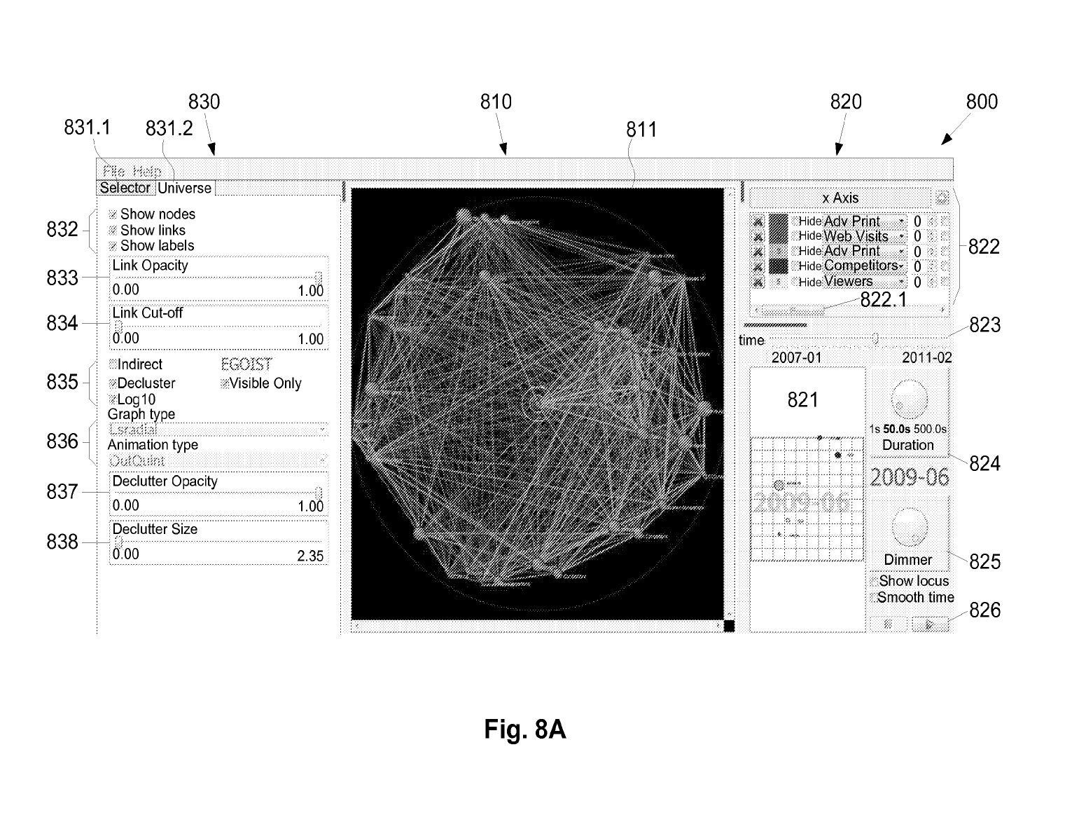

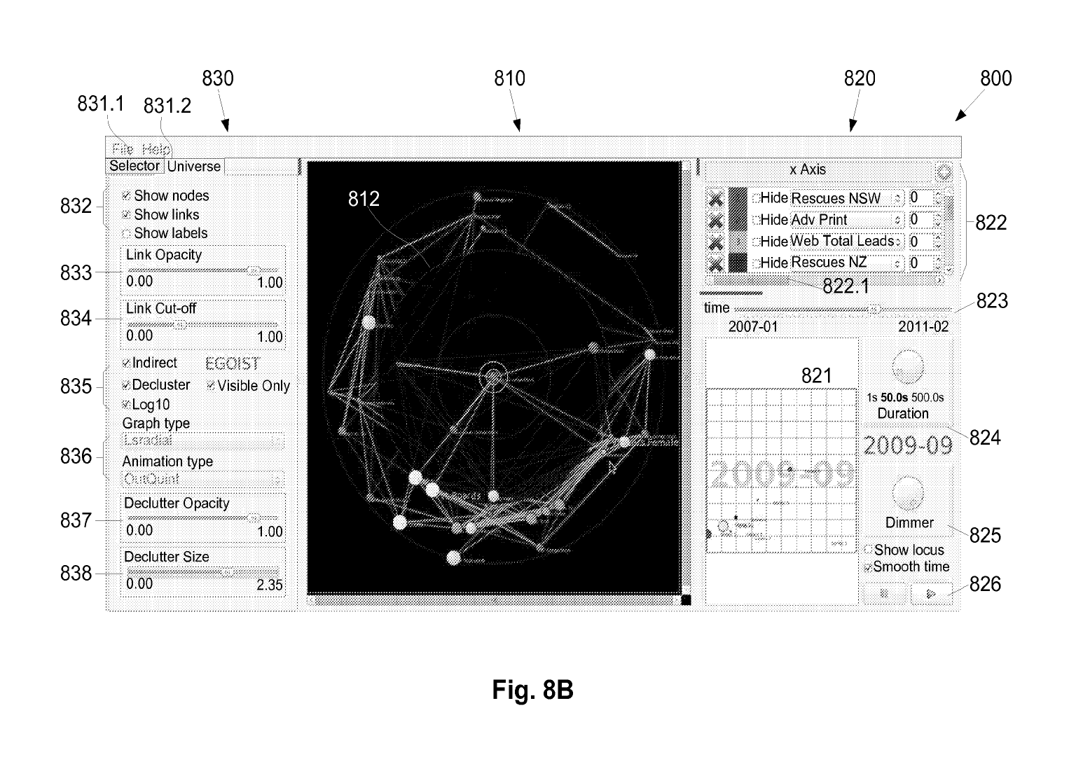

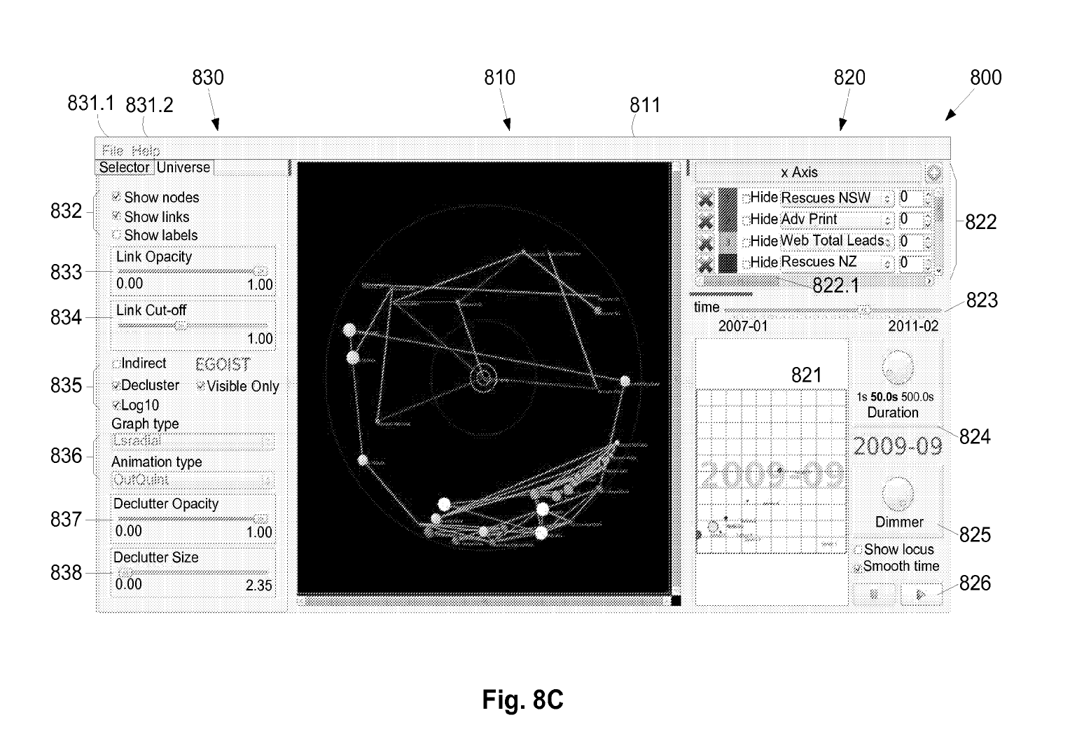

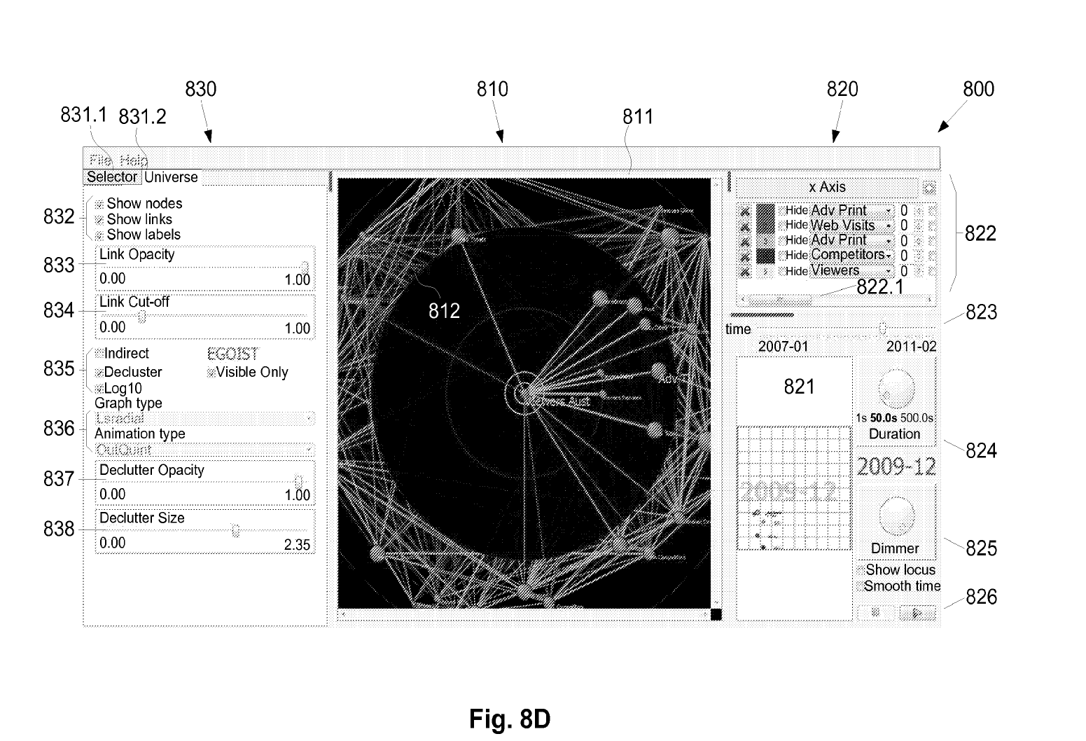

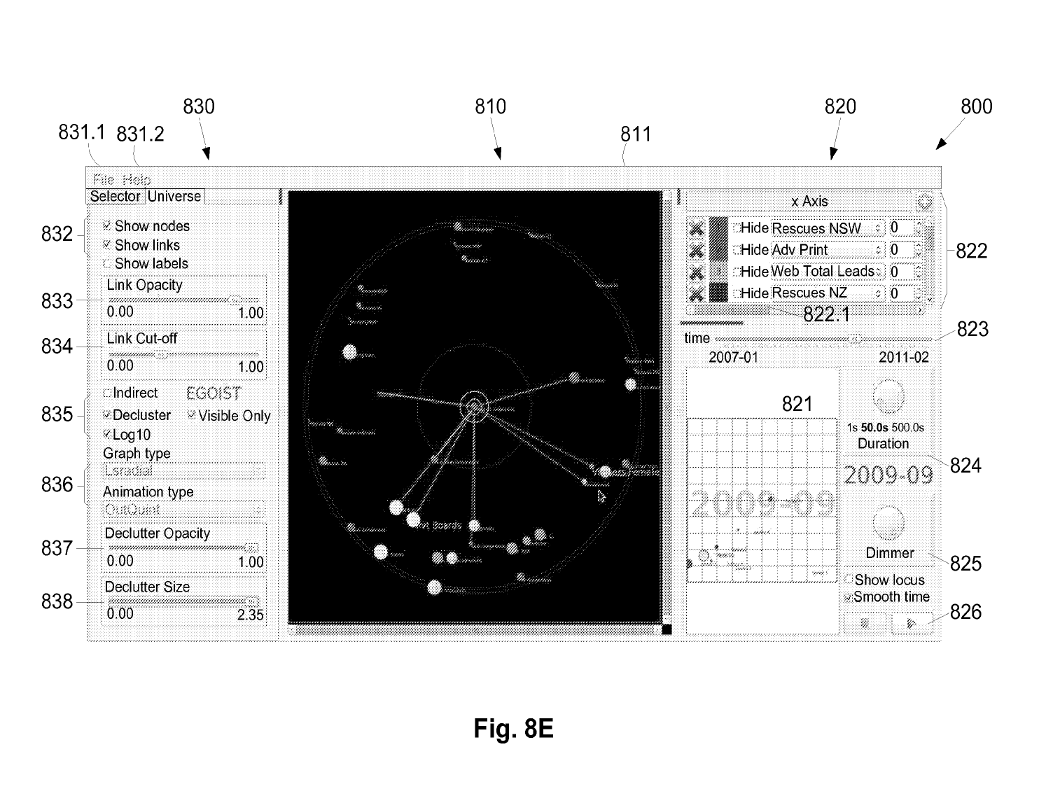

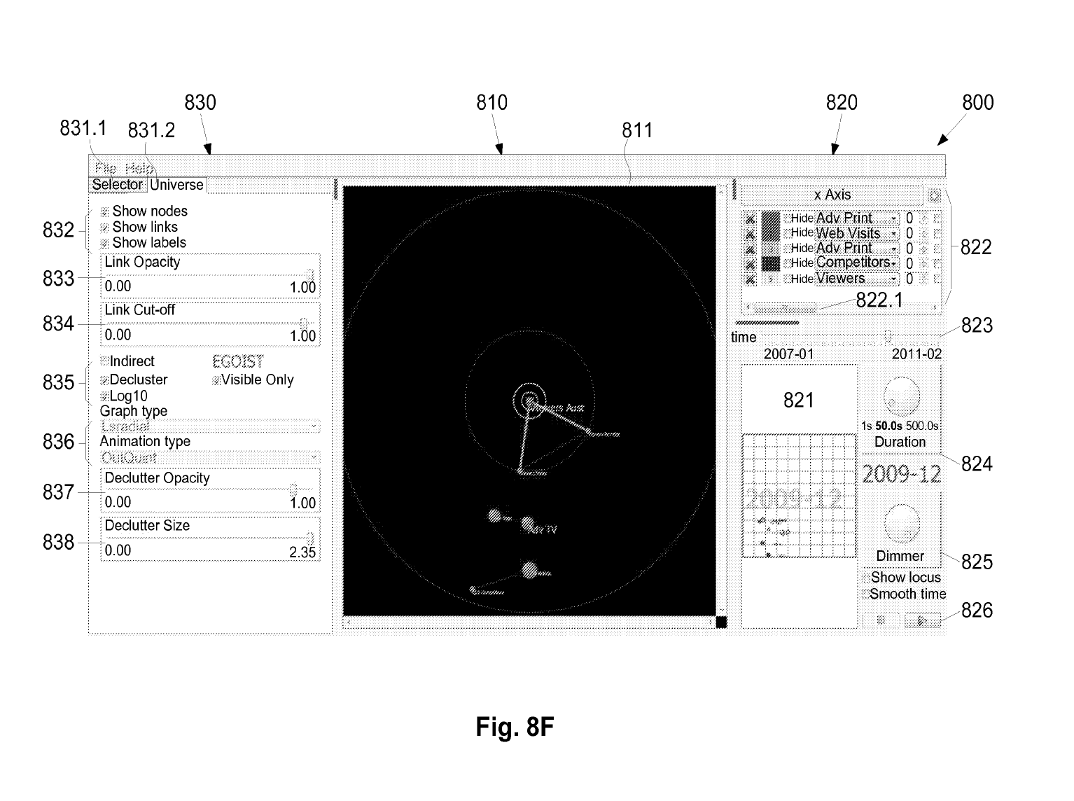

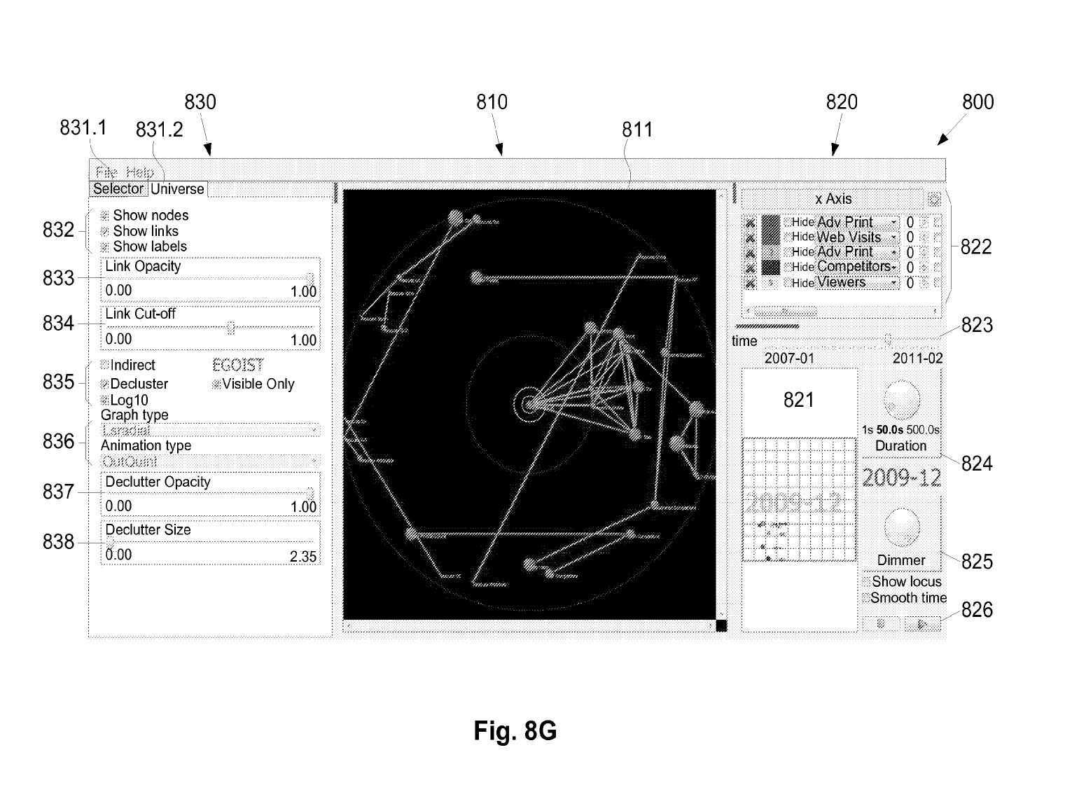

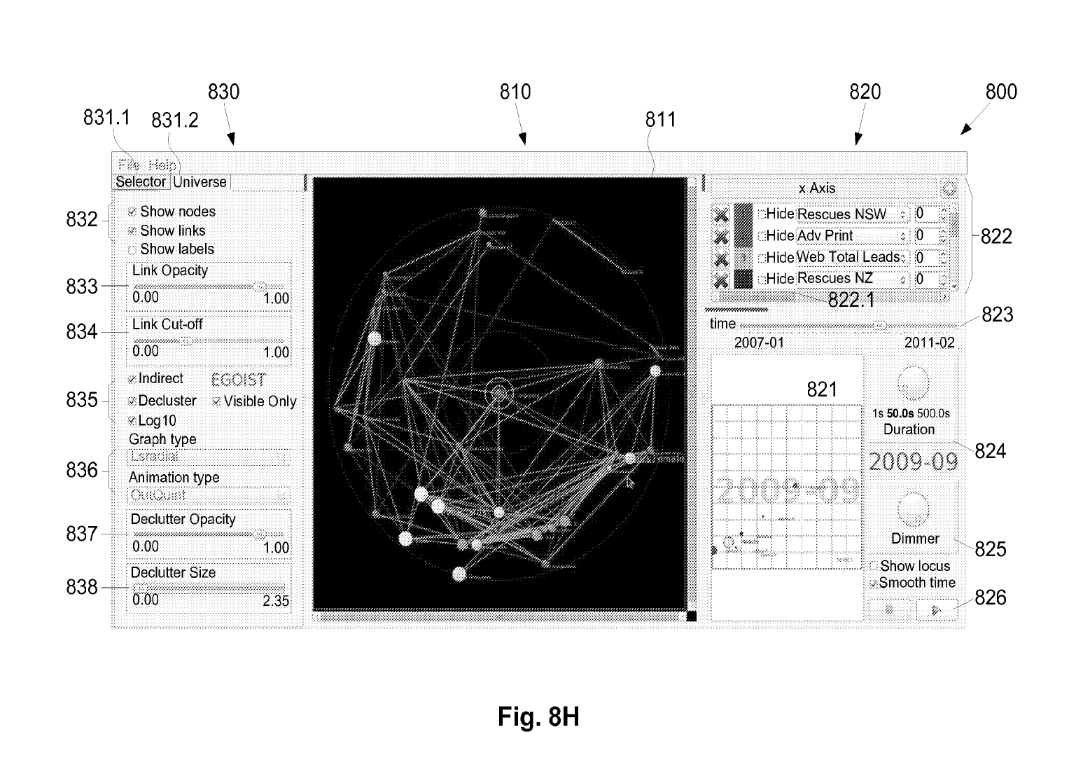

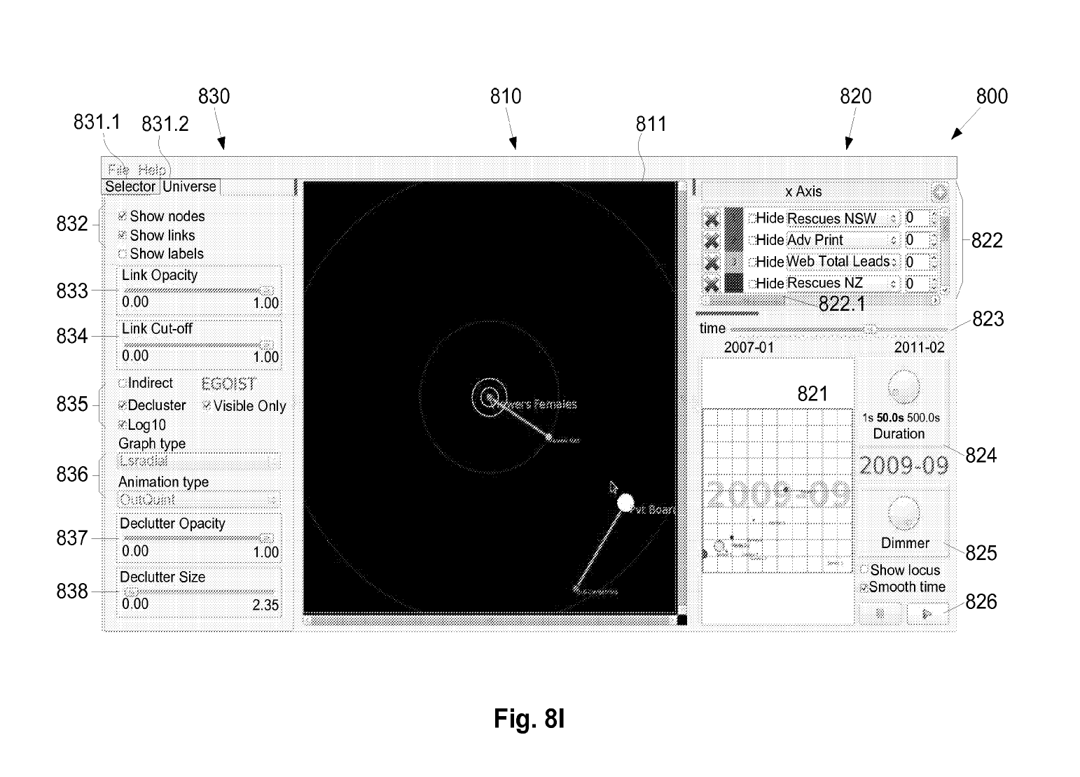

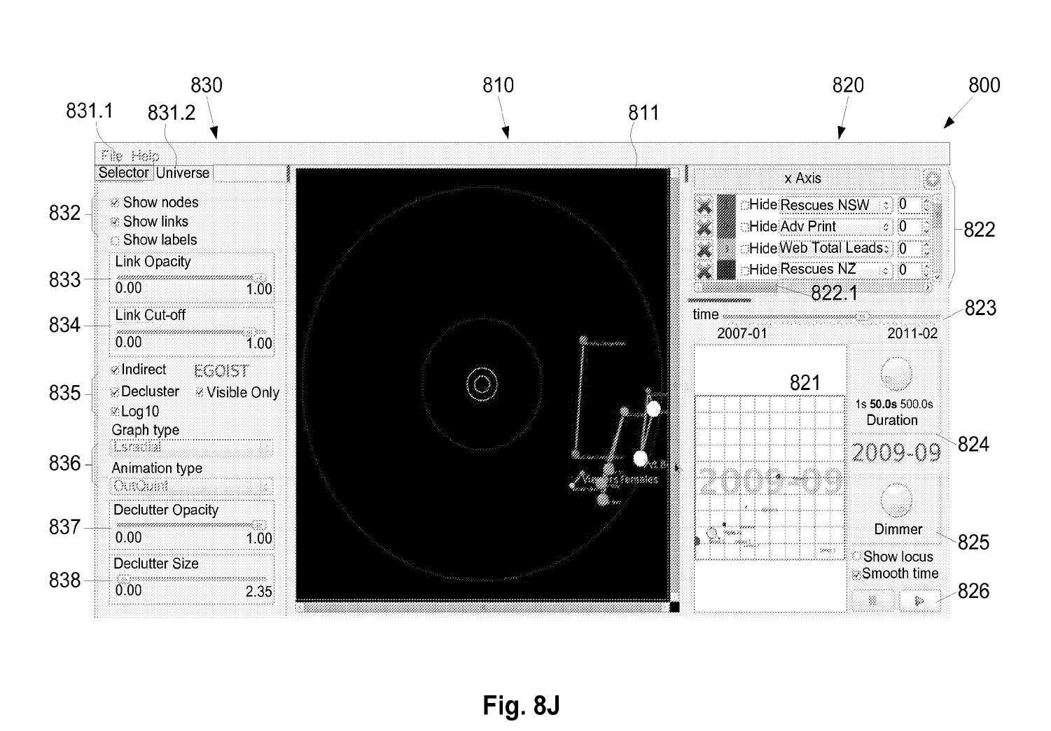

An example of a user interface for displaying first and second representations will now be described with reference to FIGS. 8A-8J.

In the example of FIG. 8A, a user interface 800 is displayed including a first representation window 810, a second representation window 820, and a control window 830. In this example, the first representation window includes the first representation 811 including the first nodes and first connections as shown.

The second representation window 820 includes the second representation 821 together with associated controls. The controls include a data set controller 822, used to select the second data sets, having a slider 822.1. In this example, the data set controller 822 includes five second nodes and displays for each of those second nodes the second data sets associated with each appearance parameter. In the current view, the second data sets associated with the x axis are shown, with data sets associated with other parameters being viewable by moving the slider 822.1. In this example, each second data set is displayed in a drop down box allowing the user to change the second data set associated with a given appearance parameter.

A slider 823 is provided to allow the user to scroll through the animation provided within the second representation 821. In addition to this, controllers 824, 825 are provided to alter the duration of time between successive images in the representation, as well as to dim aspects of the display, such as the display of indications or labels. Play and pause controls are also provided at 826, allowing the user to control display of the animation.

The control window 830 includes tabs 831.1 and 831.2 allowing the user to choose between a data selection and a “universe” control parameter input screens. The data selection screen is not shown in these examples but includes controls allowing users to select the first data sets that are to be displayed as part of the first representation 811. This has previously been described and will not therefore be described in any further detail.

The “universe” control parameter input screen allows the user to define control parameters associated with the display of the first representation. This includes a number of check boxes 832, which allow a user to determine whether nodes, connections or labels should be displayed on the first representation. Connection opacity and cut-off sliders 833, 834 are provided for controlling the opacity of the connections and the cut-off threshold for filtering the connections that are displayed.

Additional controls for allowing indirect, decluttering, logarithmic or visible only options to be selected are shown at 835. A type of representation can be controlled by inputs 836 whilst sliders 837, 838 are used to control declutter opacity and size, which is used in controlling the size and opacity of the disk used for concealing connections, as described above.

Examples of different filtering will now be described in more detail with reference to FIGS. 8A to 8J.

In the example of FIG. 8A, the first representation 811 is shown with the connection opacity set to 1, the connection cut-off at 0, the declutter opacity at 1 and the declutter size at 0. As a result, all first connections and first nodes for the selected first data sets are displayed on the representation.

In FIG. 8B, the user has selected a connection cut-off value, meaning that any connections for which the relationship coefficient falls below the selected value are filtered out and consequently not displayed on the first representation. This reduces the number of connections shown on the representation. In addition to this, the indirect checkbox 835 is shown so that indirect connections between connection nodes are filtered using a disk, whose perimeter is shown at 812, and the size and opacity of which is defined using the declutter opacity and declutter size sliders 837, 838.

In FIG. 8C the indirect selection box is not checked and accordingly, indirect connections (eg: connections between nodes other than the central node) are displayed. In this example, however, the slider 834 is used to filter those connections that are displayed, with those falling below the threshold defined by the slider being omitted.

In FIG. 8D, indirect connections are again filtered using the disk 812, with filtering of all connections being performed on the basis of the position of the slider 834.

In the example of FIG. 8E, the declutter size is increased to its maximum value so that all indirect connections are filtered by the disk. In this example, the connection cut-off slider 834 is also set to a selected value so that direct connections below the connection cutoff are also not shown. As a result, connections are only shown for those nodes which are within a threshold distance of the central node. In FIG. 8F, the connection cut-off threshold is further increased to further reduce the number of node connections shown.

In the example of FIG. 8G, the declutter size slider 838 is minimized so that indirect connections are shown, with the connection cut-off slider 834 being set to an intermediate value so only those connections above the threshold value are shown.

In FIG. 8H indirect connections are shown with the connection opacity being reduced to allow a greater number of connections to be visualized with the opacity of the connections being reduced to allow multiple connections to be more easily seen. In the example of FIG. 8I, the connection cut-off slider 834 is increased to the maximum value so that only connections for relatedness coefficients of 1 are shown. Finally, in the example of FIG. 8J, only indirect connections are shown with the connection cut-off slider 834 being used to filtering these based on the connection cut-off value.

It will be appreciated that by controlling the position of the sliders 833, 834, 837, 838, the user can therefore select the number of connections displayed, and the relative opacity of the connections, thereby allowing the relatedness of the first data sets to be more easily visualised.

A number of further features will now be described.

Throughout the above-described examples, animation has been described as being on a separate second representation. However, the second representation can alternatively be an animated version of the first representation. In this instance, the correlation can be performed over different time periods so that any two data sets can be related by multiple relationship coefficients, those coefficients being determined for corresponding time periods. Thus, a different relationship coefficient may be determined for each quarter of the year where the time intervals between successive variable measurements are of a lower value, such as weekly. In this instance, the animation can be an animated version of the first representation with the position of nodes changing depending on changes between relationship coefficients for the corresponding time periods.

In one example, datasets may be collected as part of a survey process. The survey process typically involves having individuals answer questionnaires regarding their day-today activities. This can include, for example, answering questions such as their location at a particular time of day (eg: work, home, car, bus, or the like), in addition to other more traditional information such as media consumption, product preferences, demographic information, employment information, or the like.

For example, the survey can include a first set of questions that relate to activities performed at certain times of the day. In this regard, the survey typically divides the day into a number of different time periods, such as 6:00-8:00 am, 8:00-9:00 am, 9:00-midday, etc, with the individual providing an indication of activities performed during these time periods. This provides significant information to the survey recipient regarding activities performed at particular times of the day.

Questions may also include details of travel, eating/drinking, shopping, entertainment and recreation, or the like. These will typically allow a individual to specify which forms of transport, which types of food and drink, types of shopping and entertainment have been participated in on given days.

Additionally, the individuals can provide information regarding media consumption, and in particular, which media they consumed on which days of the week. So for example, this could indicate that the individual watches television on a Monday, but reads the newspaper on Wednesday.

The individual can also be asked to provide additional information regarding brands and advertising, for example, when the time series data is to be used in an advertising context. This will include, for example, times of the day at which the individual is open or not open to advertising, the types of advertising they tend to view, brands that they use or like, brands that they do not use or don't like.

In addition to this, the survey will typically include demographic information including information such as the individual's age range, marital status, number of children, employment status, earnings, number of hours consuming media or the like.

By providing specific information regarding their location at particular times of the day, this can significantly assist in the market research process. Thus, for example, this can be used to determine the number of 30 year old males commuting by bus between 8:00 and 9:00 o′clock in the morning. In conjunction with knowledge of their media consumption patterns, this will allow market research to assess whether it is worth advertising via a certain medium to this demographic of users on buses.

Whilst one-off surveys themselves do not represent time series data, the survey can be repeated a number of times allowing time series data to be collated. Accordingly, this time series data will not only show a snapshot of activities but also how these vary over time. For example, this may highlight that the number of 30 year old males commuting by bus is greater in the winter than in the summer, in which case a company can use this information to time their adverts appropriately.

Accordingly, thus, by repeatedly collecting survey data relating to daily activities, this can allow time series data relating to an individual's activities to be collected, and then analysed as part of the above described process.

The time series data can also be broken down by attributes such as location. Thus, for example, product sales information may be available for a number of different locations. By comparing the data for each of the locations to other time series data, this can allow trends to be discerned. For example, this may demonstrate that there is a high degree of correlation between the degree of TV advertising for a product and sales in a given area, allowing marketing to be targeted more effectively for that particular area.

It is also possible to use time series data relating to events. In this example, the time series data can include an indication of a time interval during which an event occurs. This can include one-off events but also repeated events, such as a number of sporting games over a season. As an example, a company could examine whether there is any correlation between home games for a local team and certain product sales, again allowing marketing to be targeted more effectively.

Events typically occur on a one-off basis and cannot therefore in their native form be treated as time series data.

In order to accommodate this, events may be displayed as a list, allowing users to select respective events for display. In this instance, the events can be presented on the animated representations as discrete incidents at an appropriate time. Thus, if for example, if a user is viewing the second representation, the point of time at which an event occurs can be displayed, allowing this user to visualise the impact this event might have on the time series data currently being reviewed.

In the event that an impact occurs, this can be investigated in further detail. For example, a user can select an event with the date on which this occurred being used to segment time series data. Separate relationship coefficients can then be determined both before and after the event to determine if the event has resulted in a change in the relationships between different data sets. This could be used to allow the impact of an event to be displayed on either of the first or second representations. Thus, for example, the first representation could show the degree of relatedness before the event occurred and the degree of relatedness after the event occurred.

As a further alternative, time series data can be generated for events. In particular, many events will tend to have a decreasing impact over time following the event. For example, when an event occurs, sales of products may initially drop, and then gradually return to pre-event levels. To accommodate this, the time series data can be generated by defining a variable value associated with the event, and then having this variable value decay over time to represent the decreasing impact of the event. This time series data can then be correlated with existing time series data as previously described allowing, for example, a decrease in product sales to be correlated with specific one off events.

A further way in which the time series data can be analysed to determine relationship to one off events is to analyse the time series data to look for a major change in variable value. Thus, if the time series data shows a change between successive variable values that is greater than a normal degree of variation, this can be detected for example by calculating a standard deviation for the data and then comparing the change between successive variable values to the standard deviation. This can be used to identify time intervals during which major changes occur. Event data can then be reviewed to identify any event occurring during that time period, thereby identifying to users potential events that may have led to the change.

Accordingly, this provides mechanisms for allowing users to compare time series data to discrete and in particular one of events, to determine which of these may have had an impact on particular data sets of interest.

As an example, a user in reviewing product sales, may identify that sales dipped dramatically during a particular sales period. Analysing the data and comparing this to events can allow the user to identify a potential cause, such as exclusion of the product from a particular point of sale, and then assess the impact of this on ongoing sales. This can allow users to identify events that are critical to product sales.

It will be appreciated that when time series data is supplied to the system, existing relationships between different sets of time series data may already exist. In this example, an indication of these relationships can be stored together with the data sets themselves. Thus, for example, the relationships between time series data may be provided in a tree structure with total product sales at a highest level, and product sales for a given area at lower levels in a hierarchy. In this case, the relationships can be used in selecting data sets for visualization. Thus, for example, if a user selects a parent data set all child data sets may be automatically included or excluded depending on user settings. This can assist a user in selecting relevant data for inclusion in the data analysis process.

Additionally, the system can have the ability to learn about relationships, for example based on the results of previous data analysis. For example, if a user selects second data sets as part of a group, this can be used by the processing system 210 as an indication of a potential relationship between these data sets. When the user subsequently chooses to analyse one of these data sets in future, the processing system 210 can automatically select other ones of the data sets, based on previous potential relationships. This is particularly important when different users analyse common data sets, as a first user may identify a relationship that is not spotted by a second user. However, by having the system automatically flag potential relationships, this can be used to alert the second user to the relationship, thereby preventing the user from missing the relationship during subsequent analysis.

Whilst this can be performed solely on an automated basis, additionally, and or alternatively, the users can flag relationships of interest, with details of this being automatically stored as part of the relationship tree, so such relationships can be rapidly and easily identified in future.

The first and second representations can include indicators, such as labels, associated with the nodes and/or connectors. For example, the indicator can be indicative of an identity of the relevant data set, a variable name or the like. In addition to this, the indicators can be representative of variable values, or, in the case of node connections, the relationship coefficient.

As the first representation particularly tends to have a large number of nodes and node connections, the user can select to filter the nodes and connections displayed, as well as whether indicators should be displayed. This can be done by adjusting appropriate parameters relating to the first representation. In addition to this, the user can also selectively adjust the opacity of the nodes and/or node connections allowing the visualization to be more easily viewed.

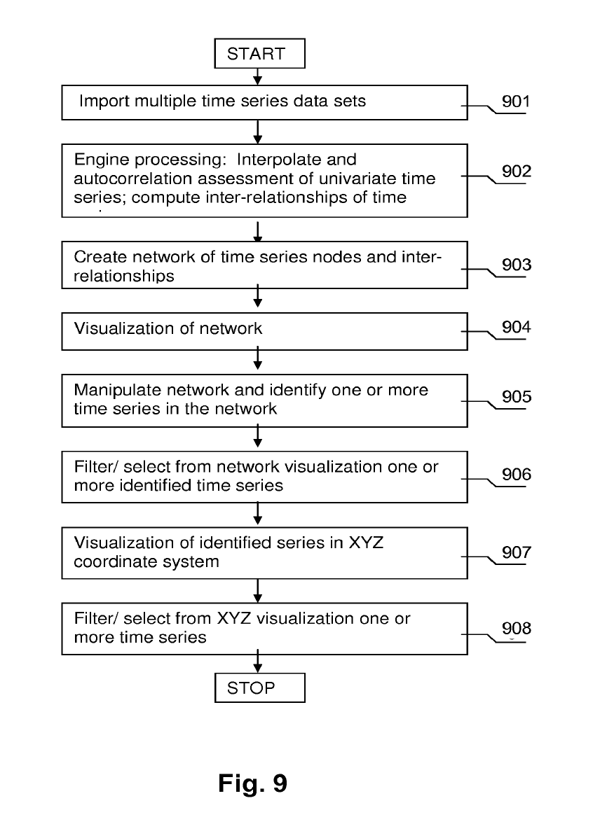

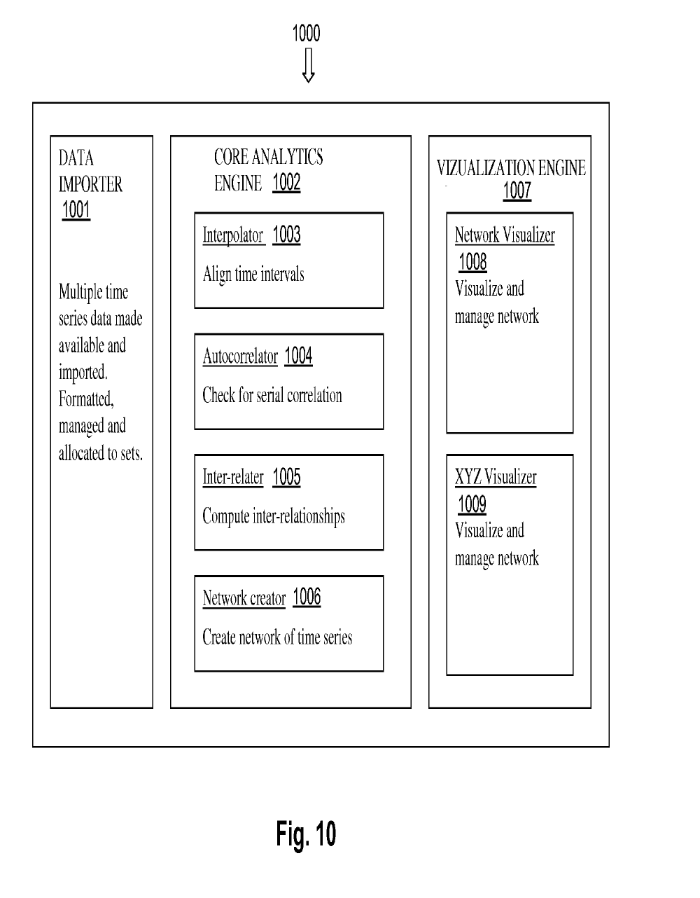

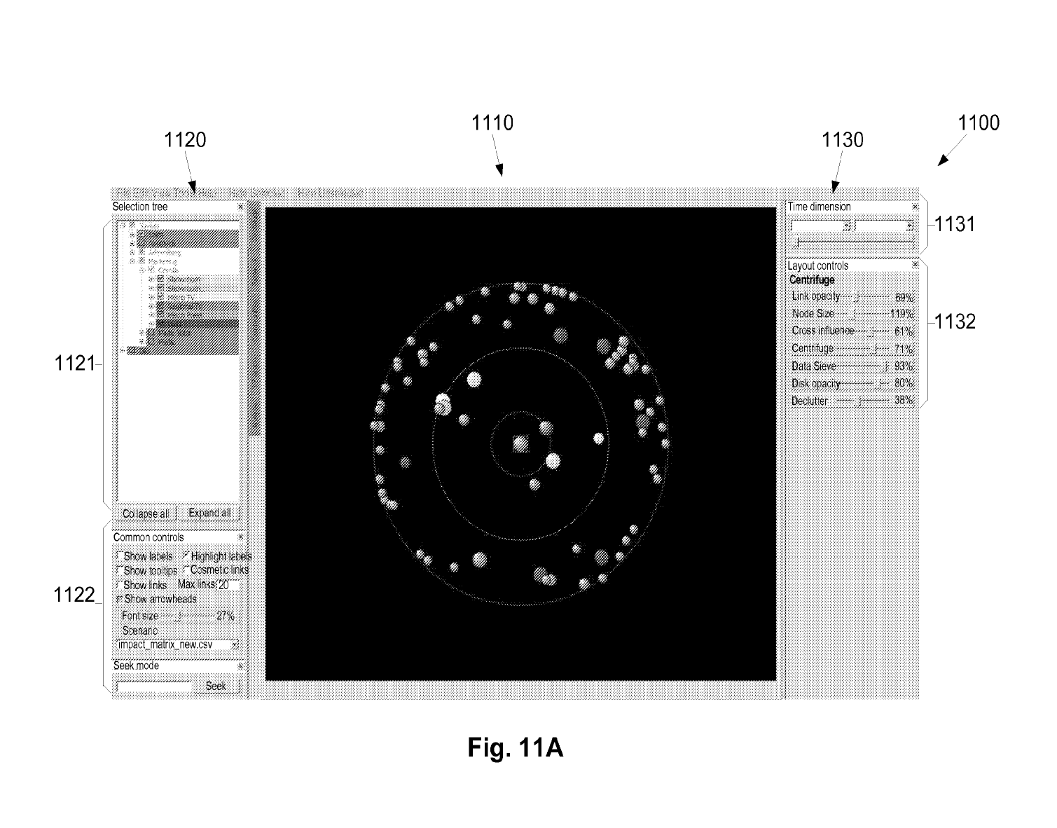

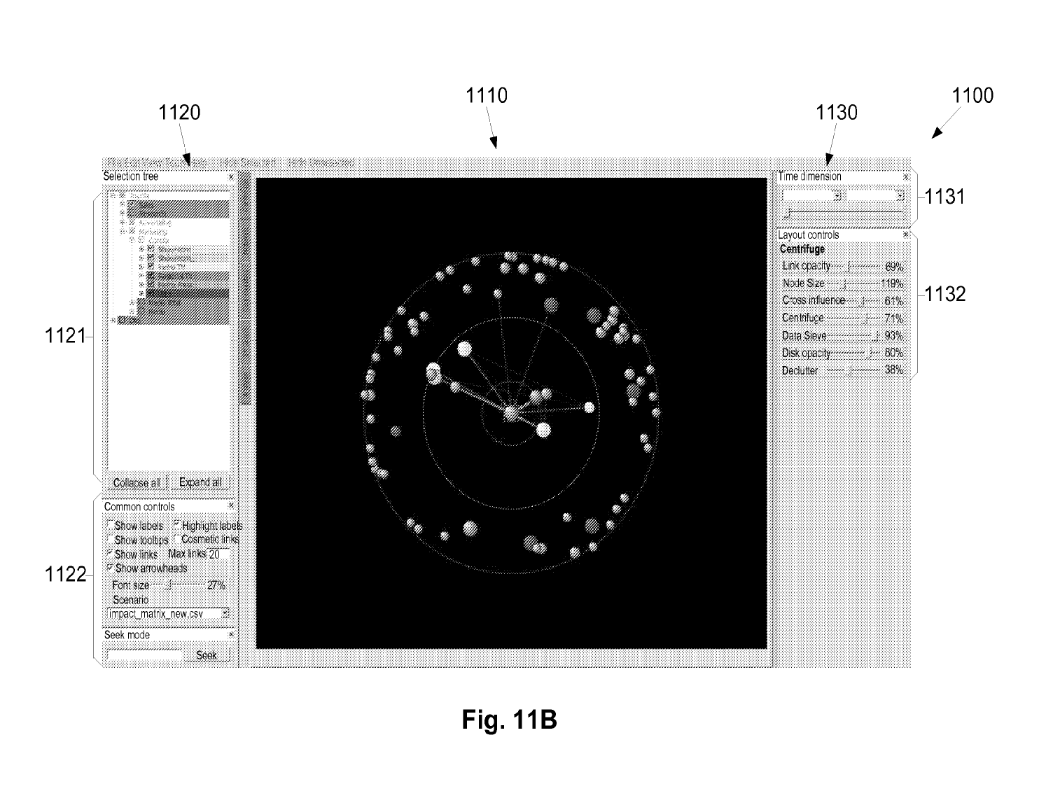

A specific example of a process for analysing time series data will now be described with reference to FIGS. 9 and 10, which show the steps performed to implement the process, and a specific configuration for a processing system 1000.

In this example, at step 901, customer time series data, or prospect time series data, is made available to the processing system 1000. The time series data, which is provided to a data importer module 1001, includes a number of over-time values recorded on a regular basis for each of a large numbers of variables. This can include, for example, sales of product X recorded by a business on a regular basis, say monthly. Another example is a cost of living index recorded and calculated say quarterly. The data importer module 1001 imports the data at step 901 from one or more sources, then formats and manages the data making it accessible for subsequent processing.

At step 902, a core analytics engine 1002 processes data from the data importer 1001 and passes results to a visualization engine 1007. The core analytics engine 1002 includes an interpolator 1003, which acts to interpolate variable values based on user defined parameters so that the time series data sets have common preferred and optionally aligned time intervals. The core analytics engine 1002 also includes an autocorrelator 1004, which determines the extent of relatedness for each univariate time series, one at a time, for example by performing an autocorrelation technique. The autocorrelator 1004 also functions to ensure that the extent of serial correlation is acceptable for each data series. An inter-relator 1005 computes the inter-relationships between different time series with room to vary any particular statistical computation method.

At step 903, a network creator 1006 takes the inter-relationships from the inter-relator 1005 and uses them to create a network of times series data, with nodes in the network representing the time series variables and the connections representing the relationships between the nodes.

At step 904, the network form is visualized by the visualization engine 1007 to create the first representation. In particular, at step 905, a network visualizer 1008 of the visualization engine 1007 enables the network to be visualized by causing the visualisation to be displayed. It also provides the operator with management capabilities of the network, its layout and representation, thereby enabling the operator to identify one or more time series in the network, and manipulate the view of the network.

At step 906, the one or more time series identified at step 905 may have further time series added should the operator deem the inter-relationships are warranted by filtering and selecting related time series nodes.

At step 907, the identified one or more time series from step 6 are passed to an XYZ visualizer 1009, which enables the operator to visualize the selected time series in an XYZ coordinates system which has axes in an X dimension, a Y dimension and a Z dimension, the latter referring to the size of nodes. The XYZ visualizer 1009 enables the operator to examine patterns of trend synchronicity in the series when viewed as progressive time intervals over the course of the chosen time series. The XYZ visualizer 1009 makes it possible for serendipitous patterns to be discovered by an operator that were previously unknown or not considered.

At step 908, the operator may choose to select a particular one or more time series for more detailed consideration using other techniques.

In functional terms the above described process can therefore:
take in time series data variables from multiple sources
account for/interface with periodic updates/refreshes
manage equivalencing or estimation of disparate time intervals in the data (weekly,
monthly etc.), called “interpolation”
provide a correlator function to enable pairwise cross correlations and, subject to
expert and customer feedback, explore and incorporate different forms of statistical
calculations and values
in a first representation
   display a network of correlated variables with connection strengths
   each node can be clickable to reveal attribute underlying data in summary form
   size the display of each variable in the network by “recent” variance in values
   have a “target” for centering variables such that all the others on screen move and re-align for the centering of the selected variables
   enable user selectable filters for variables or categories—a tree structure similar to windows explorer
   graphic display features along with zoom and pan type functionality
   enable user controlled addition or fading of network connectionage between the variables
   enable “bread crumbs” or “back” function so that one can trace steps taken to how they arrived at a current position
   enable a lasso or similar function for selecting variables to then be displayed in XY
in a second representation
   display selected filtered variables on x and y axes
   display variables in the z dimension as different sizes of circles and different colours, user chosen
   have user selection of logarithmic or non-log scales
   clickable bubbles to a) split into lower categories (e.g. a national variable split into the states and territories) and b) reveal details about the variable (similar to this function in the first representation)
   mouse-over to display names in larger lettering. Also double-click (or alternative) to enable the name to stay enlarged when that bubble moves
   function to visually see the trail of movements of one or more variables over time rather than just the bubble alone at successive times
   enable a nominal or “event” variable to be shown (at the top or side of main display) at a particular time of occurrence of the event (e.g. the Grand Prix in Melbourne or when the sugar cane harvest payments occur, etc)

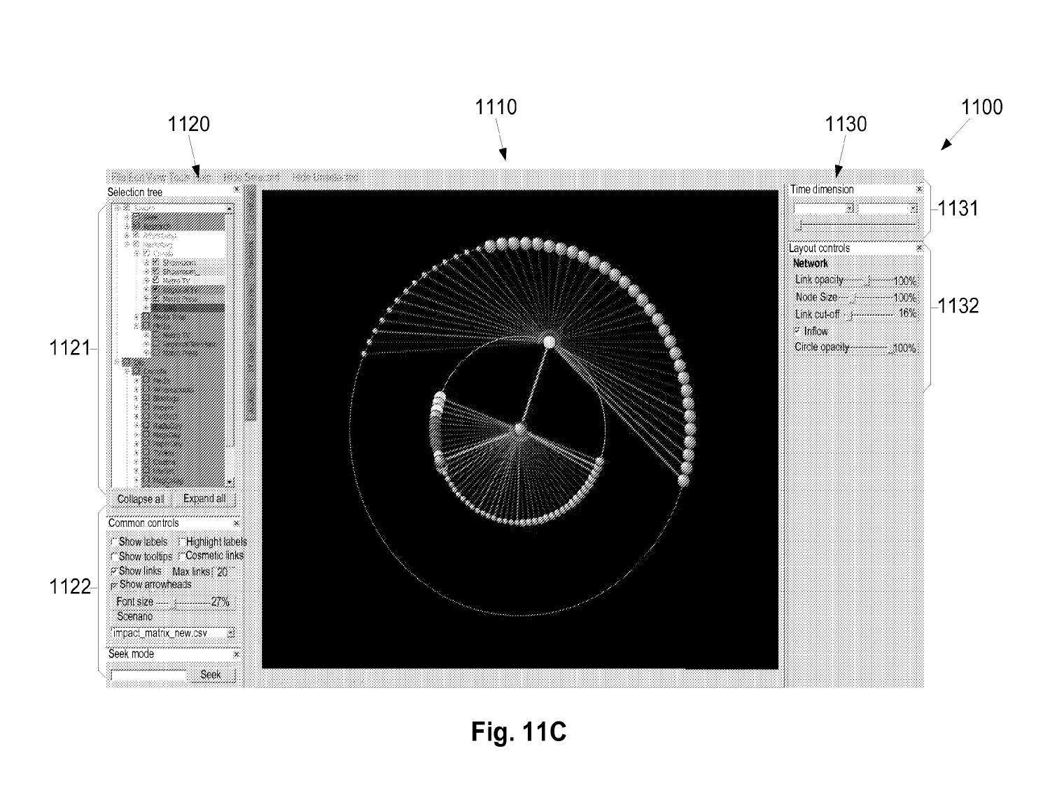

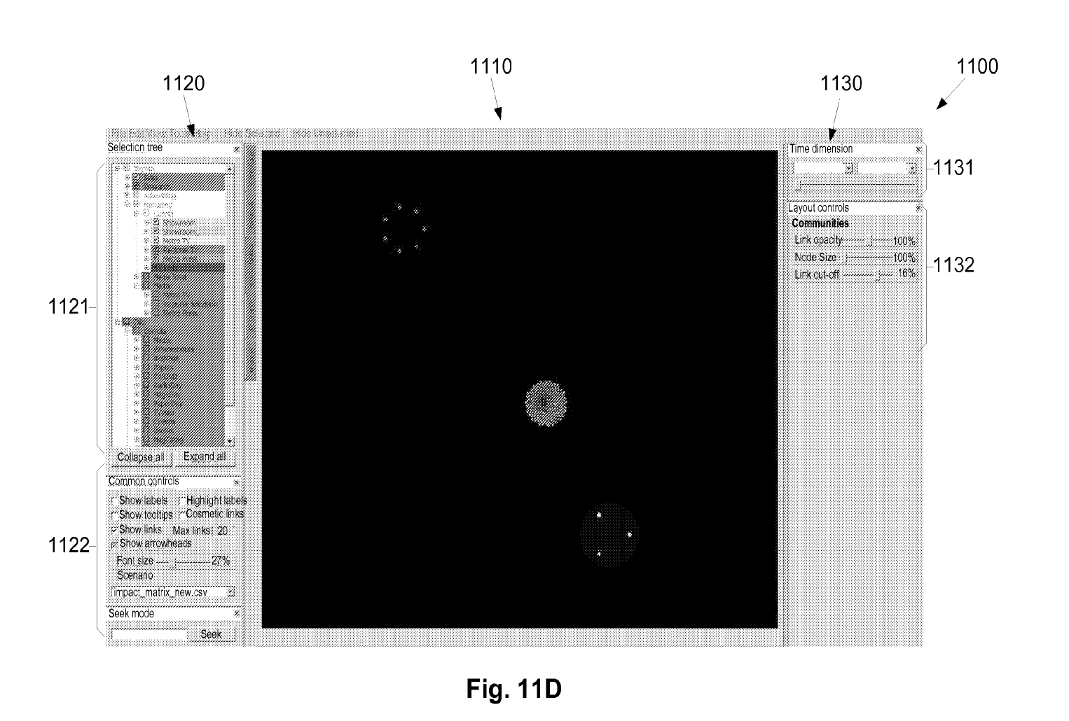

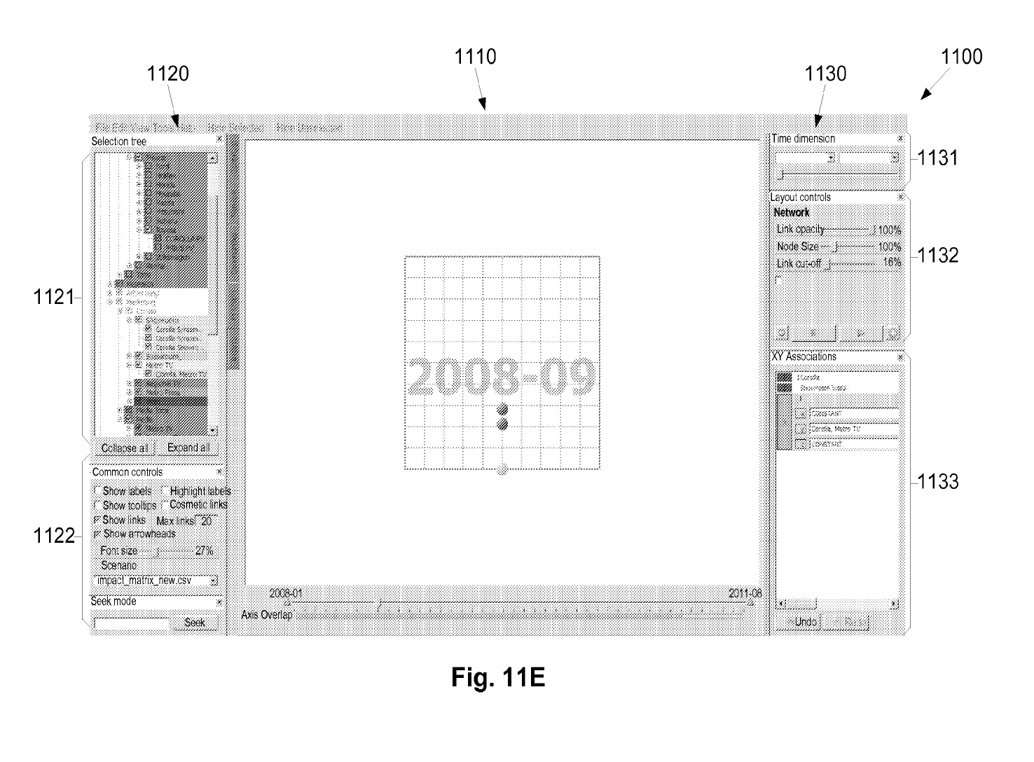

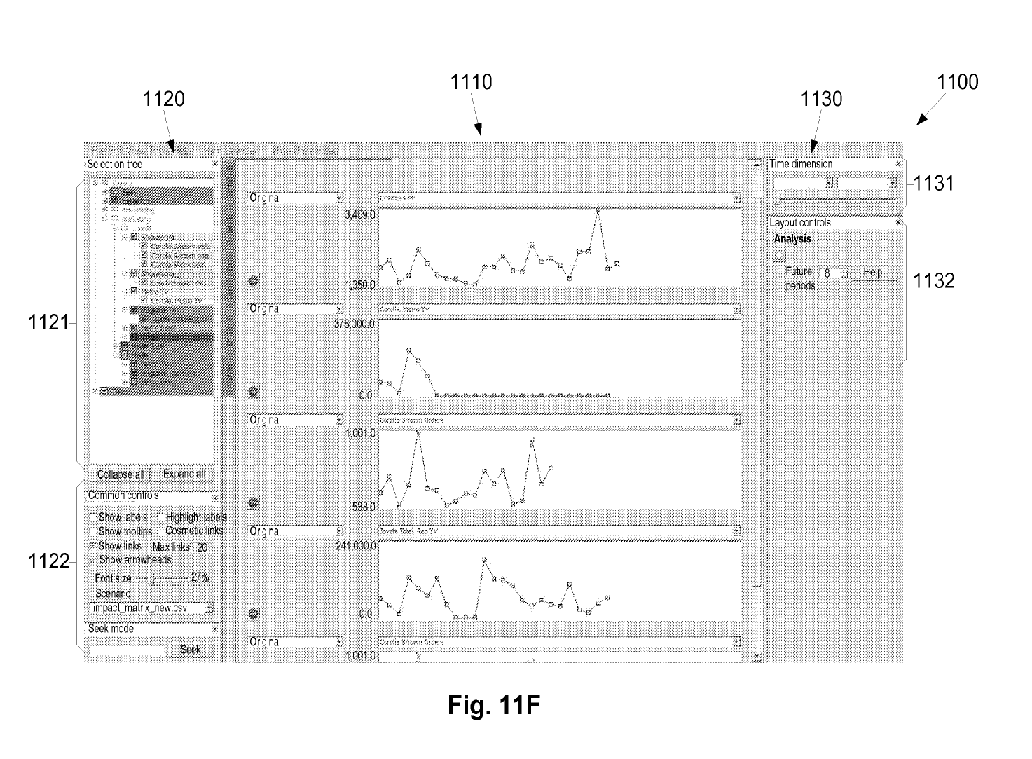

It will be appreciated that a variety of different representations can also be provided in order to further assist with the interpretation of data, and examples of these will now be described with reference to FIGS. 11A-11F.

In these examples, a user interface 1100 is displayed including a representation window 1110, and first and second control windows 1120, 1130. The representation window 1110 includes tabs 1111 for allowing different representations to be displayed in the representation window 1110.

The first control window 1120, includes a data tree representation 1121, allowing a user to select data for display, and a number of check boxes 1122, which allow a user to determine what should be displayed on the representation, including indications of nodes, connections or labels.

In the current examples, the data is selected for display on the representations using a tick box system. The data can be from one or more different sources and can be stored in a database either locally, or remotely, for example in a cloud based storage system. The data to be selected is typically laid out as a tree structure. In one particular example, the data structure can be based on metadata, or the like, associated with the original data, meaning an organisations own internal data structure can be reflected, allowing relevant data to be easily selected.

The second control window 1130 includes time series controls 1131, for controlling the time periods displayed for data shown in the representation, as well as a number of sliders 1132 allowing relevant display parameters to be controlled. These parameters can include connection opacity, node size, cross influence, a data sieve, disk opacity and decluttering. Additional display controls 1133 may also be provided. The actual controls displayed will depend on the nature of the representation shown in the representation window 1110, as will be apparent from the description below.

The manner in which the representations are displayed and controlled is substantially similar to that described above. Accordingly, the implementing software analyses time series data and displays representations of the in the form of nodes and connections, allowing users to manipulate the data and therefore ascertain underlying patterns within the data. This process will not therefore be described in any further detail.

In the above example, the interface includes three windows, with a representation window 1110 being displayed centrally and flanked by the first and second control windows 1120, 1130. In this example, the first control window 1120, situated to the left of the representation window 1110, allows what data and associated information is displayed on the representation to be selected. The first control window 1120, situated to the left of the representation window 1110, allows what data and associated information is displayed on the representation to be selected. The second control window 1130, situated to the right of the representation window 1110, allows display parameters to be selected. The layout of user interface 1100 is therefore simple making it easy enough for a non statistical/IT person to use via a browser, accessing their own and other data.

The user interface can be used to display a variety of different representations and examples of these, will now be described with reference to FIGS. 11A to 11F.

In the examples of FIGS. 8A and 8B, a representation known as “centrifuge” is shown. In these examples, nodes representing selected time series data are displayed radially outwardly of a selected central node representing data of interest. The closer the nodes are to the central node, the relatedness of the data sets, and hence the relative impact they are having on each other over the time period selected.

By way of example, a user would usually select say a hard measurement (eg sales) and look for the effect some of their marketing initiatives may have on it. The further away, the less effective their Return on Investment. Another example may be to see trends in the sharemarket, so for example if interest rates are selected as the central node, those other nodes closer to it are an indication of the strength of the effect the interest rate is having on them.

As in previous examples, the user can use input commands, such as a double click on any data node to make it the new centre node. Control inputs can also be used for fine tuning the displayed representation, including altering the relative radial spacing of the data, to isolate only the top influencing factors, or providing more granularity. In the example of FIG. 8A, the connections are not shown, but this is not essential, as shown in FIG. 8B.

It will therefore be appreciated that this is substantially similar to the first representation described above.

In the example of FIG. 11C, a representation known as “network” is shown, which again shows nodes representing selected time series data displayed relative to a selected central node representing data of interest. In this example, the representation illustrates the effects nodes have on others nodes in a knock-on way, relative to the selected central node. This therefore represents cause and effect between the nodes. The cause and effect may be determined in a variety of ways, depending for example on the nature of the data, and information, such as metadata associated with the data. For example, this could be based on cause and effect defined within the data, may be determined depending on results of the relatedness analysis, based on the nature of the data, or on predetermined rules.

In the example of FIG. 11D, a representation known as “communities” is shown. The communities representation is indicative of clustered pools of data, separated into statistically valid groups, shown as individual networks. This allows users to navigate between groups of data, as well as to determine relationships between data in different groups.

This in turn allows organisations to use not only their own internal data, but also external data, such as data from other organisations, generic data such as economic indicators, weather, events, such as earthquakes, floods, elections and the like. In a further example, this can be used to examine survey data regarding people's day-to-day activities, such as demographics, whereabouts (time of day, day of week, week of year . . . at the pub, the beach, at home, school, work , supermarket etc), media consumption (holistically, so traditional TV (by shows), radio station, mag, papers, outdoor, cinema, search etc, but also social, twitter, blogging), and brand information regarding brands consumed, such as what consumer products they purchase, sports teams they support, or the like.

By easily examining relationships between different groups of data, users can more easily ascertain data sets in other groups of data that are related to data sets in their own group. This allows data from various different sources to be analysed more easily, as previously described.

Thus, this allows companies to relate their data to customers by who they are, where they live, their attitudes, their behaviours, all consumption habits, and help create newly defined segments of the population for marketing purposes.

In the example of FIG. 11E, an XY Graph similar to the second representation described above is shown.

This provides a dimensional visualisation of data and how relatedness of different nodes changes over time. This can be used to visualise case and effect over time in a free flowing animation, showing how relationships change based on changes in the appearance of nodes, such as how the nodes move, grow or shrink. In one example, the user selects from the display controls 1133 how many nodes are to be displayed, with each node being associated with up to three respective data sets, selected using a drop down menu. In this example, three dimensions in the form of the X horizontal axis, the Y vertical axis, and a size of the nodes. Animation of the display can then be performed as previously described.

In the example of FIG. 11F, analysis graphs are shown for forecasting purposes.

In this example, the representation window displays a number of graphs representing historical data from selected data sets. The user can then select a future time period, and use the graphs to predict the influence of the different data sets on each other. This is based on projections, and allows a user to alter different variables to predict the impact of this on different data sets.

For example, a user could chose sales in the top graph, then added four more below it, such as (Advertising for Television, Newspapers, Internet and Trade Promotions), based on historical data. In this example, as the user slides manipulates the data, the processing system will predict the influence on the other data sets, using information regarding the degree of relatedness. Additionally, tabs on the graphs allow for data to be viewed as Original, Average, Trend, Elasticity or for users to enter their own Rule-Based predictive formula.

Examples of the types of time series data that can be used in the system include company information, such as variables about sales, online and offline inquiries, and a wide number and variety of marketing and financial information such as ad-spend on certain products, product types and models, competitor price movements, or the like. However, in addition to this, the time series data can include numerous non-corporate or ‘external’ variables, such as demographic information including population information, employment figures or the like, event data, for example relating to sporting events, census data, survey information or the like. However, it will be appreciated that this is not intended to be limiting and any appropriate information can be used.

It will be appreciated from the above, that multiple time series variables are often difficult to comprehend, i.e. in terms of which “goes with” which over time. Sales go up seemingly when the competitor's price goes up—maybe. These are things good managers sense and “know”, but this is often based on an informed and experienced guess, rather than through rigorous data analysis. However, as the market place becomes increasingly competitive, analysis of data becomes more and more important, with stakeholders requiring that management make data-informed decisions.

From a graphical perspective, traditional ways of viewing times series employ a line chart. Such charts typically have a volume or monetary metric on the vertical (y) axis, with time shown across the horizontal or x axis. It is common to see 3, 4 or 5 variables displayed comparatively over time. However, this only allows for a limited understanding, and it is rare that more variables are ever considered in combination as existing visualization techniques are simply too confusing. Yet it could be that sales of X are related to something else simply not known about or not thought of before—each of which such insights represents an opportunity for marketing, resourcing or cooperative engagement of some sort, previously not understood and therefore not leveraged to benefit company profits.

By enabling senior executives to empirically underpin their “gut feelings” and be able to communicate that to others in a data supported way, better quality decisions will result and fewer false or misguided avenues travelled. The company will benefit in tangible ways and very often through improved top level strategic decisions.

Thus, by enabling a user to view a visualisation of how the data sets may be related, this allows users to use their own historical knowledge and background about their business to interpret the meaning of any relationships. The visualisation therefore provides a mechanism to draw on this knowledge/history to discover insights of how variables relate to other variables in ways simply not possible any other way. Observations of variables seen to move in similar ways over time sometimes will be coincidental, however on other occasions such observations will be highly revealing and serve as input to management decision making.

The above described process can therefore deliver insights not previously possible for a business. Whilst the process does not make specific recommendations about actions or decisions, it does greatly facilitate users' ability to understand their business. In particular, users can view their own data and externally sourced data in ways not previously possible and particularly over time movements in values of those variables, allowing them to derive insights to inform improved decision making for corporate betterment.

Whilst the above described examples have focused on the analysis of time series data for the purpose of market research, this is not essential, and the system can be used in analysis any form of time series data to allow relationships to be ascertained and understood.

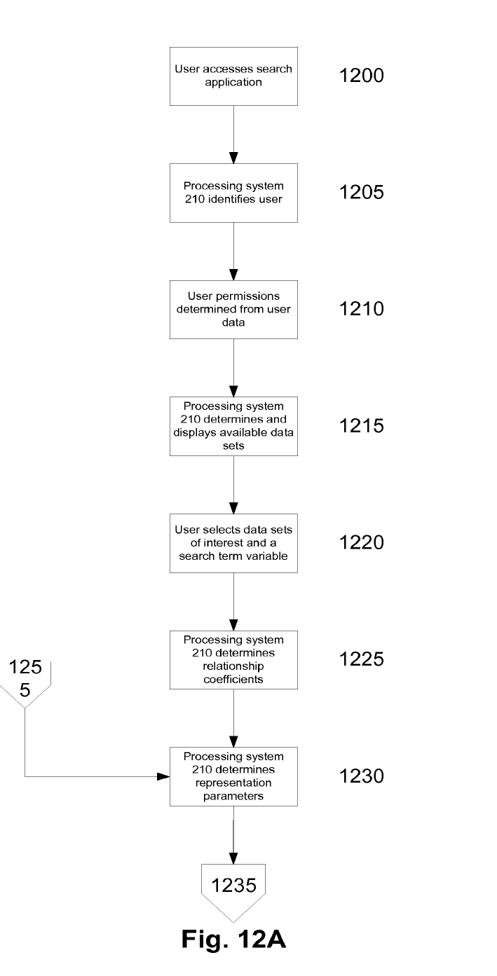

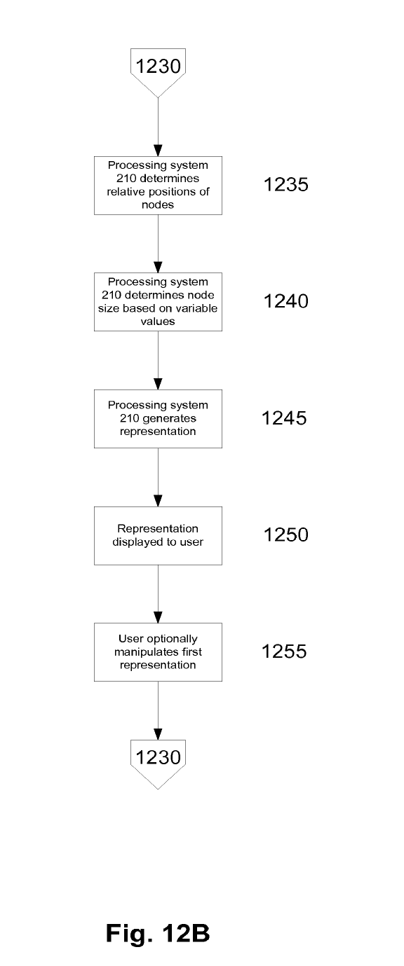

An example process for performing a search will now be described with reference to FIGS. 12A and 12B. Again, it is assumed that this uses the process of FIG. 5 to configure data for use.

In this example, at step 1200, a user accesses a search application implemented by the processing system 210, with the processing system 210 identifying the user at step 1205. The identification process is typically used to ensure that a user has permission to access the data sets stored in the database 211, and may be performed in any appropriate manner. In one particular example, this is achieved by having the user provide authentication information, such as a username and password, or the like, which the processing system 210 compares to previously determined and stored authentication information, which is typically created during a registration process. Such processes are known in the art and will not therefore be described in any further detail.

At step 1210 the processing system 210 accesses user permissions associated with the user, typically based on the identity of the user. The user permissions may be stored as part of user data associated with the user, and typically specify any relevant permissions associated with the user. Thus, for example, the permissions may indicate that the user is able to access only limited data provided by their employer, depending for example on their position within the organisation.

Thus, typically a user is able to access from their own company, along with other data. This can include a “library” of public and other companies' private data that the user has permission to access, such as GDP, cost of living indices, commodity prices, weather, stock movements and foreign exchange trading data. Other data sets may also include, and be selectable from proprietary survey research data segmented by demographic, geographic, respondents' brand and media consumption and usage habits.

At step 1215, the processing system 210 determines and displays details of available data sets, thereby allowing the user to select data sets of interest, as well as to select a variable for use as the search term, at step 1220. The selected data sets and the selected search term variable are used as a basis for creating the representation, as will be apparent from the following description. The selected data sets can include all available data sets, but more typically are a subset of all available data sets, which the user believes may be of interest.

It will be appreciated by a person skilled in the art that the data sets can be displayed in any appropriate way and this can include, for example, providing a list of available data sets via a user interface. Additionally, and/or alternatively, data sets can be provided in different categories allowing users to search via a combination of category and/or keyword searching to allow particular data sets of interest to be selected. The data sets will also typically be filtered based on the user permissions associated with the user and based on the access permissions of the data set. Accordingly, in one example, the user is only presented with details of the data sets they are able to use in the analysis process.

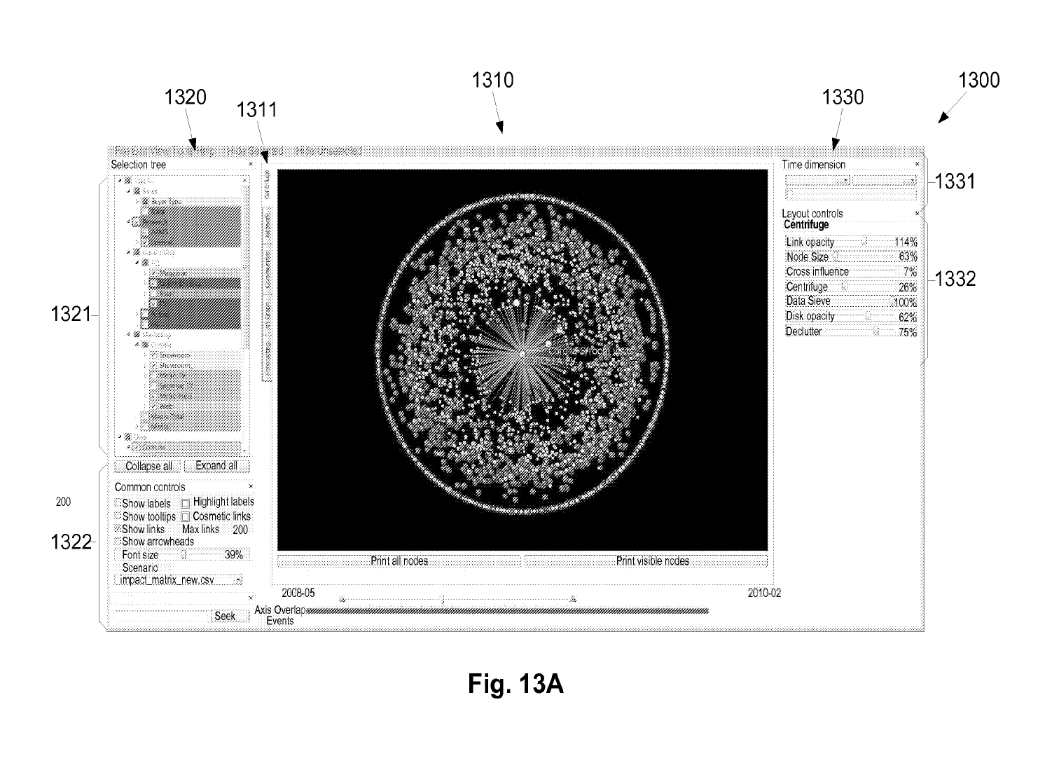

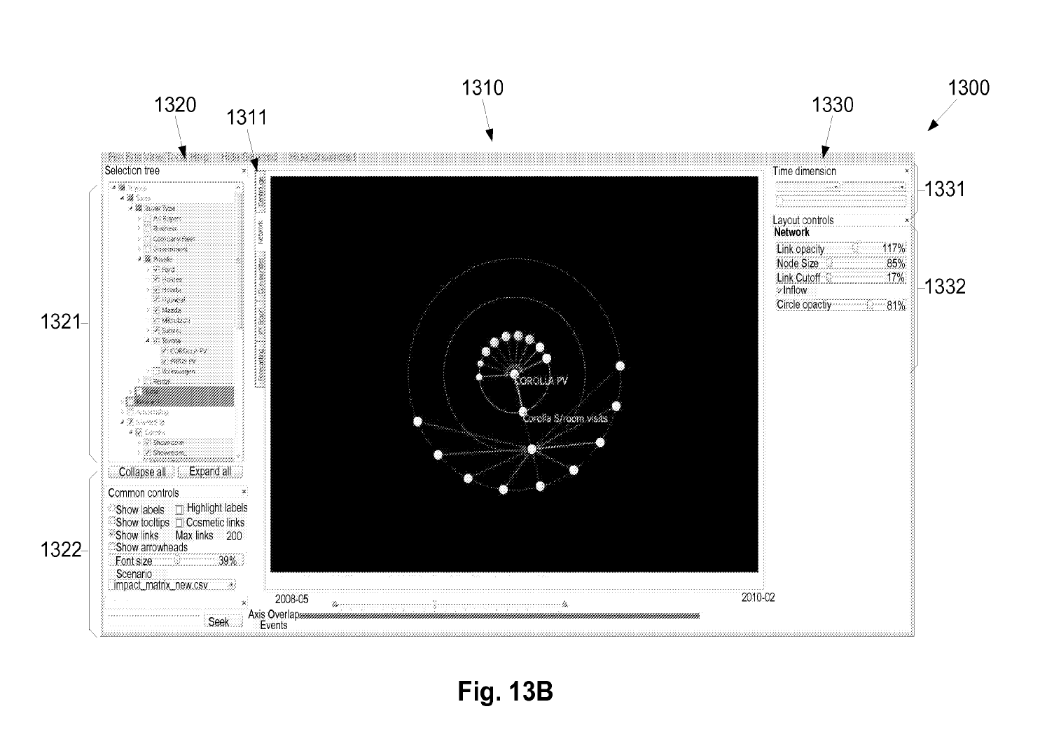

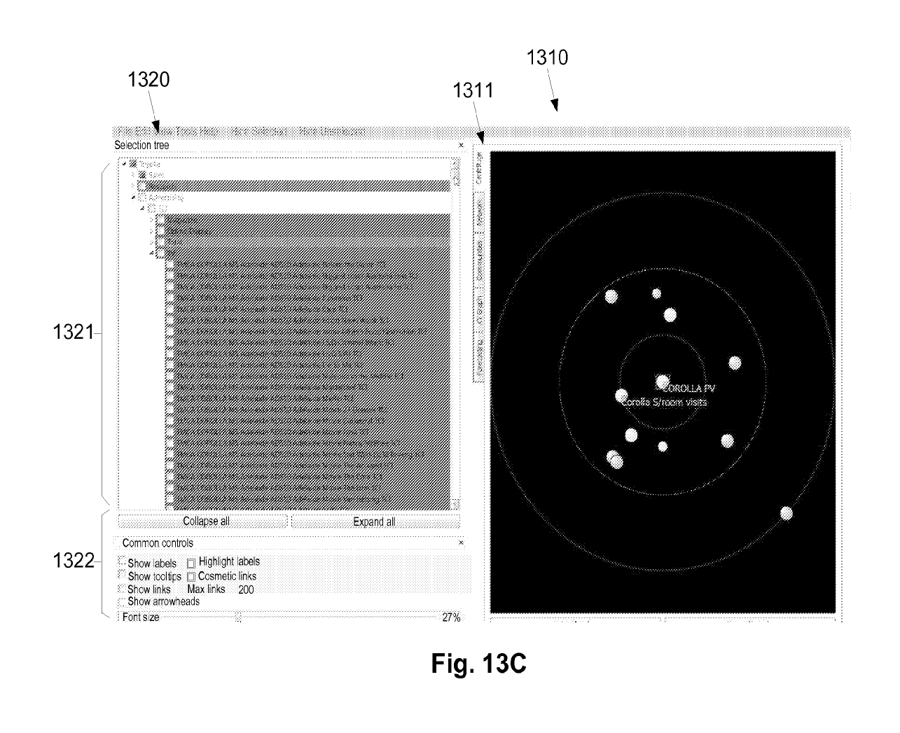

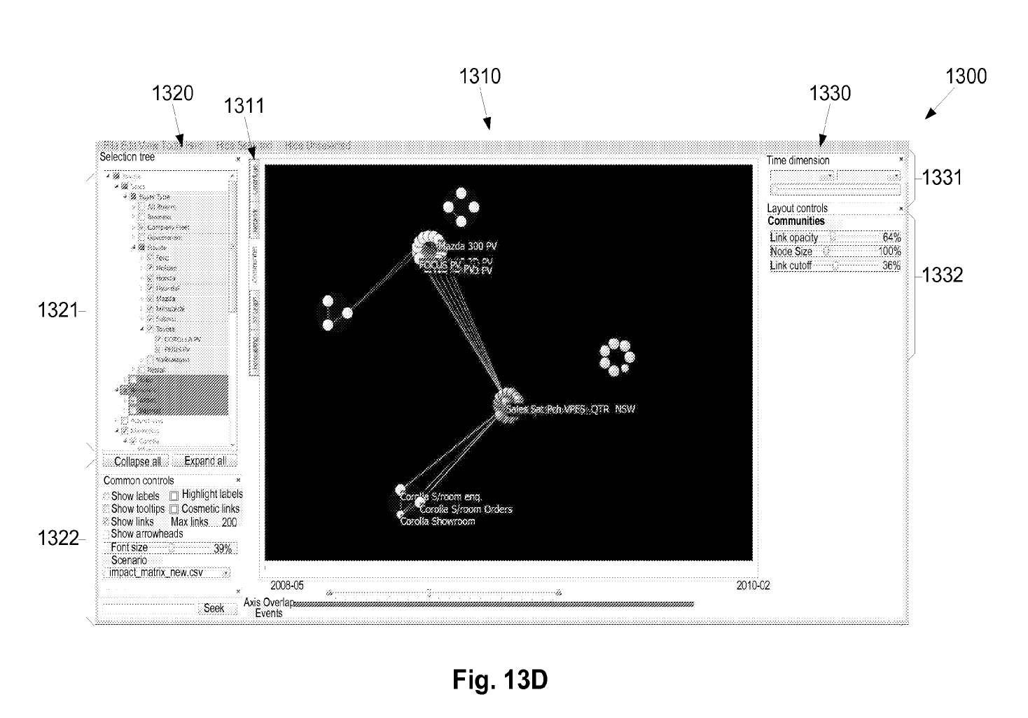

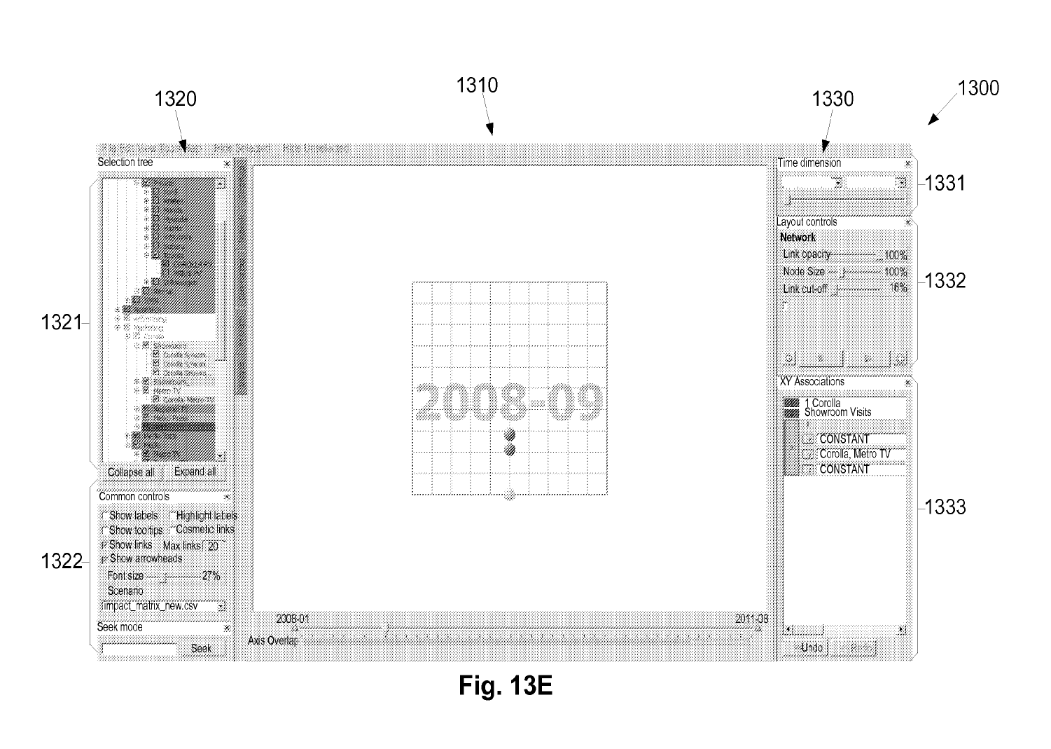

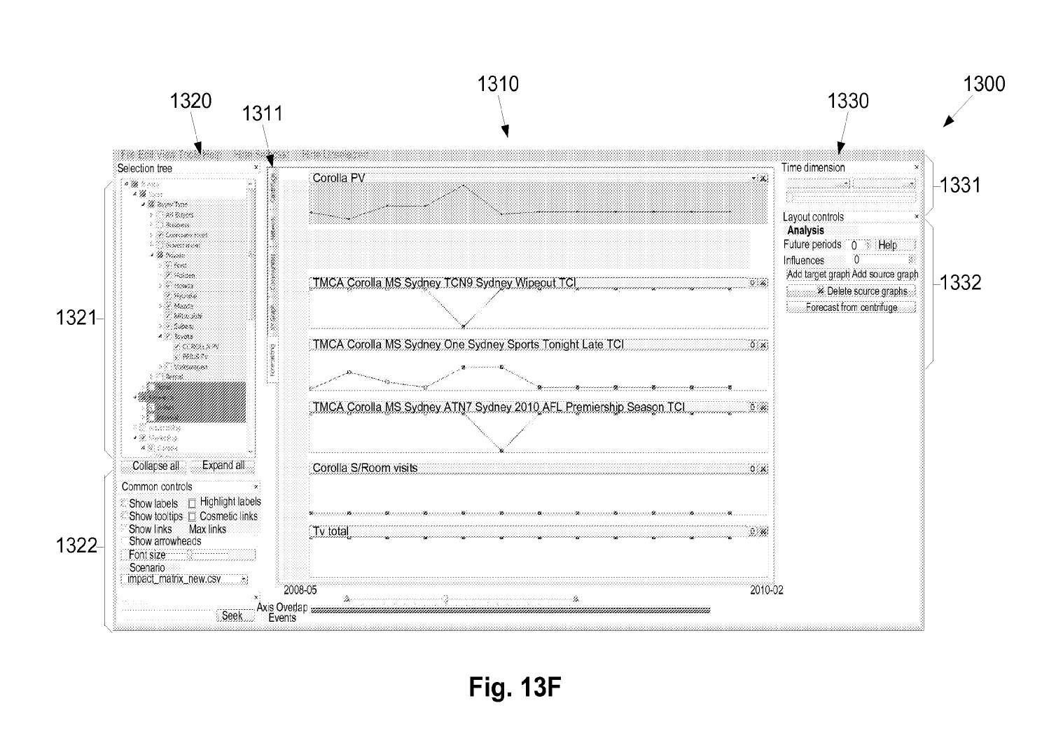

In one example, the data sets are selected using a suitable graphical user interface, and an example of this will now be described with reference to FIG. 13A. For the purpose of this example, the data shown is artificial, but uses the names of various Toyota™ motor vehicles products, used with permission, for the purpose of illustration.

In this example, the user interface 1300 includes a representation window 1310, and first and second control windows 1320, 1330. The representation window 1310 includes tabs 1311 for allowing different representations to be displayed in the representation window 1310. A number of different representations may be provided, commonly referred to as “centrifuge”, “network”, “communities”, “XY graph” and “forecasting”, and details of these will be described further below. Each representation can be used to display the same selected data sets, but each represents a different view and thereby enables different aspects of the variables and their relationships to be more fully understood to derive the answers the user is seeking.

The first control window 1320, includes a data tree representation 1321, allowing a user to select data for display, and a number of check boxes 1322, which allow a user to determine what should be displayed on the representation, including indications of nodes, connections or labels. The second control window 1330 includes time series controls 1331, for controlling the time periods displayed for data shown in the representation, as well as a number of sliders 1332 allowing relevant display parameters, such as connection opacity, node size, cross influence, a data sieve, disk opacity and decluttering, to be controlled. The actual controls displayed may also depend on the nature of the representation shown in the representation window 1310, so that only relevant controls are displayed.

Thus, in the current example, the interface includes three windows, with a representation window 1310 being displayed centrally and flanked by the first and second control windows 1320, 1330. In this example, the first control window 1320, situated to the left of the representation window 1310, allows what data and associated information is displayed on the representation to be selected. The second control window 1330, situated to the right of the representation window 1310, allows display parameters to be selected. The layout of user interface 1300 is therefore simple making it easy enough for a non statistical/IT person to use via a browser, accessing their own and other data sets.

In the current example, the data sets are selected for display on the representations using a tick box system. The data sets can be from one or more different sources and can be stored in a database either locally, or remotely, for example in a cloud based storage system. The data sets to be selected are typically laid out as a tree structure. In one particular example, the data structure can be based on metadata, or the like, associated with the original data, meaning an organisations own internal data structure can be reflected, allowing relevant data to be easily selected.

For the purpose of this example, the user is performing a search to determine cause and effect of factors influencing the number of Corolla car sales. To achieve this the user selects check boxes in the data tree for the data the user wants to examine, which may include many hundreds or thousands of variables that may impact the user's selected variable. In this example, the user has selected certain sales variables, advertising variables (as a targeted cost per thousand Index) and marketing variables for inclusion in the representation. The user also selects the Corolla PV variable to select this as the search term, for example by double-clicking on this variable. In one example, this results in the selected variable being centered on the representation, so that other variables which are related more and less strongly can be shown in greater or lesser proximity to the centered variable.

In any event, once the data sets have been selected in accordance with user input commands received via an input device, the processing system 210 determines the relationship coefficients between the search term variable and each other variable in the selected data sets. It will be appreciated that this may be achieved by retrieving the previously stored relationship coefficient, or by calculating new relationship coefficients as required.

At step 1230, the processing system 210 determines any representation parameters. The representation parameters are typically used to control how the representation is displayed, and can include for example, options regarding filtering of the number of connections or nodes which are shown, an opacity of nodes, a representation viewpoint or zoom levels, whether other information, such as node identifiers, are to be displayed, or the like.

The representation parameters are typically controlled by the user, allowing the user to manipulate the representation, as will be described in more detail below, but typically include initial default values which are used when the representation is initially displayed.

In one example, the representation parameters are determined using the controls 1322 as well as controls in the second control window 1330. Thus, this allows the user to choose selected time periods for display, along with display settings that effect the visualisations.

At step 1235, the processing system 210 determines the positions of the nodes within the representation, which will depend on the nature of the representation selected. For example, in the case of the “centrifuge” representation, the relative spatial positions of the nodes are based on the determined relationship coefficients, so that more highly related nodes are positioned closer to each other. The relative spatial positions can be determined using any suitable graph mapping technique that is capable of determining a relative spatial position, and this will not therefore be described in further detail.

At step 1240 the processing system 210 optionally determines a node size for each data set, based on the variable values. For example, each selected data set is represented by a respective node in the representation, with the size optionally being based on the variable values in some manner. Thus, the node size can be used to represent absolute variable values, such as an average variable value for the total time series data or over a predetermined time interval, or alternatively can represent changes in variable values, for example the degree to which the variable value has increased or decreased over the most recent time interval. However, this is not essential, and alternatively, the nodes may be displayed with a common size, or alternatively the node size can represent other information associated with the data set.

At step 1245 the processing system 210 generates the representation. In generating the representation, the processing system 210 will take into account the representation parameters, such as the currently selected viewpoint, zoom level, or the like, and then use this, together with the relative spatial positions of the nodes, to determine the appearance of the representation.

Thus, for example, the representation parameters will typically include a coefficient threshold, which is used to filter the number of node connections that are shown in the representation. Accordingly, the processing system 210 will compare the relationship coefficient for each pair of nodes to the coefficient threshold and then only display node connections between nodes when the corresponding relationship coefficient exceeds the coefficient threshold.

At step 1250, the representation is displayed to the user. Thus, it will be appreciated that if the user is using an end station 203, the representation may be generated by the processing system 210 and then transferred to the end station 203, as required.

In the example of FIG. 13A, the “centrifuge” representation is shown. In this example, nodes representing the selected data sets are displayed radially outwardly of a central node representing the search term variable. The closer the nodes are to the central node, the greater the relatedness of the data set variables, and hence the greater the relative impact they are having on each other over the time period selected.

In the current example, there are a large number of variables not related or only minimally related to the centered variable. A small number are however comparatively more strongly related than others to Corolla sales for the chosen time period. The name of one is shown to be Showroom visits (variable labels are under control of the user). This small set of variables are the ones most impactful on the selected variable of interest that corresponds to the search term, and therefore represent variables the user may typically want to investigate in more detail.

To achieve, at step 1255 the user optionally manipulates the representation. The nature of the manipulation will depend on the preferred implementation, but typically this can include altering representation parameters, such as a viewpoint, the presence or absence of indicators, zoom levels, or the like. Thus, the control inputs can be used for fine tuning the displayed representation, including altering the relative radial spacing of the data, to isolate only the top influencing factors, or providing more granularity.

The user can also adjust the search term, by selecting a variable of another data set, with the processing system 210 determining selection of the variable, and then moving a viewpoint so that the node representing the selected variable is displayed centrally in the representation. For example, the user can double click on any data node to make it the search term variable.

Alternatively, the user may select a different one of the available representation types, by selecting a different one of the tabs 1311.

During this process, if the user manipulates the representation, the process typically returns to step 1230 allowing the representation to be updated as required.

Manipulation of the representation is important to allow user visualisation of the degree of relatedness between the selected data sets. In particular, allowing the user to alter the viewpoint and adjust zoom levels allows the user to explore the relative degree of relatedness between the different selected data sets. This in turn allows users to identify clusters of data sets and their associated variables that are highly related and may therefore be of further interest. Thus, this allows the user to find out more about the relationships with the few most impactful variables and the knock-on effects that each may have.

In the current example, as shown in FIG. 13B, the user switches to the “network” screen, using the tabs 1311. This allows the user to look more closely at features of the variables and relationships. In this example the nodes again represent selected data sets displayed relative to a selected search term variable.

In addition to display of the nodes, information regarding causality between the nodes is shown by arrows, with the direction of causal inference being indicated by the use of arrowheads. For example, ‘Showroom visits’ is pointing in to Corolla sales, not the other way around, meaning the number of showroom visit influences the number of Corolla sales, and not vice versa. Other variables (not named in the figure) are also influential and pointing inward and thereby indicating the direction of cause and effect. If directionality is in both directions then the dominant direction is indicated by a single arrowhead.

In a further example, the arrows can also be coloured, with green arrows indicating a positive casual effect and red arrows indicating a negative causal effect on the variable to which the arrow points. Furthermore, by holding the computer mouse over the relationship between two variables (or ‘nodes’ in terms of it being in a network of variables), the type of relationship can be seen (regression or correlation) and the strength of it (e.g. a numerical coefficient). By clicking on a variable, profile information about the variable and data is made available to the user, e.g. the source and description of the underlying data.

Thus, the “network” tab enables the user to understand more closely not only the variables with most impact but the knock-on effects or indirect effects via other variables that may influence any particular variable of interest to a great or less extent, and thereby to consider corporate action to further the effects or else to counter them.

In the example of FIG. 13C, the data tree has been expanded to show additional granularity or specificity of data available to the user. In this case, should the user wish to know about the causative impact of advertising campaigns tied to specific television shows in a certain geography (e.g. Masterchef in Adelaide), they can select such from the data tree.

As the user selects or deselects data sets via the data tree, such as marketing spend by segment, the processing system 210 recalculates the relative spatial position of the nodes, allowing the user to see again which variables have had a greater or lesser impact. This interactivity is inherent in the system and an important part of its operational value. Senior executives, time poor and non-technical and non-statistical need immediate answers to questions that impact the bottom line of these operations, not days, weeks or months. The existing state of the art is often for cause and effect questions to be answered by the use of analytical tools (e.g. computer packaged statistical software) by one or more analysts reporting back their results to the originator days, weeks or months after the question was asked.

Thus, as distinct from traditional search methodologies, such as Google™, Bing™, or Yahoo™, the search works in a unique way, not only with respect to cause and effect, but by making it possible for the user to increase or decrease the number of data sets that are examined. Thus, rather than an unknown and virtually limitless amount of data to be searched as in traditional search, the above search allows the user interact with known data sets and immediately turn those on or off to suit the nature of their inquiry.

In the example of FIG. 13D, a representation known as “communities” is shown. The “communities” representation is indicative of clustered pools of data, separated into statistically valid groups, shown as individual networks. This allows users to navigate between groups of data, as well as to determine relationships between data in different groups.

The reasoning why such clusters are found can be insightful. For example, in the current arrangement, only a few communities or clusters are shown and only some of the relationships in this display. The user may want to select the variables in a cluster for closer examination, for example by taking them into the “centrifuge” screen to search for more depth on the relationships between them.

This in turn allows organisations to use not only their own internal data, but also external data, such as data from other organisations, generic data such as economic indicators, weather, events, such as earthquakes, floods, elections and the like. In a further example, this can be used to examine survey data regarding people's day-to-day activities, such as demographics, whereabouts (time of day, day of week, week of year . . . at the pub, the beach, at home, school, work, supermarket etc), media consumption (holistically, so traditional TV (by shows), radio station, mag, papers, outdoor, cinema, search etc, but also social, twitter, blogging), and brand information regarding brands consumed, such as what consumer products they purchase, sports teams they support, or the like.

By easily examining relationships between different groups of data, users can more easily ascertain data sets in other groups of data that are related to data sets in their own group. This allows data from various different sources to be analysed more easily, as previously described.

The natural clustering of selected data sets is especially powerful when including multiple shared communities of data from trusted industry niches. This is not unlike a ‘corporate Facebook’ where companies ‘friend’ each other based on trust and define what they might like to share, leveraging cross-pollenisation of marketing and taking back some control beyond out-sourced marketing agencies.

In the example of FIG. 13E, an “XY graph” or bubble chart is shown. This provides an animation, in which different variables are displayed as different dimensions, such as x-z positions, sizes, shapes, colours or the like, with changes in variable values being represented as part of an animation. This therefore provides a dimensional visualisation of data and how relatedness of different nodes changes over time. This can be used to visualise case and effect over time in a free flowing animation, showing how relationships change based on changes in the appearance of nodes, such as how the nodes move, grow or shrink.

In one example, the user selects from the display controls 1333 how many nodes are to be displayed, with each node being associated with up to three respective data sets, selected using a drop down menu. In this example, three dimensions in the form of the X horizontal axis, the Y vertical axis, and a size of the nodes, but it will be appreciated that other indicators could be used.

This representation therefore allows users to see the synchronicity or movement over time (across selectable ranges) of certain variables in relation to each other. This has the advantage of enabling the user to assess the timing of when particular incidents or events occurred and what impact they may have had on one or more variables of particular interest; and to control the flow of time easily to make the assessments.

FIG. 13F shows a “forecasting” representation, in which the processing system uses mathematical analysis to calculate and present forecasts to the user about the impact of variables in relation to other variables causally or correlationally.

In this example, the representation window 1310 displays a number of graphs representing historical data from selected data sets. The user can then select a future time period, and use the graphs to predict the influence of the different data sets on each other. This is based on projections, and allows a user to alter different variables to predict the impact of this on different data sets.

For example, a user could chose sales in the top graph, then added four more below it, such as (Advertising for Television, Newspapers, Internet and Trade Promotions), based on historical data. In this example, as the user manipulates the data, the processing system will predict the influence on the other data sets, using information regarding the degree of relatedness. Additionally, tabs on the graphs allow for data to be viewed as Original, Average, Trend, Elasticity, or for users to enter their own Rule-Based predictive formula.

Thus, in use, the user selects the time periods that are relevant and the data sets from the data tree, and can then manipulate via interactive graphics the ‘what if’ aspects the user wishes to determine. For example, by clicking and dragging data points, the processing system 210 can evaluate these changes to forecast a future outcome. Using smoothing, trends and cyclical analysis, plus the entering of ‘local’ rules, this is a powerful way to more accurately ‘guess’ a future outcome. To achieve this, the processing system 210 implements a machine learning engine to refine the accuracy of these forecasts, with each data refresh that the user provides.

Thus, the system implements an insights bot providing machine learning and modelling capability. This continually trawls collated, processed, correlated and regressed data to identify new patterns and abnormalities or threshold weights, and triggers an alert to the user. The identified patterns and subsequent triggers may represent valuable insights to the user on new or updated data, and according to the patterns of search and data usage exhibited over time by the user. More usage in general leads to more accurate forecast and to more accurate potential insights generation.

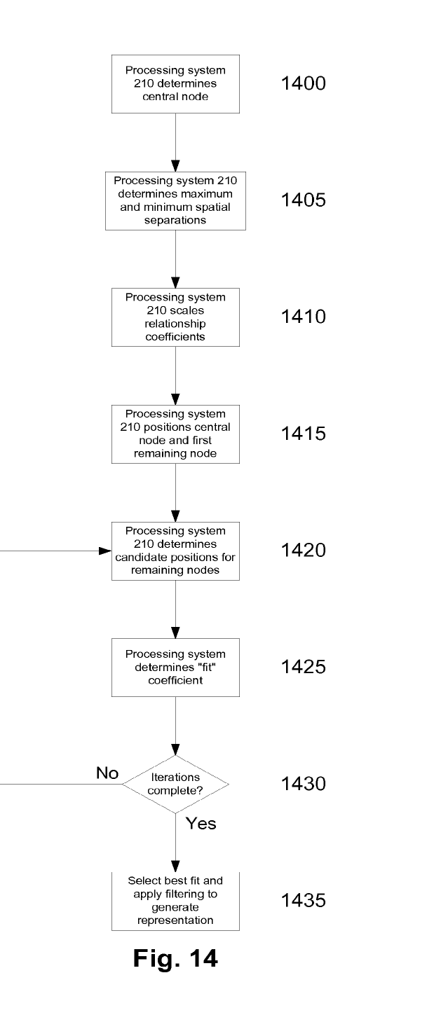

An example process for generating the representation, and in particular the “centrifuge” representation will now be described in more detail with reference to FIG. 14.

In this regard, it will be appreciated that the processing system 210 has to perform analysis of the selected data sets, and in particular the relationship coefficients between the selected data sets, in order to generate the representation. To achieve this, at step 1400 the processing system 210 determines a central node, corresponding to the selected search term variable, which is the node to be displayed at a centre of the representation.

The nodes corresponding to other selected data sets will be arranged in the space around the central node and will have a distance from the central node dependant of their relationship coefficients with the selected data set represented by the central node. This distance is between a minimum and a maximum value so that all data will display with a consistent spread and the central node will be uncluttered.

Accordingly, at step 1405, the processing system 210 determines maximum and minimum spatial separations relative to the central node. The maximum and minimum spatial separations correspond to the maximum and minimum distance from the central node at which other nodes can be provided and this may therefore be determined arbitrarily, or in accordance with input commands supplied by the user.

At step 1410 the processing system 210 scales the relationship coefficients based on the maximum and minimum spatial separations. Accordingly, for nodes that are highly related to the central node, these will be provided at the minimum spatial separation whereas nodes that are not related to the central node will have a maximum spatial separation. This effectively defines a series of concentric spheres or circles upon which nodes may be positioned relative to the central node. It will be appreciated that nodes having an intervening degree of relatedness will be positioned between the maximum and minimum spatial separations. This could be performed on a linear scale, logarithmic scale, or the like, depending on the preferred implementation.

Thus, the distance between the central node and any other node is dictated by the respective relationship coefficient value of these nodes. A correlation value of zero will cause the distance to be maximised, whilst a correlation value of +/−1.0 will cause the distance to be minimised. Correlation values between these two extremes are mapped linearly to a value between these two extremes, so that each node is provided on a sphere or circle centered at the origin and whose radius varies linearly between the minimum and the maximum radii. This distance is fixed and cannot change so that all nodes other than the central node move on their own concentric sphere or circle.

At step 1415, the processing system positions a central node and a remaining node. The remaining node is provided at the scaled spatial separation determined at step 1410 above and may be arbitrarily positioned relative to the central node. Typically, however, the remaining node is positioned directly below the central node.

At step 1420 the processing system 210 determines candidate positions for the remaining nodes. The candidate positions are based on the degree of relatedness to the central node, as defined by the scaled spatial separation relative to the central node, and the relationship coefficient with other nodes in the representation. Thus, for example, if a next node being considered is highly related to the remaining node, it will be positioned close by whereas if it is unrelated to the remaining node, it will be positioned further away. The position is provided on the concentric sphere based on the scaled separation mentioned above.

It will be appreciated from this that the distance between two non-central nodes is not on the same scale as the distances to the central node because their separations may be greater. For example, suppose the minimum radius is 10 and the maximum is 30: Nodes may be between 10 and 30 distant from the central node (i.e. have loci with radii between 10 and 30). However, two non-central nodes may be separated by 60 (opposite sides of the Great Circle). In this case a separation of 60 represents zero correlation. When two nodes are perfectly correlated (correlation of 1.0) they will be separated by a nominal distance designed to stop nodes clustering too tightly. Correlations between the two extremes have corresponding linearly-varying separations.

However, the only distances that are fixed are those between the central node and other nodes. The calculation of the separation between other nodes is performed using a simplified iterative least squares method. So in practice, if a large number of selected data sets are selected, the absolute separations of nodes can be subject to quite a lot of variation.

The initial positions are calculated by applying the cosine rule to the triangle formed by the central node, the remaining node and the next node to be placed. Where no solution exists (i.e. the length of one edge of the triangle is greater than the sum of the lengths of its other two edges), the node will be positioned with an alpha value of 1t. This corresponds to a position vertically above the central node.

Having determined candidate positions at all remaining nodes, at step 1425, the processing system 210 determines a fit coefficient typically using a regression technique, such as a method of least squares, or the like. The fit coefficient represents the accuracy with which the nodes have been positioned.

The processing system 210 then determines if all iterations are complete at step 1430. In this regard, the processing system 210 will typically perform a number of iterations corresponding to different node layouts and determine which of these most accurately represents the degree of relatedness between the nodes. If it is determined that the iterations are not complete, at step 1430 the process returns to step 1420, otherwise the process moves on to step 1435 with the candidate positions that provide the best fit being used to generate the representation. At this point the processing system 210 may also apply filtering to generate the representation, as will be described in more detail below.

In one example, the algorithm performs up to 500 iterations, seeking a ‘best fit’ of all nodes considered together in each iteration. A form of damping can be built-in to the algorithm by virtue of the limiting of the maximum angular change of position of any node in a single iteration to a value which decreases with iteration. Currently this angular delta starts off at ⅔ n and decreases by around 10% on each iteration.

Once a representation has been generated, this can be manipulated in a number of ways. Selecting a node, for example by double clicking on the node, will move the selected node to the centre of the representation. In one example, all other nodes will move to the right of the central node, before the user further manipulates view points or the like to display the representation as desired. Two circles indicating the maximum and minimum separation may also be displayed.

Another manipulation that can be performed is the selection of an input to iterate through the algorithm once. Since the algorithm currently exist only when alpha is less than some small value (currently 1 degree), the number of iterations is completely deterministic. For example, an arbitrary number of iterations can be performed. As such, the algorithm seems particularly efficient for a solution in n-1 dimensions.

The above described algorithm is based on a method of least-squares approach for laying out the nodes and therefore has an execution time related approximately to the square of the number of nodes. It also performs analysis on all nodes selected for the representation regardless of how many nodes are actually displayed, and accordingly the user may elect to select a particular number of iterations based on the number of nodes being considered, thereby controlling the time required to generate and/or manipulate the representation.

As previously mentioned, filtering can be performed to limit the number of nodes and connections displayed on the representation. In general two different types of filters can be implemented.

A general cut-off filter is used to filter out connections having relationship coefficients below a threshold, based on the original unweighted data sets. In this example, the filter is applied to all data sets, including the central node, if it falls in the lower range of the cut off.

In addition to this, a direct relative cut-off can be used. In this example, a reweighted filter provides a view where the coefficients are reweighted to the selected central node and the filter reapplied. To achieve the reweighting of cross coefficients, all indirect cross node coefficients are multiplied by the highest direct coefficient of the selected central connection. Therefore all coefficients in the database will be less than the strongest direct connection. When the filter is fully applied the last remaining visible connections and nodes are directly related to the central connection or of the same coefficient. The display is then repositioned using the reweighted coefficients. The option of direct cut-off must be selected.

A further type of filtering that can be applied is referred to as a disk cut off filter. In this regard, each node in the representation is connected to every other node. When displaying connections, there tends to be dense noise from cross connections. These connections clutter up the screen blocking out the direct connections of interest. Accordingly, a multi plane model can be constructed where direct connections (eg: connections between the central node and another node) travel across an upper plane and the cross connections (eg: connections between nodes other than the central node), travel across a lower plane. A disk is inserted in between these planes which when applied reduces or blocks out the cross connections from view actively decluttering the screen from the cross connections. This disc is resizable in real time allowing for cross connections to still be viewed outside the cut off disk. Included is an opacity control to control the distraction of cross connections under the disc so it is possible to identify the cross connections with reduced opacity.

A number of further features will now be described.

In one example, data sets can be shared by users, allowing the system to be used in establishing a data library for the purpose of extending and thereby enriching the data sets to which a user has access during search. In this regard, the library functions to facilitate the exchange of data between different companies, as well as to provide access to additional data that could enable new insights to be found in and around a subject area, e.g. teenagers, golfers, new home buyers, etc.

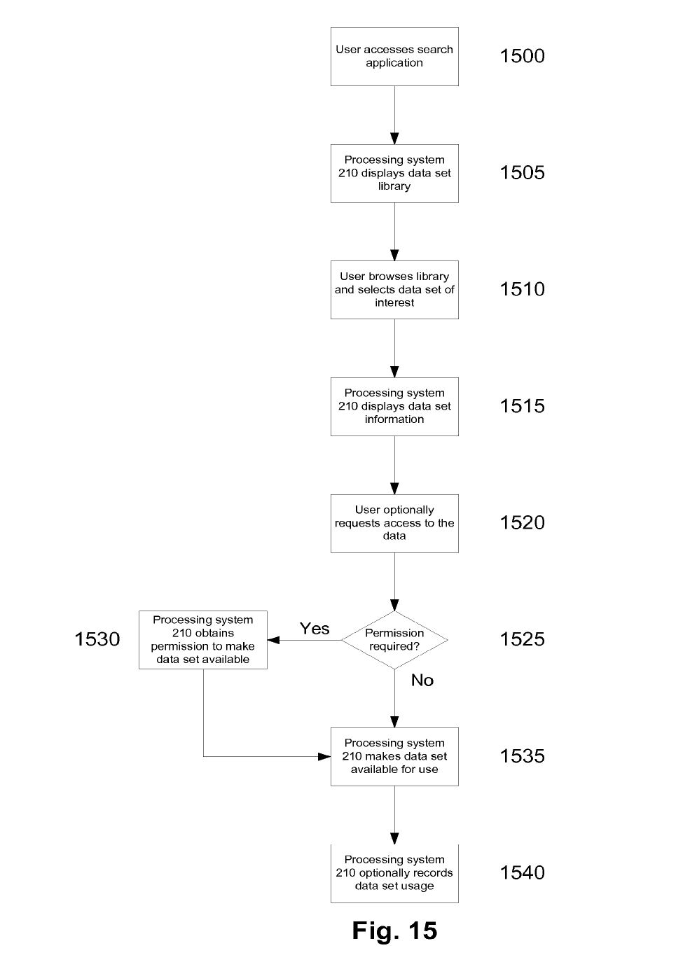

In one example, this is achieved by having a user specify appropriate permissions when submitting data to be used in a search or other analysis, as described above for example with respect to FIG. 15. In this example, the user can designate that the data should be private, limited to access by specified individuals, or other entities, or open for general use. Alternatively, a user may be asked to grant permission to share the data when access to the data is requested.

In one example, when making the data available to other users, such as companies, or other individuals, a user may be provided with a reduction in fees for any services performed, thereby encouraging greater sharing of data. Whilst shared data can be made freely available, alternatively data sets may be shared on a pay-per-use or subscription basis. In this instance, when a user's data set is accessed by other users, for example if the other users select this for performing a search, then the user that submitted the data might be compensated, for example through a proportion of any fees paid.

It will be appreciated that entities such as corporations often have data sets for which they have paid and are now surplus to their requirements. Examples include: survey data, either one-off or time series, about sporting preferences, vacationer experiences or proposed destinations, family health status and prospects, shopper experiences, food brand preferences, etc. They could equally be about the economies of any particular vertical market or segment commissioned by the depositor and now lying idle, or about media consumption patterns by beach goers, opera lovers, etc. In many cases the data has been costly and the depositor would wish to defray the cost, or use the funds to exchange for other data to enrich their ability to gain new insights of cause and effect or correlational type, and maybe to extend co branding opportunities with corporate in the same brand community.

Accordingly, the above described process can provide a library of data sets that are available to other users. This is a virtual form of library that contains data sets already deposited by other corporate users and by the host of the processing system 210, from collated and publically available updated sources such as the weather, commodity prices, foreign exchange, etc. This allows users to gain access to a greater range of data sets, whilst also allowing user's to be paid for use of their own data.

Providing access to data sets via a library typically involves having the electronic processing device of the processing system 210 display an indication of a plurality of data sets, each data set being indicative of at least one variable value of a corresponding variable. A selected data set is then determined in accordance with input commands, allowing the processing system to determine if the user has permission to access the data set. If so, the data set is made available for use, otherwise access to the data can be refused.

A specific example of the process for accessing shared data will now be described in more detail with reference to FIG. 15.

At step 1500, a user access the search application hosted by the processing system 210, which then displays a data set library at step 1505. The data set library typically includes all data sets within the system, and may optionally also identify data sets for which the user already has access permissions, for example determined based on a user identity as described above with respect to steps 1205 to 1215.

The library is typically displayed as part of a graphical user interface that enables the user to access and browse data sets stored in the library, allowing the user to optionally select a data set of interest at step 1510. This may be achieved in any suitable manner, but in one example, this is achieved by displaying a data tree similar to the data tree representation 1321 described above with respect to FIGS. 13A to 13F. The data tree typically includes categories of data sets, which can be sorted and arranged by different parameters, such as by name, price, subject matter, size, data type, date range and granularity, and by cluster, industry vertical, or client. Upon identifying a data set of interest, the user can select the data set, for example by clicking on the data set in the data tree.

Once a data set has been selected, this allows the processing system 210 to display additional information regarding the selected data set at step 1515, typically by retrieving the information from metadata associated with the data.

The additional information can be of any appropriate form, and typically includes information that allows the user to assess whether or not they wish to access the data. This can include, for example, a precis of the data set content, as well as information regarding the source of the data, cost of using the data set, or the like. Additionally and/or alternatively the information can include selected portions of the data set, or a modified version of the data set, such as a pre-processed metadata file or ‘digital footprint’ in which certain fields of the data and specific names may have been scrambled or de-identified at the depositor's request.

If of interest, the user may then request access to the data at step 1520, for example by agreeing to purchase the selected data set for inclusion in a search. At step 1525, the processing system 210 determines if permission is required to access the data. For example, a user may submit data and indicate that this is to be shared subject to approval. This allows the submitter to veto use of the data set, for example by competitors, or the like. If permission is required, then at step 1530, the processing system 210 contacts the submitter and determines if permission is granted.

If permission to access the data is not granted, access to the data set will be refused, otherwise, at step 1535, the processing system 210 makes the data set available for use, for example by updating user permissions, or the like. Access to the data set could be for unlimited use, or could be on a pay-per-use basis, and this will typically be indicated in the user permissions.

At step 1540, the processing system 210 optionally monitors the searches performed, and records an indication of usage of the data sets, which can be used for logging and invoicing purposes.

In addition to selecting data sets as described above, users of the system can enter into data sharing arrangements. For example, entities such as companies can choose to enter into a data sharing relationships with other companies. This allows the companies to ‘friend’ each other, based on trust, and defines what data sets they might like to share, as well as any financial incentives to assist with depositing and borrowing of data. Thus, user's can define global access permissions for selected ‘friends’, allowing access to data sets in a straightforward manner. As part of this, user's can specify any compensation to be associated with use of the data, such as an access purchase fee and/or a discount in fees for search services.

As an example: Company A has previously deposited a Usage and Attitudes (U&A) study of teenagers for which company A receives an incentive. Company B browsers the library and decides to purchase the data set by clicking ‘buy’. This sends a notification to company A and the system seeking the granting of permission to allow purchase by company B. Once permission is granted, the metadata associated with the data is made accessible to the data tree of persons in the permissions set of company B.

Over an extended period, data sets become less relevant and hence there is a depreciation in value and cost over time taken into account by the system.

It will be appreciated that the above described process allows users to leverage the inherent value contained within their data sets, whilst also allowing control over what may be access. The library can therefore provide a platform for users to share data, create communities, gain more insights and leverage ‘old’ or no longer require data.

It will also be appreciated that in addition to data sets for which permission is required, additional generic data sets may be made freely available to all users, including data relating to nature, such as the weather, commodity prices, foreign exchange, from OECD, etc.

In one example, datasets may be collected as part of a survey process. The survey process typically involves having individuals answer questionnaires regarding their day-today activities. This can include, for example, answering questions such as their location at a particular time of day (eg: work, home, car, bus, or the like), in addition to other more traditional information such as media consumption, product preferences, demographic information, employment information, or the like.

For example, the survey can include a first set of questions that relate to activities performed at certain times of the day. In this regard, the survey typically divides the day into a number of different time periods, such as 6:00-8:00 am, 8:00-9:00 am, 9:00-midday, etc, with the individual providing an indication of activities performed during these time periods. This provides significant information to the survey recipient regarding activities performed at particular times of the day.

Questions may also include details of travel, eating/drinking, shopping, entertainment and recreation, or the like. These will typically allow a individual to specify which forms of transport, which types of food and drink, types of shopping and entertainment have been participated in on given days.

Additionally, the individuals can provide information regarding media consumption, and in particular, which media they consumed on which days of the week. So for example, this could indicate that the individual watches television on a Monday, but reads the newspaper on Wednesday.

The individual can also be asked to provide additional information regarding brands and advertising, for example, when the time series data is to be used in an advertising context. This will include, for example, times of the day at which the individual is open or not open to advertising, the types of advertising they tend to view, brands that they use or like, brands that they do not use or don't like.

In addition to this, the survey will typically include demographic information including information such as the individual's age range, marital status, number of children, employment status, earnings, number of hours consuming media or the like.

By providing specific information regarding their location at particular times of the day, this can significantly assist in the market research process. Thus, for example, this can be used to determine the number of 30 year old males commuting by bus between 8:00 and 9:00 o′clock in the morning. In conjunction with knowledge of their media consumption patterns, this will allow market research to assess whether it is worth advertising via a certain medium to this demographic of users on buses.

Whilst one-off surveys themselves do not represent time series data, the survey can be repeated a number of times allowing time series data to be collated. Accordingly, this time series data will not only show a snapshot of activities but also how these vary over time. For example, this may highlight that the number of 30 year old males commuting by bus is greater in the winter than in the summer, in which case a company can use this information to time their adverts appropriately.

Accordingly, thus, by repeatedly collecting survey data relating to daily activities, this can allow time series data relating to an individual's activities to be collected, and then analysed as part of the above described process.

The time series data can also be broken down by attributes such as location. Thus, for example, product sales information may be available for a number of different locations. By comparing the data for each of the locations to other time series data, this can allow trends to be discerned. For example, this may demonstrate that there is a high degree of correlation between the degree of TV advertising for a product and sales in a given area, allowing marketing to be targeted more effectively for that particular area.

It is also possible to use time series data relating to events. In this example, the time series data can include an indication of a time interval during which an event occurs. This can include one-off events but also repeated events, such as a number of sporting games over a season. As an example, a company could examine whether there is any correlation between home games for a local team and certain product sales, again allowing marketing to be targeted more effectively.

Events typically occur on a one-off basis and cannot therefore in their native form be treated as time series data.

In order to accommodate this, events may be displayed as a list, allowing users to select respective events for display. In this instance, the events can be presented on the animated representations as discrete incidents at an appropriate time. Thus, for example, if a user is viewing the “XY chart” representation, the point of time at which an event occurs can be displayed, allowing this user to visualise the impact this event might have on the time series data currently being reviewed.

In the event that an impact occurs, this can be investigated in further detail. For example, a user can select an event with the date on which this occurred being used to segment time series data. Separate relationship coefficients can then be determined both before and after the event to determine if the event has resulted in a change in the relationships between different data sets. This could be used to allow the impact of an event to be displayed on any of the representations. Thus, for example, the representation could show the degree of relatedness before the event occurred and the degree of relatedness after the event occurred.

As a further alternative, time series data can be generated for events. In particular, many events will tend to have a decreasing impact over time following the event. For example, when an event occurs, sales of products may initially drop, and then gradually return to pre-event levels. To accommodate this, the time series data can be generated by defining a variable value associated with the event, and then having this variable value decay over time to represent the decreasing impact of the event. This time series data can then be correlated with existing time series data as previously described allowing, for example, a decrease in product sales to be correlated with specific one off events.

A further way in which the time series data can be analysed to determine relationship to one off events is to analyse the time series data to look for a major change in variable value. Thus, if the time series data shows a change between successive variable values that is greater than a normal degree of variation, this can be detected for example by calculating a standard deviation for the data and then comparing the change between successive variable values to the standard deviation. This can be used to identify time intervals during which major changes occur. Event data can then be reviewed to identify any event occurring during that time period, thereby identifying to users potential events that may have led to the change.

Accordingly, this provides mechanisms for allowing users to compare time series data to discrete and in particular one off events, to determine which of these may have had an impact on particular data sets of interest.

As an example, a user in reviewing product sales, may identify that sales dipped dramatically during a particular sales period. Analysing the data and comparing this to events can allow the user to identify a potential cause, such as exclusion of the product from a particular point of sale, and then assess the impact of this on ongoing sales. This can allow users to identify events that are critical to product sales.

It will be appreciated that when time series data is supplied to the system, existing relationships between different sets of time series data may already exist. In this example, an indication of these relationships can be stored together with the data sets themselves. Thus, for example, the relationships between time series data may be provided in a tree structure with total product sales at a highest level, and product sales for a given area at lower levels in a hierarchy. In this case, the relationships can be used in selecting data sets for visualization. Thus, for example, if a user selects a parent data set all child data sets may be automatically included or excluded depending on user settings. This can assist a user in selecting relevant data for inclusion in the data analysis process.

Additionally, the system can have the ability to learn about relationships, for example based on the results of previous data analysis. For example, if a user selects second data sets as part of a group, this can be used by the processing system 210 as an indication of a potential relationship between these data sets. When the user subsequently chooses to analyse one of these data sets in future, the processing system 210 can automatically select other ones of the data sets, based on previous potential relationships. This is particularly important when different users analyse common data sets, as a first user may identify a relationship that is not spotted by a second user. However, by having the system automatically flag potential relationships, this can be used to alert the second user to the relationship, thereby preventing the user from missing the relationship during subsequent analysis.

Whilst this can be performed solely on an automated basis, additionally, and or alternatively, the users can flag relationships of interest, with details of this being automatically stored as part of the relationship tree, so such relationships can be rapidly and easily identified in future.

The representations can include indicators, such as labels, associated with the nodes and/or connectors. For example, the indicator can be indicative of an identity of the relevant data set, a variable name or the like. In addition to this, the indicators can be representative of variable values, or, in the case of node connections, the relationship coefficient.

As the representation particularly tends to have a large number of nodes and node connections, the user can select to filter the nodes and connections displayed, as well as whether indicators should be displayed. This can be done by adjusting appropriate parameters relating to the representation. In addition to this, the user can also selectively adjust the opacity of the nodes and/or node connections allowing the visualization to be more easily viewed.

Examples of the types of data sets that can be used in the system include company information, such as variables about sales, online and offline inquiries, and a wide number and variety of marketing and financial information such as ad-spend on certain products, product types and models, competitor price movements, or the like. However, in addition to this, the data sets can include numerous non-corporate or ‘external’ variables, such as demographic information including population information, employment figures or the like, event data, for example relating to sporting events, census data, survey information or the like. However, it will be appreciated that this is not intended to be limiting and any appropriate information can be used.

It will be appreciated from the above, that multiple time series variables are often difficult to comprehend, i.e. in terms of which “goes with” which over time. Sales go up seemingly when the competitor's price goes up—maybe. These are things good managers sense and “know”, but this is often based on an informed and experienced guess, rather than through rigorous data analysis. However, as the market place becomes increasingly competitive, analysis of data becomes more and more important, with stakeholders requiring that management make data-informed decisions.

From a graphical perspective, traditional ways of viewing times sense data sets employ a line chart. Such charts typically have a volume or monetary metric on the vertical (y) axis, with time shown across the horizontal or x axis. It is common to see 3, 4 or 5 variables displayed comparatively over time. However, this only allows for a limited understanding, and it is rare that more variables are ever considered in combination as existing visualization techniques are simply too confusing. Yet it could be that sales of X are related to something else simply not known about or not thought of before—each of which such insights represents an opportunity for marketing, resourcing or cooperative engagement of some sort, previously not understood and therefore not leveraged to benefit company profits.

By enabling senior executives to empirically underpin their “gut feelings” and be able to communicate that to others in a data supported way, better quality decisions will result and fewer false or misguided avenues travelled. The company will benefit in tangible ways and very often through improved top level strategic decisions.

Thus, by enabling a user to perform a search and view results as a visualisation of how the data sets may be related, this allows users to use their own historical knowledge and background about their business to interpret the meaning of any relationships. The visualisation therefore provides a mechanism to draw on this knowledge/history to discover insights of how variables relate to other variables in ways simply not possible any other way. Observations of variables seen to move in similar ways over time sometimes will be coincidental, however on other occasions such observations will be highly revealing and serve as input to management decision making.

The above described process can therefore deliver insights not previously possible for a business. Whilst the process does not make specific recommendations about actions or decisions, it does greatly facilitate users' ability to understand their business. In particular, users can view their own data and externally sourced data in ways not previously possible and particularly over time movements in values of those variables, allowing them to derive insights to inform improved decision making for corporate betterment.

Whilst the above described examples have focused on the analysis of data sets for the purpose of market research, this is not essential, and the system can be used in analysis any form of time series data to allow relationships to be ascertained and understood.

In any event, the above described process can use a cloud platform import function interprets and formats data sets into time series or other data types and assigns subsets to data trees with appropriate naming conventions. The tree structures are ordered directed trees which grow in diversity and richness as more data becomes available to the particular user. The data trees enable the user to expand or contract the data sets that they perceive are most relevant to the searches the user has in mind.

Variables become associated with other variables (directionally and by strength) by means of correlation or, more commonly, time series regression methods using both proprietary and package algorithms particularly suited to the determination of cause and effect relationships.

The electronic processing device implementing the method can perform data cleansing, interpolation of series, checks on stationarity and seasonality, and autocorrelation checks. Other functions include structural equation modelling, baysian modelling, the generation of structural vector autoregressive models, and model evaluation including misspecification tests. Candidate variables and models are progressively narrowed to ‘terminal’ models to enable testing for approximation of fit to the data. A thorough testing and calibration of the model ensures that visualization by the user across different datasets in the representations are meaningful and appropriate.

The system continually learns over time. This helps ensure performance improvements and ease/relevance of use. Econometric and neural network models run during the process to ensure learnings are gained from more recent data and usage, provide information to our ‘features knowledge base’, and guide our ‘insights bot’ that alerts the user to look for more recent and potentially relevant insights—including also rule sets that prevent nonsensical results while not constraining the serendipitous nature of the search and discovery proven to be so essential to finding important insights.

Advanced econometric models underpin much of the systems analytics. When in forecasting mode, these make possible a user playground for ‘what ifs’ and therefore a variety of cause and effect insights to be generated. Econometrics modelling also includes features (influence flow and maximization) for purposes of assisting regression variable selection, and improving the identification of knock-on impact and daisy chain patterns of causes and their effects over time.

In the above described examples, the term node merely means a visual indication of a data set on a respective representation and is not intended to be limiting.

Persons skilled in the art will appreciate that numerous variations and modifications will become apparent. All such variations and modifications which become apparent to persons skilled in the art, should be considered to fall within the spirit and scope that the invention broadly appearing before described.

What is claimed is:

1. A method for use in analysing time series data, the method including, in an electronic processing device:
a) determining a relationship coefficient between each pair of a plurality of data sets, each data set being a time series data set indicative of variable values of a corresponding variable over time, and the relationship coefficient being determined at least in part using cause and effect multiple regression analysis thereby enabling inferences to be drawn as to which variables have served as contributory causes to affect certain other variables so that the relationship coefficient is indicative of a degree of causal relatedness between the pair of data sets;
b) displaying a first representation including at least one of:
i) first nodes indicative of first data sets, the first data sets being selected ones of the plurality of data sets, and wherein the first nodes include:
a central node corresponding to a selected first data set; and,
other nodes indicative of respective other first data sets, the other nodes being displayed radially outwardly of the central node, with a distance from the central node being based on the relationship coefficient between the selected first data set and the respective other first data set of the other node;
ii) node connections indicative of the relationship coefficients between at least some of the first data sets, the node connections including an arrow indicative of a direction of causality;
c) manipulating the first representation in accordance with user input commands a user by:
determining a user selected first data set in accordance with user input commands; and
moving a viewpoint so that the first node of the user selected first data set becomes the central node with other nodes being displayed radially outwardly of the central node, with a distance from the central node being based on the relationship coefficient between the user selected first data set and the respective other first data set of the other node;
d) determining selection of a plurality of second data sets from the first data sets in accordance with user input commands; and,
e) displaying a second representation, the second representation including clusters of second nodes, the second nodes being indicative of the second data sets and each cluster being a statistically valid group of highly interrelated second data sets.

2. The method according to claim 1, wherein the electronic processing device determines a distance between one of the other nodes and the central node by:
determining maximum and minimum spatial separations relative to the central node; and,
scaling the relationship coefficients between the selected first data set and the respective other first data set of the other node based on the maximum and minimum spatial separations to determine the distance between the central node and the other node.

3. The method according to claim 2, wherein other nodes are positioned based on a linear mapping of the correlation value between the respective first data set and the selected first data set between the maximum and minimum spatial separations.

4. The method according to claim 2, wherein the first representation includes two circles indicating the maximum and minimum separation.

5. The method according to claim 2, wherein:
other nodes for which the respective first data set is highly related to the selected first data set are provided at a minimum spatial separation; and,
other nodes for which the respective first data set is highly unrelated to the selected first data set are provided at a maximum spatial separation

6. The method according to claim 1, wherein the separation between other nodes is based on a relationship coefficient of the respective first data set of one other node with the respective first data sets of other ones of the other nodes.

7. The method according to claim 1, wherein the separation between other nodes is determined using a simplified iterative least squares method.

8. The method according to claim 1, wherein the user selects a first data set, by selecting the other node of the first data set in the first representation.

9. The method according to claim 1, wherein the electronic processing device filters node connections between other nodes using a disk cut off filter so that filter node connections are not shown in the first representation and wherein the disk cut off filter is resizable between maximum and minimum spatial extents.

10. The method according to claim 1, wherein the method includes manipulating the first representation in accordance with input commands of a user, by altering at least one of:
a) a number of connections;
b) data set indicators; and,
c) zoom levels.

11. The method according to claim 1, wherein the method includes:
a) determining a coefficient threshold; and,
b) displaying node connections having a relationship coefficient that exceeds the coefficient threshold, in the first representations.

12. The method according to claim 1, wherein the method includes:
a) determining a node size for each node at least in part using variable values for the corresponding first data set; and,
b) displaying the nodes in accordance with the node size.

13. The method according to claim 1, wherein the method includes at least one of:
displaying the nodes as at least one of circles spheres, and bubbles; and,
displaying the nodes together with indicators indicative of an identity of the corresponding data set.

14. The method according to claim 1, wherein the method includes determining selection of at least one of the first and second data sets in according with user input commands received via an input device and wherein the method includes at least one of:
a) displaying a list of data sets via a user interface and determining selection of data sets from the list; and,
b) determining selection of the second data sets in accordance with user selection of nodes in the first representation.

15. The method according to claim 1, wherein the method includes:
a) obtaining a data set;
b) determining a time interval associated with the data set, the time interval being indicative of the time between successive variable values;
c) comparing the time interval to a preset time interval; and,
d) if required, interpolating variable values in the data set to determine new variable values having a time interval equal to the preset time interval.

16. The method according to claim 1, wherein the method includes:
a) time shifting variable values in a data set in accordance with a time offset to form at least one time shifted data set;
b) displaying the second representation using at least one time shifted data set.

17. The method according to claim 1, wherein the method includes:
a) determining user permission associated with a user;
b) determining access permissions associated with a data set; and,
c) confirming whether a data set can be used as a first or second data set using the user permissions and data access permissions.

18. The method according to claim 1, wherein the method further includes displaying a forecasting representation by:
a) determining selection of a number of data sets from at least one of the first data sets and the second data sets;
b) for a future time period, determining a change in variable values for at least one of the number of data sets, in accordance with user input commands;
c) calculating a forecast by determining a change in variable values for other ones of the number of datasets using the degree of relatedness; and,
d) displaying a forecasting representation indicative of the forecast.

19. The method according to claim 18, wherein the method further includes calculating the forecast using machine learning techniques.

20. An apparatus for use in analysing time series data, the apparatus including, an electronic processing device that:
a) determines a relationship coefficient between each pair of a plurality of data sets, each data set being a time series data set indicative of variable values of a corresponding variable over time, and the relationship coefficient being determined at least in part using cause and effect multiple regression analysis thereby enabling inferences to be drawn as to which variables have served as contributory causes to affect certain other variables so that the relationship coefficient is indicative of a degree of causal relatedness between the pair of data sets;
b) displays a first representation including at least one of:
i) first nodes indicative of first data sets, the first data sets being selected ones of the plurality of data sets, and wherein the first nodes include:
a central node corresponding to a selected first data set; and,
other nodes indicative of respective other first data sets, the other nodes being displayed radially outwardly of the central node, with a distance from the central node being based on the relationship coefficient between the selected first data set and the respective other first data set of the other node;
ii) node connections indicative of the relationship coefficients between at least some of the first data sets the node connections including an arrow indicative of a direction of causality;
c) manipulating the first representation in accordance with user input commands a user by:
determining a user selected first data set in accordance with user input commands; and
moving a viewpoint so that the first node of the user selected first data set becomes the central node with other nodes being displayed radially outwardly of the central node, with a distance from the central node being based on the relationship coefficient between the user selected first data set and the respective other first data set of the other node;
d) determines selection of at least two second data sets from the first data sets in accordance with user input commands; and,
e) displays a second representation, the second representation including clusters of second nodes, the second nodes being indicative of the second data sets and each cluster being a statistically valid group of highly interrelated second data sets.
